(19) United States
(12) Patent Application Publication
(10) Pub. No.: US 2024/0373063 A1
(43) Pub. Date: Nov. 7, 2024

(54) 3D DATA TRANSMISSION DEVICE, 3D DATA TRANSMISSION METHOD, 3D DATA RECEPTION DEVICE, AND 3D DATA RECEPTION METHOD

(71) Applicant: LG Electronics Inc., Seoul (KR)

(72) Inventors: Daehyun KIM, Seoul (KR); Hanje PARK, Seoul (KR); Donggyu SIM, Seoul (KR); Hansol CHOI, Seoul (KR)

(21) Appl. No.: 18/294,892

(22) PCT Filed: Aug. 3, 2022
(86) PCT No.: PCT/KR2022/011486

§ 371 Date: Feb. 2, 2024

(30) Foreign Application Priority Data
Aug. 3, 2021 (KR) 10-2021-0102077

(51) Int. Cl. H04N 19/597; G06T 7/60; G06T 17/20; H04N 19/70

(52) U.S. Cl. CPC H04N 19/597; G06T 7/60; G06T 17/20; H04N 19/70

(57) ABSTRACT

A 3D data transmission method according to embodiments may comprise the steps of: generating a geometry image, an attribute image, an occupancy map, and additional information on the basis of the geometry information and the attribute information included in mesh data; encoding each of the geometry image, the attribute image, the occupancy map, and the additional information; dividing, into a plurality of connection information patches, the connection information included in the mesh data and encoding, as units of divided connection information patches, the connection information included in each connection information patch; and transmitting a bitstream including the encoded geometry image, the encoded attribute image, the encoded occupancy map, the encoded additional information, the encoded connection information, and signaling information.

### TECHNICAL FIELD

Embodiments provide a method for providing 3D contents to provide a user with various services such as virtual reality (VR), augmented reality (AR), mixed reality (MR), and autonomous driving services.

### BACKGROUND ART

A point cloud of 3D contents is a set of points in a 3D space. It is difficult to generate point cloud data because the number of points in the 3D space is large.

A large throughput is required to transmit and receive data of a point cloud.

### DISCLOSURE

### Technical Problem

An object of the embodiments devised to solve the above-described problems is to provide a device and method for efficiently transmitting and receiving mesh data.

Another object of the embodiments is to provide a device and method for addressing processing latency and encoding/decoding complexity of mesh data.

Another object of the embodiments is to provide a device and method for efficiently processing connectivity information related to mesh data.

Embodiments are not limited to the above-described objects, and the scope of the embodiments may be extended to other objects that can be inferred by those skilled in the art based on the entire contents of the present disclosure.

### Technical Solution

The object of the present disclosure can be achieved by providing a method of transmitting 3D data. The method may include generating a geometry image, an attribute image, an occupancy map, and auxiliary information based on geometry information and attribute information contained in mesh data, encoding the geometry image, the attribute image, the occupancy map, and the auxiliary information, respectively, splitting connectivity information contained in the mesh data into a plurality of connectivity patches and encoding the connectivity information contained in each of the split connectivity patches on a basis of the connectivity patches, and transmitting a bitstream containing the encoded geometry image, the encoded attribute image, the encoded occupancy map, the encoded auxiliary information, the encoded connectivity information, and signaling information.

According to an embodiment, the encoding of the connectivity information may include correcting the connectivity information contained in the mesh data based on geometry information reconstructed based on the encoded geometry image and the encoded auxiliary information, splitting the corrected connectivity information into a plurality of connectivity patches, encoding connectivity information related to each of the connectivity patches on a basis of the split connectivity patches, and generating mapping information mapping, based on the encoded connectivity information, a vertex index in a corresponding one of the connectivity patches to a vertex index in a frame.

According to an embodiment, the connectivity information contained in the mesh data and the corrected connectivity information may be configured on a frame-by-frame basis.

According to an embodiment, the vertex index in the frame mapped to the vertex index in the corresponding one of the connectivity patches included in the mapping information may be a frame-based index.

According to an embodiment, the vertex index in the frame mapped to the vertex index in the corresponding one of the connectivity patches included in the mapping information may be a connectivity patch-based index.

According to an embodiment, boundary connectivity information positioned between the connectivity patches may not be transmitted.

According to an embodiment, boundary connectivity information positioned between the connectivity patches may be included in one of the connectivity patches to be encoded and transmitted.

In another aspect of the present disclosure, provided herein is a device for transmitting 3D data. The device may include a generator configured to generate a geometry image, an attribute image, an occupancy map, and auxiliary information based on geometry information and attribute information contained in mesh data, an encoder configured to encode the geometry image, the attribute image, the occupancy map, and the auxiliary information, respectively, a connectivity information processor configured to split connectivity information contained in the mesh data into a plurality of connectivity patches and encode the connectivity information contained in each of the split connectivity patches on a basis of the connectivity patches, and a transmitter configured to transmit a bitstream containing the encoded geometry image, the encoded attribute image, the encoded occupancy map, the encoded auxiliary information, the encoded connectivity information, and signaling information.

According to an embodiment, the connectivity information processor may include a connectivity information corrector configured to correct the connectivity information contained in the mesh data based on geometry information reconstructed based on the encoded geometry image and the encoded auxiliary information, a connectivity patch configurator configured to split the corrected connectivity information into a plurality of connectivity patches, a connectivity information encoder configured to encode connectivity information related to each of the connectivity patches on a basis of the split connectivity patches, and a mapping information generator configured to generate mapping information mapping, based on the encoded connectivity information, a vertex index in a corresponding one of the connectivity patches to a vertex index in a frame.

According to an embodiment, the connectivity information contained in the mesh data and the corrected connectivity information may be configured on a frame-by-frame basis.

According to an embodiment, the vertex index in the frame mapped to the vertex index in the corresponding one of the connectivity patches included in the mapping information may be a frame-based index.

According to an embodiment, the vertex index in the frame mapped to the vertex index in the corresponding one of the connectivity patches included in the mapping information may be a connectivity patch-based index.

In another aspect of the present disclosure, provided herein is a method of receiving 3D data. The method may include receiving a bitstream containing an encoded geometry image, an encoded attribute image, an encoded occupancy map, encoded auxiliary information, encoded connectivity information, and signaling information, reconstructing geometry information and attribute information by decoding the encoded geometry image, the encoded attribute image, the encoded occupancy map, and the encoded auxiliary information, respectively, based on the signaling information, decoding the encoded connectivity information on a connectivity patch-by-patch basis based on the signaling information and the reconstructed geometry information, and reconstructing mesh data based on the reconstructed geometry information and attribute information and the decoded connectivity information.

According to an embodiment, the decoding of the connectivity information may include converting a vertex index in a corresponding connectivity patch to a vertex index in a frame based on mapping information included in the signaling information.

According to an embodiment, the vertex index in the frame mapped to the vertex index in the connectivity patch included in the mapping information may be a frame-based index or a connectivity patch-based index.

According to an embodiment, the method may further include converting the vertex index in the frame included in the mapping information to a local vertex index, based on the vertex index in the frame being the connectivity patch-based index, and converting the local vertex index to a global vertex index by applying an offset to the local vertex index.

### Advantageous Effects

A 3D data transmission method, a 3D data transmission device, a 3D data reception method, and a 3D data reception device according to embodiments may provide a good-quality 3D service.

A 3D data transmission method, a 3D data transmission device, a 3D data reception method, and a 3D data reception device according to embodiments may provide a good-quality mesh data service.

A 3D data transmission method, a 3D data transmission device, a 3D data reception method, and a 3D data reception device according to embodiments may provide a good-quality point cloud service. A 3D data transmission method, a 3D data transmission device, a 3D data reception method, and a 3D data reception device according to embodiments may achieve various video codec methods.

A 3D data transmission method, a 3D data transmission device, a 3D data reception method, and a 3D data reception device according to embodiments may provide universal 3D content such as a self-driving service.

A 3D data transmission method, a 3D data transmission device, a 3D data reception method, and a 3D data reception device according to embodiments may provide an optimal point cloud content service by configuring a V-PCC bitstream and enabling files to be transmitted, received, and stored.

A 3D data transmission method, a 3D data transmission device, a 3D data reception method, and a 3D data reception device according to embodiments may utilize mesh connectivity information to encode/decode geometry and attribute information on a mesh basis rather than a point basis, thereby increasing efficiency.

A 3D data transmission method, a 3D data transmission device, a 3D data reception method, and a 3D data reception device according to embodiments may divide connectivity information within one frame into a plurality of connectivity patches and perform encoding and decoding independently for each of the divided connectivity patches, thereby enabling parallel encoding and decoding of the mesh data and selective transmission of part of the mesh data.

A 3D data transmission method, a 3D data transmission device, a 3D data reception method, and a 3D data reception device according to embodiments may improve transmission efficiency by selectively transmitting a bitstream of a connectivity patch corresponding to a region within a user's viewpoint in an application using mesh data.

A 3D data transmission method and a 3D data transmission device according to embodiments may transmit information about mapping between a vertex index of a connectivity patch and a corresponding geometry information index (or a vertex index of a frame), and a 3D data reception method and a 3D data reception device may correct the vertex index of the frame based on the received mapping information, such that the local vertex index in the connectivity patch may be used as the vertex index of the frame. Thereby, indices may be efficiently transmitted.

With a 3D data transmission method, a 3D data transmission device, a 3D data reception method, and a 3D data reception device according to embodiments, a vertex index of a frame may be converted into a connectivity patch index (i.e. a local vertex index), which is transmitted in transmitting mapping information. Accordingly, the size of a connectivity information bitstream constituting the mapping information may be reduced compared to the vertex index of the frame (i.e. a global vertex index), and thus compression efficiency may be increased.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary structure of a transmission/reception system for providing point cloud content according to embodiments;

FIG. 2 illustrates capture of point cloud data according to embodiments;

FIG. 3 illustrates an exemplary point cloud, geometry, and texture image according to embodiments;

FIG. 4 illustrates an exemplary V-PCC encoding process according to embodiments;

FIG. 5 illustrates an example of a tangent plane and a normal vector of a surface according to embodiments;

FIG. 6 illustrates an exemplary bounding box of a point cloud according to embodiments;

FIG. 7 illustrates an example of determination of individual patch positions on an occupancy map according to embodiments;

FIG. 8 shows an exemplary relationship among normal, tangent, and bitangent axes according to embodiments;

FIG. 9 shows an exemplary configuration of minimum mode and maximum mode of a projection mode according to embodiments;

FIG. 10 illustrates an exemplary EDD code according to embodiments;

FIG. 11 illustrates an example of recoloring based on color values of neighboring points according to embodiments;

FIG. 12 illustrates an example of push-pull background filling according to embodiments;

FIG. 13 shows an exemplary possible traversal order for a 4*4 block according to embodiments;

FIG. 14 illustrates an exemplary best traversal order according to embodiments;

FIG. 15 illustrates an exemplary 2D video/image encoder according to embodiments;

FIG. 16 illustrates an exemplary V-PCC decoding process according to embodiments;

FIG. 17 shows an exemplary 2D video/image decoder according to embodiments;

FIG. 18 is a flowchart illustrating operation of a transmission device according to embodiments of the present disclosure;

FIG. 19 is a flowchart illustrating operation of a reception device according to embodiments;

FIG. 20 illustrates an exemplary structure that may be coupled with a method/device for transmitting and receiving point cloud data, according to embodiments;

FIG. 21 is a block diagram illustrating another exemplary video encoder according to embodiments;

FIG. 22 is a block diagram illustrating another exemplary video decoder according to embodiments;

FIG. 23 is a block diagram illustrating another exemplary video encoder according to embodiments;

FIGS. 24-(a) and 24-(b) illustrate an example of original vertex data and reconstructed vertex data in the case of geometry lossy encoding according to embodiments;

FIG. 25-(a) illustrates an example of original connectivity information according to embodiments, and FIG. 25-(b) illustrates an example of corrected connectivity information according to embodiments;

FIGS. 26-(a) to 26-(c) illustrate various examples of connectivity patch splitting methods according to embodiments;

FIGS. 27-(a) and 27-(b) illustrate an exemplary method of processing boundary connectivity information according to embodiments;

FIG. 28 illustrates another exemplary method of processing boundary connectivity information according to embodiments;

FIG. 29 illustrates an example of a vertex access order in encoding on a connectivity patch basis according to embodiments;

FIGS. 30-(a) to 30-(c) illustrate an exemplary case where a vertex index N for a frame included in each vertex index mapping list is given per frame according to embodiments;

FIGS. 31-(a) to 31-(d) illustrate an exemplary case where a vertex index N for a frame included in each vertex index mapping list is given per connectivity patch according to embodiments;

FIG. 32 is a diagram illustrating another exemplary video decoder according to embodiments;

FIGS. 33-(a) to 33-(c) illustrate an exemplary process for mapping vertex indices for frames according to embodiments;

FIG. 34-(a) shows an exemplary vertex index mapping list of connectivity patch 0 according to embodiments, and FIG. 34-(b) shows an exemplary vertex index mapping list of connectivity patch 1, wherein vertex indices for a frame are listed on a connectivity information matching basis according to embodiments;

FIGS. 35-(a) and 35-(b) illustrate another exemplary process for mapping vertex indices for a frame according to embodiments;

FIGS. 36-(a) to 36-(c) illustrate an example of a vertex ordering process when the vertex indices for a frame are received from a vertex index mapping list on a frame-by-frame basis according to embodiments;

FIGS. 37-(a) to 37-(c) illustrate an example of a vertex ordering process when vertex indices for a frame are received from a vertex index mapping list on a per-connectivity patch basis according to embodiments;

FIG. 38 illustrates an example of data carried by sample stream V-PCC units in a V-PCC bitstream according to embodiments;

FIG. 39 shows an exemplary syntax structure of V-PCC units according to embodiments;

FIG. 40 shows an exemplary atlas substream structure according to embodiments;

FIG. 41 shows an exemplary syntax structure of a connectivity patch header according to embodiments;

FIG. 42 shows a syntax structure of an atlas tile layer according to embodiments;

FIG. 43 shows a syntax structure of an atlas tile header included in an atlas tile layer according to embodiments;

FIG. 44 shows examples of coding types assigned to a field ath_type according to embodiments;

FIG. 45 shows a syntax structure of an atlas tile data unit according to embodiments;

FIG. 46 shows a syntax structure of patch information data according to embodiments;

FIG. 47 is a flowchart illustrating an exemplary method of transmitting mesh data according to embodiments; and

FIG. 48 is a flowchart illustrating an exemplary method of receiving mesh data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

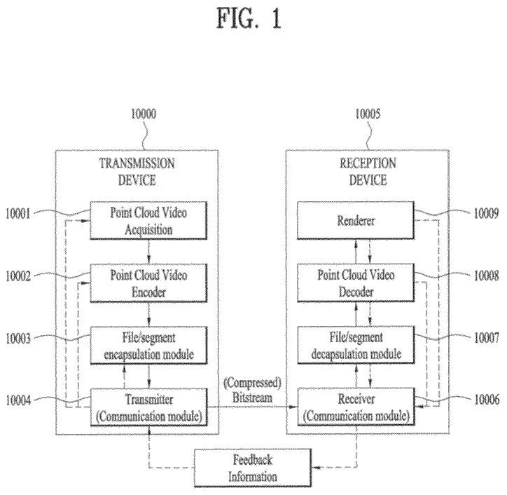

FIG. 1 illustrates an exemplary structure of a transmission/reception system for providing point cloud content according to embodiments.

The present disclosure provides a method of providing point cloud content to provide a user with various services such as virtual reality (VR), augmented reality (AR), mixed reality (MR), and autonomous driving. The point cloud content according to the embodiments represent data representing objects as points, and may be referred to as a point cloud, point cloud data, point cloud video data, point cloud image data, or the like.

A point cloud data transmission device 10000 according to embodiment may include a point cloud video acquisition unit 10001, a point cloud video encoder 10002, a file/segment encapsulation module (or file/segment encapsulator) 10003, and/or a transmitter (or communication module) 10004. The transmission device according to the embodiments may secure and process point cloud video (or point cloud content) and transmit the same. According to embodiments, the transmission device may include a fixed station, a base transceiver system (BTS), a network, an artificial intelligence (AI) device and/or system, a robot, and an AR/VR/XR device and/or a server. According to embodiments, the transmission device 10000 may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The point cloud video acquisition unit 10001 according to the embodiments acquires a point cloud video through a process of capturing, synthesizing, or generating a point cloud video.

The point cloud video encoder 10002 according to the embodiments encodes the point cloud video data acquired from the point cloud video acquisition unit 10001. According to embodiments, the point cloud video encoder 10002 may be referred to as a point cloud encoder, a point cloud data encoder, an encoder, or the like. The point cloud compression coding (encoding) according to the embodiments is not limited to the above-described embodiment. The point cloud video encoder may output a bitstream including the encoded point cloud video data. The bitstream may include not only the encoded point cloud video data, but also signaling information related to encoding of the point cloud video data.

The point cloud video encoder 10002 according to the embodiments may support both the geometry-based point cloud compression (G-PCC) encoding scheme and/or the video-based point cloud compression (V-PCC) encoding scheme. In addition, the point cloud video encoder 10002 may encode a point cloud (referring to either point cloud data or points) and/or signaling data related to the point cloud.

The file/segment encapsulation module 10003 according to the embodiments encapsulates the point cloud data in the form of a file and/or segment form. The point cloud data transmission method/device according to the embodiments may transmit the point cloud data in a file and/or segment form.

The transmitter (or communication module) 10004 according to the embodiments transmits the encoded point cloud video data in the form of a bitstream. According to embodiments, the file or segment may be transmitted to a reception device over a network, or stored in a digital storage medium (e.g., USB, SD, CD, DVD, Blu-ray, HDD, SSD, etc.). The transmitter according to the embodiments is capable of wired/wireless communication with the reception device (or the receiver) over a network of 4G, 5G, 6G, etc. In addition, the transmitter may perform necessary data processing operation according to the network system (e.g., a 4G, 5G or 6G communication network system). The transmission device may transmit the encapsulated data in an on-demand manner.

A point cloud data reception device 10005 according to the embodiments may include a receiver 10006, a file/segment decapsulator (or file/segment decapsulation module) 10007, a point cloud video decoder 10008, and/or a renderer 10009. According to embodiments, the reception device may include a device robot, a vehicle, AR/VR/XR devices, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The receiver 10006 according to the embodiments receives a bitstream containing point cloud video data. According to embodiments, the receiver 10006 may transmit feedback information to the point cloud data transmission device 10000.

The file/segment decapsulation module 10007 decapsulates a file and/or a segment containing point cloud data.

The point cloud video decoder 10008 decodes the received point cloud video data.

The renderer 10009 renders the decoded point cloud video data. According to embodiments, the renderer 10009 may transmit the feedback information obtained at the reception side to the point cloud video decoder 10008. The point cloud video data according to the embodiments may carry feedback information to the receiver 10006. According to embodiments, the feedback information received by the point cloud transmission device may be provided to the point cloud video encoder 10002.

The arrows indicated by dotted lines in the drawing represent a transmission path of feedback information acquired by the reception device 10005. The feedback information is information for reflecting interactivity with a user who consumes point cloud content, and includes user information (e.g., head orientation information), viewport information, and the like). In particular, when the point cloud content is content for a service (e.g., autonomous driving service, etc.) that requires interaction with a user, the feedback information may be provided to the content transmitting side (e.g., the transmission device 10000) and/or the service provider. According to embodiments, the feedback information may be used in the reception device 10005 as well as the transmission device 10000, and may not be provided.

The head orientation information according to embodiments is information about a user's head position, orientation, angle, motion, and the like. The reception device 10005 according to the embodiments may calculate viewport information based on the head orientation information. The viewport information may be information about a region of the point cloud video that the user is viewing. A viewpoint (or orientation) is a point where a user is viewing a point cloud video, and may refer to a center point of the viewport region. That is, the viewport is a region centered on the viewpoint, and the size and shape of the region may be determined by a field of view (FOV). In other words, a viewport is determined according to a position and a viewpoint (or orientation) of a virtual camera or a user, point cloud data is rendered in the viewport based on viewport information. Accordingly, the reception device 10005 may extract the viewport information based on a vertical or horizontal FOV supported by the device in addition to the head orientation information. In addition, the reception device 10005 performs gaze analysis to check how the user consumes a point cloud, a region that the user gazes at in the point cloud video, a gaze time, and the like. According to embodiments, the reception device 10005 may transmit feedback information including the result of the gaze analysis to the transmission device 10000. The feedback information according to the embodiments may be acquired in the rendering and/or display process. The feedback information according to the embodiments may be secured by one or more sensors included in the reception device 10005. In addition, according to embodiments, the feedback information may be secured by the renderer 10009 or a separate external element (or device, component, etc.). The dotted lines in FIG. 1 represent a process of transmitting the feedback information secured by the renderer 10009. The point cloud content providing system may process (encode/decode) point cloud data based on the feedback information. Accordingly, the point cloud video decoder 10008 may perform a decoding operation based on the feedback information. The reception device 10005 may transmit the feedback information to the transmission device. The transmission device (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) all point cloud data, and provide point cloud content to the user.

According to embodiments, the transmission device 10000 may be called an encoder, a transmission device, a transmitter, or the like, and the reception device 10005 may be called a decoder, a reception device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to point cloud data.

The elements of the point cloud content providing system illustrated in FIG. 1 may be implemented by hardware, software, a processor, and/or combinations thereof.

Embodiments may provide a method of providing point cloud content to provide a user with various services such as virtual reality (VR), augmented reality (AR), mixed reality (MR), and autonomous driving.

In order to provide a point cloud content service, a point cloud video may be acquired first. The acquired point cloud video may be transmitted to a reception side through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service (the point cloud data transmission method and/or point cloud data reception method) may include an acquisition process, an encoding process, a transmission process, a decoding process, a rendering process, and/or a feedback process.

According to embodiments, the process of providing point cloud content (or point cloud data) may be referred to as a point cloud compression process. According to embodiments, the point cloud compression process may represent a video-based point cloud compression (V-PCC) process.

Each element of the point cloud data transmission device and the point cloud data reception device according to the embodiments may be hardware, software, a processor, and/or a combination thereof.

The point cloud compression system may include a transmission device and a reception device. According to embodiments, the transmission device may be called an encoder, a transmission apparatus, a transmitter, a point cloud transmission apparatus and so on. According to embodiments, the reception device may be called a decoder, a reception apparatus, a receiver, a point cloud reception apparatus and so on. The transmission device may output a bitstream by encoding a point cloud video, and deliver the same to the reception device through a digital storage medium or a network in the form of a file or a stream (streaming segment). The digital storage medium may include various storage media such as a USB, SD, CD, DVD, Blu-ray, HDD, and SSD.

The transmission device may include a point cloud video acquisition unit, a point cloud video encoder, a file/segment encapsulator, and a transmitting unit (or transmitter) as shown in FIG. 1. The reception device may include a receiver, a file/segment decapsulator, a point cloud video decoder, and a renderer as shown in FIG. 1. The encoder may be referred to as a point cloud video/picture/picture/frame encoder, and the decoder may be referred to as a point cloud video/picture/picture/frame decoding device. The renderer may include a display. The renderer and/or the display may be configured as separate devices or external components. The transmission device and the reception device may further include a separate internal or external module/unit/component for the feedback process. According to embodiments, each element in a transmission device and a reception device may be configured of hardware, software and/or processor.

According to embodiments, the operation of the reception device may be the reverse process of the operation of the transmission device.

The point cloud video acquirer may perform the process of acquiring point cloud video through a process of capturing, composing, or generating point cloud video. In the acquisition process, data of 3D positions (x, y, z)/attributes (color, reflectance, transparency, etc.) of multiple points, for example, a polygon file format (PLY) (or the stanford triangle format) file may be generated. For a video having multiple frames, one or more files may be acquired. During the capture process, point cloud related metadata (e.g., capture related metadata) may be generated.

A point cloud data transmission device according to embodiments may include an encoder configured to encode point cloud data, and a transmitter configured to transmit the point cloud data or a bitstream including the point cloud data.

A point cloud data reception device according to embodiments may include a receiver configured to receive a bitstream including point cloud data, a decoder configured to decode the point cloud data, and a renderer configured to render the point cloud data.

The method/device according to the embodiments represents the point cloud data transmission device and/or the point cloud data reception device.

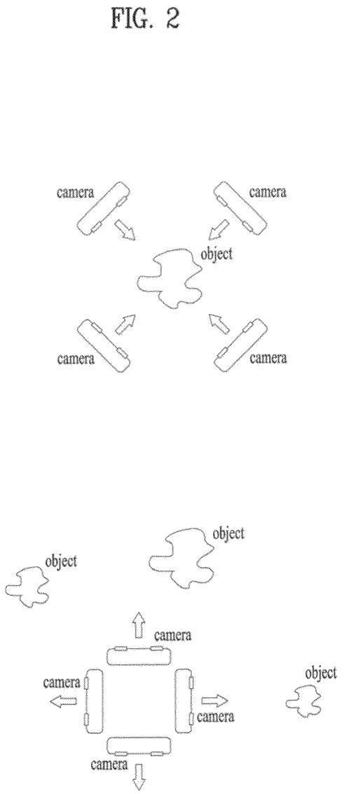

FIG. 2 illustrates capture of point cloud data according to embodiments.

Point cloud data (or point cloud video data) according to embodiments may be acquired by a camera or the like. A capturing technique according to embodiments may include, for example, inward-facing and/or outward-facing.

In the inward-facing according to the embodiments, one or more cameras inwardly facing an object of point cloud data may photograph the object from the outside of the object.

In the outward-facing according to the embodiments, one or more cameras outwardly facing an object of point cloud data may photograph the object. For example, according to embodiments, there may be four cameras.

The point cloud data or the point cloud content according to the embodiments may be a video or a still image of an object/environment represented in various types of 3D spaces. According to embodiments, the point cloud content may include video/audio/an image of an object.

Equipment for capture of point cloud content, a combination of camera equipment (a combination of an infrared pattern projector and an infrared camera) capable of acquiring depth and RGB cameras capable of extracting color information corresponding to the depth information may be configured. Alternatively, the depth information may be extracted through LiDAR, which uses a radar system that measures the location coordinates of a reflector by emitting a laser pulse and measuring the return time. A shape of the geometry consisting of points in a 3D space may be extracted from the depth information, and an attribute representing the color/reflectance of each point may be extracted from the RGB information. The point cloud content may include information about the positions (x, y, z) and color (YCbCr or RGB) or reflectance (r) of the points. For the point cloud content, the outward-facing technique of capturing an external environment and the inward-facing technique of capturing a central object may be used. In the VR/AR environment, when an object (e.g., a core object such as a character, a player, a thing, or an actor) is configured into point cloud content that may be viewed by the user in any direction (360 degrees), the configuration of the capture camera may be based on the inward-facing technique. When the current surrounding environment is configured into point cloud content in a mode of a vehicle, such as autonomous driving, the configuration of the capture camera may be based on the outward-facing technique. Because the point cloud content may be captured by multiple cameras, a camera calibration process may need to be performed before the content is captured to configure a global coordinate system for the cameras.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing with an actual camera may not be performed. In this case, the capture process may be replaced simply by a process of generating related data.

Post-processing may be needed for the captured point cloud video to improve the quality of the content. In the video capture process, the maximum/minimum depth may be adjusted within a range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, one piece of point cloud content having a wide range may be generated, or point cloud content with a high density of points may be acquired.

The point cloud video encoder 10002 may encode the input point cloud video into one or more video streams. One point cloud video may include a plurality of frames, each of which may correspond to a still image/picture. In this specification, a point cloud video may include a point cloud image/frame/picture/video/audio. In addition, the term “point cloud video” may be used interchangeably with a point cloud image/frame/picture. The point cloud video encoder 10002 may perform a video-based point cloud compression (V-PCC) procedure. The point cloud video encoder may perform a series of procedures such as prediction, transformation, quantization, and entropy coding for compression and encoding efficiency. The encoded data (encoded video/image information) may be output in the form of a bitstream. Based on the V-PCC procedure, the point cloud video encoder may encode point cloud video by dividing the same into a geometry video, an attribute video, an occupancy map video, and auxiliary information (or auxiliary data), which will be described later. The geometry video may include a geometry image, the attribute video may include an attribute image, and the occupancy map video may include an occupancy map image. The auxiliary information may include auxiliary patch information. The attribute video/image may include a texture video/image.

The file/segment encapsulator (file/segment encapsulation module) 10003 may encapsulate the encoded point cloud video data and/or metadata related to the point cloud video in the form of, for example, a file. Here, the metadata related to the point cloud video may be received from the metadata processor. The metadata processor may be included in the point cloud video encoder 10002 or may be configured as a separate component/module. The file/segment encapsulator 10003 may encapsulate the data in a file format such as ISOBMFF or process the same in the form of a DASH segment or the like. According to an embodiment, the file/segment encapsulator 10003 may include the point cloud video-related metadata in the file format. The point cloud video metadata may be included, for example, in boxes at various levels on the ISOBMFF file format or as data in a separate track within the file. According to an embodiment, the file/segment encapsulator 10003 may encapsulate the point cloud video-related metadata into a file. The transmission processor may perform processing for transmission on the point cloud video data encapsulated according to the file format. The transmission processor may be included in the transmitter 10004 or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor along with the point cloud video data, and perform processing of the point cloud video data for transmission.

The transmitter 10004 may transmit the encoded video/image information or data that is output in the form of a bitstream to the receiver 10006 of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoding device.

The receiver 10006 may receive point cloud video data transmitted by the point cloud video transmission device according to the present disclosure. Depending on the transmission channel, the receiver may receive the point cloud video data over a broadcast network or through a broadband. Alternatively, the point cloud video data may be received through a digital storage medium.

The reception processor may process the received point cloud video data according to the transmission protocol. The reception processor may be included in the receiver 10006 or may be configured as a separate component/module. The reception processor may reversely perform the above-described process of the transmission processor such that the processing corresponds to the processing for transmission performed at the transmission side. The reception processor may deliver the acquired point cloud video data to the file/segment decapsulator 10007, and the acquired point cloud video-related metadata to the metadata processor (not shown). The point cloud video-related metadata acquired by the reception processor may take the form of a signaling table.

The file/segment decapsulator (file/segment decapsulation module) 10007 may decapsulate the point cloud video data received in the form of a file from the reception processor. The file/segment decapsulator 10007 may decapsulate the files according to ISOBMFF or the like, and may acquire a point cloud video bitstream or point cloud video-related metadata (a metadata bitstream). The acquired point cloud video bitstream may be delivered to the point cloud video decoder 10008, and the acquired point cloud video-related metadata (metadata bitstream) may be delivered to the metadata processor (not shown). The point cloud video bitstream may include the metadata (metadata bitstream). The metadata processor may be included in the point cloud video decoder 10008 or may be configured as a separate component/module. The point cloud video-related metadata acquired by the file/segment decapsulator 10007 may take the form of a box or a track in the file format. The file/segment decapsulator 10007 may receive metadata necessary for decapsulation from the metadata processor, when necessary. The point cloud video-related metadata may be delivered to the point cloud video decoder 10008 and used in a point cloud video decoding procedure, or may be transferred to the renderer 10009 and used in a point cloud video rendering procedure.

The point cloud video decoder 10008 may receive the bitstream and decode the video/image by performing an operation corresponding to the operation of the point cloud video encoder. In this case, the point cloud video decoder 10008 may decode the point cloud video by dividing the same into a geometry video, an attribute video, an occupancy map video, and auxiliary information as described below. The geometry video may include a geometry image, and the attribute video may include an attribute image. The occupancy map video may include an occupancy map image. The auxiliary information may include auxiliary patch information. The attribute video/image may include a texture video/image.

The 3D geometry may be reconstructed based on the decoded geometry image, the occupancy map, and auxiliary patch information, and then may be subjected to a smoothing process. A color point cloud image/picture may be reconstructed by assigning color values to the smoothed 3D geometry based on the texture image. The renderer 10009 may render the reconstructed geometry and the color point cloud image/picture. The rendered video/image may be displayed through the display (not shown). The user may view all or part of the rendered result through a VR/AR display or a typical display.

The feedback process may include transferring various kinds of feedback information that may be acquired in the rendering/displaying process to the transmission side or to the decoder of the reception side. Interactivity may be provided through the feedback process in consuming point cloud video. According to an embodiment, head orientation information, viewport information indicating a region currently viewed by a user, and the like may be delivered to the transmission side in the feedback process. According to an embodiment, the user may interact with things implemented in the VR/AR/MR/autonomous driving environment. In this case, information related to the interaction may be delivered to the transmission side or a service provider during the feedback process. According to an embodiment, the feedback process may be skipped.

The head orientation information may represent information about the location, angle and motion of a user's head. On the basis of this information, information about a region of the point cloud video currently viewed by the user, that is, viewport information, may be calculated.

The viewport information may be information about a region of the point cloud video currently viewed by the user. Gaze analysis may be performed using the viewport information to check the way the user consumes the point cloud video, a region of the point cloud video at which the user gazes, and how long the user gazes at the region. The gaze analysis may be performed at the reception side and the result of the analysis may be delivered to the transmission side on a feedback channel. A device such as a VR/AR/MR display may extract a viewport region based on the location/direction of the user's head, vertical or horizontal FOV supported by the device, and the like.

According to an embodiment, the aforementioned feedback information may not only be delivered to the transmission side, but also be consumed at the reception side. That is, decoding and rendering processes at the reception side may be performed based on the aforementioned feedback information. For example, only the point cloud video for the region currently viewed by the user may be preferentially decoded and rendered based on the head orientation information and/or the viewport information.

Here, the viewport or viewport region may represent a region of the point cloud video currently viewed by the user. A viewpoint is a point which is viewed by the user in the point cloud video and may represent a center point of the viewport region. That is, a viewport is a region around a viewpoint, and the size and form of the region may be determined by the field of view (FOV).

The present disclosure relates to point cloud video compression as described above. For example, the methods/embodiments disclosed in the present disclosure may be applied to the point cloud compression or point cloud coding (PCC) standard of the moving picture experts group (MPEG) or the next generation video/image coding standard.

As used herein, a picture/frame may generally represent a unit representing one image in a specific time interval.

A pixel or a pel may be the smallest unit constituting one picture (or image). Also, “sample” may be used as a term corresponding to a pixel. A sample may generally represent a pixel or a pixel value. It may represent only a pixel/pixel value of a luma component, only a pixel/pixel value of a chroma component, or only a pixel/pixel value of a depth component.

A unit may represent a basic unit of image processing. The unit may include at least one of a specific region of the picture and information related to the region. The unit may be used interchangeably with term such as block or area or module in some cases. In a general case, an M×N block may include samples (or a sample array) or a set (or array) of transform coefficients configured in M columns and N rows.

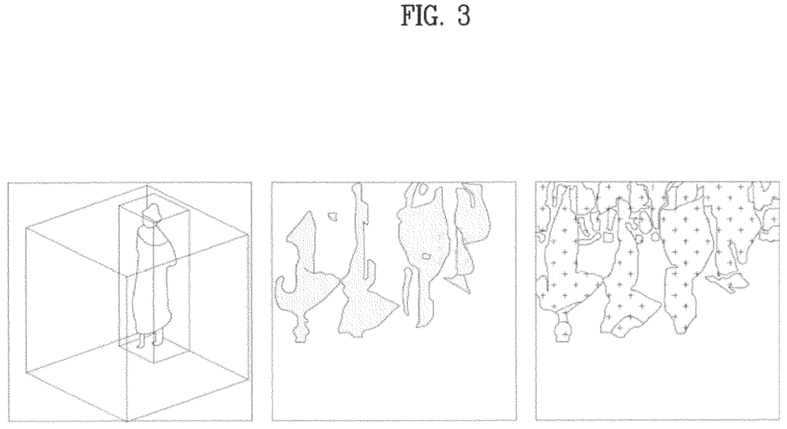

FIG. 3 illustrates an example of a point cloud, a geometry image, and a texture image according to embodiments.

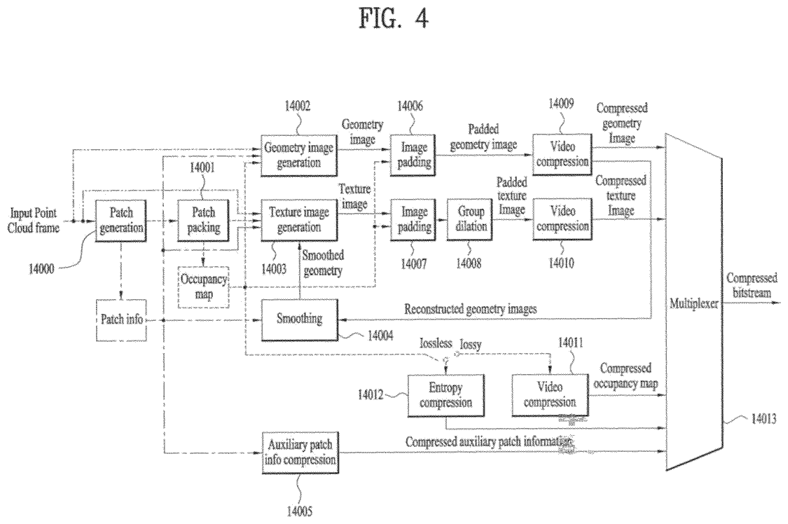

A point cloud according to the embodiments may be input to the V-PCC encoding process of FIG. 4, which will be described later, to generate a geometric image and a texture image. According to embodiments, a point cloud may have the same meaning as point cloud data.

As shown in the FIG. 3, the left part shows a point cloud, in which a point cloud object is positioned in a 3D space and may be represented by a bounding box or the like. The middle part in FIG. 3 shows a geometry image, and the right part in FIG. 3 shows a texture image (non-padded image). In the present disclosure, a geometry image may be called a geometry patch frame/picture or a geometry frame/picture and a texture image may be called an attribute patch frame/picture or an attribute frame/picture.

A video-based point cloud compression (V-PCC) according to embodiments is a method of compressing 3D point cloud data based on a 2D video codec such as High Efficiency Video Coding (HEVC) or Versatile Video Coding (VVC). Data and information that may be generated in the V-PCC compression process are as follows:

Occupancy map: this is a binary map indicating whether there is data at a corresponding position in a 2D plane, using a value of 0 or 1 in dividing the points constituting a point cloud into patches and mapping the same to the 2D plane. The occupancy map may represent a 2D array corresponding to atlas, and the values of the occupancy map may indicate whether each sample position in the atlas corresponds to a 3D point. Atlas means an object including information about 2D patches for each point cloud frame. For example, atlas may include 2D arrangement and size of patches, the position of a corresponding 3D region within a 3D point, a projection plan, and a level of detail parameters.

Patch: A set of points constituting a point cloud, which indicates that points belonging to the same patch are adjacent to each other in 3D space and are mapped in the same direction among 6-face bounding box planes in the process of mapping to a 2D image.

Geometry image: this is an image in the form of a depth map that presents position information (geometry) about each point constituting a point cloud on a patch-by-patch basis. The geometry image may be composed of pixel values of one channel. Geometry represents a set of coordinates associated with a point cloud frame.

Texture image: this is an image representing the color information about each point constituting a point cloud on a patch-by-patch basis. A texture image may be composed of pixel values of a plurality of channels (e.g., three channels of R, G, and B). The texture is included in an attribute. According to embodiments, a texture and/or attribute may be interpreted as the same object and/or having an inclusive relationship.

Auxiliary patch info: this indicates metadata needed to reconstruct a point cloud with individual patches. Auxiliary patch information may include information about the position, size, and the like of a patch in a 2D/3D space.

Point cloud data according to the embodiments, for example, V-PCC components may include an atlas, an occupancy map, geometry, and attributes.

Atlas represents a collection of 2D bounding boxes. It may be a group of patches, for example, patches projected into a rectangular frame that correspond to a 3-dimensional bounding box in 3D space, which may represent a subset of a point cloud. In this case, a patch may represent a rectangular region in the atlas corresponding to a rectangular region in a planar projection. In addition, patch data may represent data in which transformation of patches included in the atlas needs to be performed from 2D to 3D. Additionally, a patch data group is also referred to as an atlas.

An attribute may represent a scalar or vector associated with each point in the point cloud. For example, the attributes may include color, reflectance, surface normal, time stamps, material ID.

The point cloud data according to the embodiments represents PCC data according to video-based point cloud compression (V-PCC) scheme. The point cloud data may include a plurality of components. For example, it may include an occupancy map, a patch, geometry and/or texture.

FIG. 4 illustrates an example of a point cloud video encoder according to embodiments.

FIG. 4 illustrates a V-PCC encoding process for generating and compressing an occupancy map, a geometry image, a texture image, and auxiliary patch information. The V-PCC encoding process of FIG. 4 may be processed by the point cloud video encoder 10002 of FIG. 1. Each element of FIG. 4 may be performed by software, hardware, processor and/or a combination thereof.

The patch generation or patch generator 14000 receives a point cloud frame (which may be in the form of a bitstream containing point cloud data). The patch generator 14000 generates a patch from the point cloud data. In addition, patch information including information about patch generation is generated.

The patch packing or patch packer 14001 packs one or more patches. In addition, the patch packer 14001 generates an occupancy map containing information about patch packing.

The geometry image generation or geometry image generator 14002 generates a geometry image based on the point cloud data, patch information (or auxiliary information), and/or occupancy map information. The geometry image means data (i.e., 3D coordinate values of points) containing geometry related to the point cloud data and refers as to a geometry frame.

The texture image generation or texture image generator 14003 generates a texture image based on the point cloud data, patches, packed patches, patch information (or auxiliary information) and/or the smoothed geometry. The texture image refers as to an attribute frame. That is, the texture image may be generated further based on smoothed geometry generated by smoothing processing of smoothing based on the patch information.

The smoothing or smoother 14004 may mitigate or eliminate errors contained in the image data. For example, the reconstructed geometry images are smothered based on the patch information. That is, portions that may cause errors between data may be smoothly filtered out to generate smoothed geometry.

The auxiliary patch information compression or auxiliary patch information compressor 14005 may compress auxiliary patch information related to the patch information generated in the patch generation. In addition, the compressed auxiliary patch information in the auxiliary patch information compressor 14005 may be transmitted to the multiplexer 14013. The auxiliary patch information may be used in the geometry image generator 14002.

The image padding or image padders 14006 and 14007 may pad the geometry image and the texture image, respectively. The padding data may be padded to the geometry image and the texture image.

The group dilation or group dilator 14008 may add data to the texture image in a similar manner to image padding. The auxiliary patch information may be inserted into the texture image.

The video compression or video compressors 14009, 14010, and 14011 may compress the padded geometry image, the padded texture image, and/or the occupancy map, respectively. In other words, the video compressors 14009, 14010, and 14011 may compress the input geometry frame, attribute frame, and/or occupancy map frame, respectively, to output a video bitstream of the geometry image, a video bitstream of the texture image, a video bitstream of the occupancy map. The video compression may encode geometry information, texture information, and occupancy information.

The entropy compression or entropy compressor 14012 may compress the occupancy map based on an entropy scheme.

According to embodiments, the entropy compression and/or video compression may be performed on an occupancy map frame depending on whether the point cloud data is lossless and/or lossy.

The multiplexer 14013 multiplexes the video bitstream of the compressed geometry, the video bitstream of the compressed texture image, the video bitstream of the compressed occupancy map, and the bitstream of compressed auxiliary patch information from the respective compressors into one bitstream.

The blocks described above may be omitted or may be replaced by blocks having similar or identical functions. In addition, each of the blocks shown in FIG. 4 may operate as at least one of a processor, software, and hardware.

Detailed operations of each process of FIG. 4 according to embodiments are described below.

Patch generation (14000)

The patch generation process refers to a process of dividing a point cloud into patches, which are mapping units, in order to map the point cloud to the 2D image. The patch generation process may be divided into three steps: normal value calculation, segmentation, and patch segmentation.

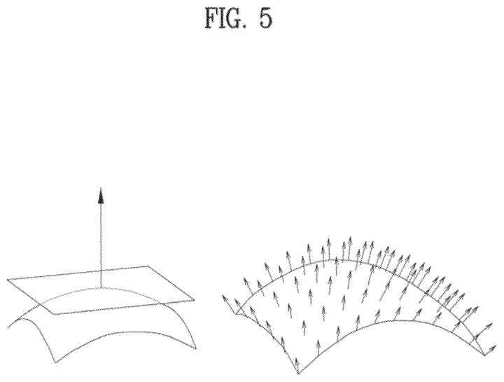

The normal value calculation process will be described in detail with reference to FIG. 5.

FIG. 5 illustrates an example of a tangent plane and a normal vector of a surface according to embodiments.

The surface of FIG. 5 is used in the patch generator 14000 of the V-PCC encoding process of FIG. 4 as follows.

Normal calculation related to patch generation

Each point of a point cloud has its own direction, which is represented by a 3D vector called a normal vector. Using the neighbors of each point obtained using a K-D tree or the like, a tangent plane and a normal vector of each point constituting the surface of the point cloud as shown in FIG. 5 may be obtained. The search range applied to the process of searching for neighbors may be defined by the user.

The tangent plane refers to a plane that passes through a point on the surface and completely includes a tangent line to the curve on the surface.

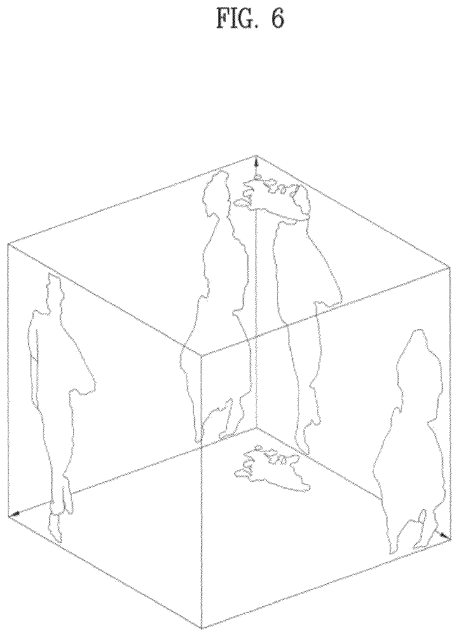

FIG. 6 illustrates an exemplary bounding box of a point cloud according to embodiments.

The bounding box according to the embodiments refers to a box of a unit for dividing point cloud data based on a hexahedron in a 3D space.

A method/device according to embodiments, for example, patch generator 14000 may use a bounding box in a process generating a patch from point cloud data.

The bounding box may be used in the process of projecting a target object of the point cloud data onto a plane of each planar face of a hexahedron in a 3D space. The bounding box may be generated and processed by the point cloud video acquisition unit 10001 and the point cloud video encoder 10002 of FIG. 1. Further, based on the bounding box, the patch generation 14000, patch packing 14001, geometry image generation 14002, and texture image generation 14003 of the V-PCC encoding process of FIG. 4 may be performed.

Segmentation related to patch generation

Segmentation is divided into two processes: initial segmentation and refine segmentation.

The point cloud video encoder 10002 according to the embodiments projects a point onto one face of a bounding box. Specifically, each point constituting a point cloud is projected onto one of the six faces of a bounding box surrounding the point cloud as shown in FIG. 6. Initial segmentation is a process of determining one of the planar faces of the bounding box onto which each point is to be projected.

\vec{n}ₚᵢₐₓ, which is a normal value corresponding to each of the six planar faces, is defined as follows:

(1.0, 0.0, 0.0), (0.0, 1.0, 0.0), (0.0, 0.0, 1.0), (−1.0, 0.0, 0.0), (0.0,−1.0, 0.0), (0.0, 0.0,−1.0).

As shown in the equation below, a face that yields the maximum value of dot product of the normal vector \vec{n}ₚᵢ; of each point, which is obtained in the normal value calculation process, and \vec{n}_{idx} is determined as a projection plane of the corresponding point. That is, a plane whose normal vector is most similar to the direction of the normal vector of a point is determined as the projection plane of the point.

maxₚ_{_{idx}}{\vec{n}ₚᵢ·\vec{n}ₚ_{_{idx}}}

The determined plane may be identified by one cluster index, which is one of 0 to 5.

Refine segmentation is a process of enhancing the projection plane of each point constituting the point cloud determined in the initial segmentation process in consideration of the projection planes of neighboring points. In this process, a score normal, which represents the degree of similarity between the normal vector of each point and the normal of each planar face of the bounding box which are considered in determining the projection plane in the initial segmentation process, and score smooth, which indicates the degree of similarity between the projection plane of the current point and the projection planes of neighboring points, may be considered together.

Score smooth may be considered by assigning a weight to the score normal. In this case, the weight value may be defined by the user. The refine segmentation may be performed repeatedly, and the number of repetitions may also be defined by the user.

Patch segmentation related to patch generation

Patch segmentation is a process of dividing the entire point cloud into patches, which are sets of neighboring points, based on the projection plane information about each point constituting the point cloud obtained in the initial/refine segmentation process. The patch segmentation may include the following steps:
1) Calculate neighboring points of each point constituting the point cloud, using the K-D tree or the like. The maximum number of neighbors may be defined by the user;
2) When the neighboring points are projected onto the same plane as the current point (when they have the same cluster index), extract the current point and the neighboring points as one patch;
3) Calculate geometry values of the extracted patch.
4) Repeat operations 2) to 3) until there is no unextracted point.

The occupancy map, geometry image and texture image for each patch as well as the size of each patch are determined through the patch segmentation process.

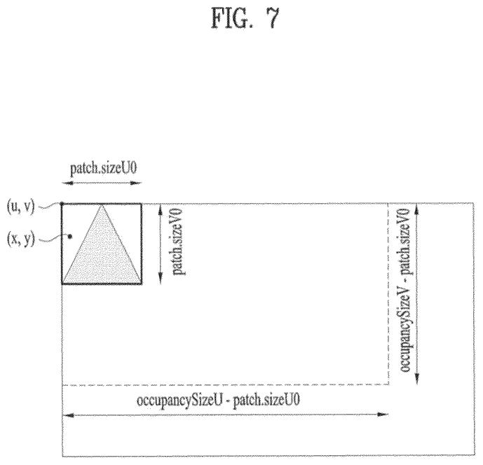

FIG. 7 illustrates an example of determination of individual patch positions on an occupancy map according to embodiments.

The point cloud video encoder 10002 according to the embodiments may perform patch packing and generate an occupancy map.

Patch packing & occupancy map generation (14001)

This is a process of determining the positions of individual patches in a 2D image to map the segmented patches to the 2D image. The occupancy map, which is a kind of 2D image, is a binary map that indicates whether there is data at a corresponding position, using a value of 0 or 1. The occupancy map is composed of blocks and the resolution thereof may be determined by the size of the block. For example, when the block is 1*1 block, a pixel-level resolution is obtained. The occupancy packing block size may be determined by the user.

The process of determining the positions of individual patches on the occupancy map may be configured as follows:
1) Set all positions on the occupancy map to 0;
2) Place a patch at a point (u, v) having a horizontal coordinate within the range of (0, occupancy SizeU-patch.sizeU0) and a vertical coordinate within the range of (0, occupancySizeV-patch.sizeV0) in the occupancy map plane;
3) Set a point (x, y) having a horizontal coordinate within the range of (0, patch.sizeU0) and a vertical coordinate within the range of (0, patch.sizeV0) in the patch plane as a current point;
4) Change the position of point (x, y) in raster order and repeat operations 3) and 4) if the value of coordinate (x, y) on the patch occupancy map is 1 (there is data at the point in the patch) and the value of coordinate (u+x, v+y) on the global occupancy map is 1 (the occupancy map is filled with the previous patch). Otherwise, proceed to operation 6);
5) Change the position of (u, v) in raster order and repeat operations 3) to 5);
6) Determine (u, v) as the position of the patch and copy the occupancy map data about the patch onto the corresponding portion on the global occupancy map; and
7) Repeat operations 2) to 6) for the next patch.

occupancySizeU: indicates the width of the occupancy map. The unit thereof is occupancy packing block size.

occupancy SizeV: indicates the height of the occupancy map. The unit thereof is occupancy packing block size.

patch.sizeU0: indicates the width of the occupancy map. The unit thereof is occupancy packing block size.

patch.sizeV0: indicates the height of the occupancy map. The unit thereof is occupancy packing block size.

For example, as shown in FIG. 7, there is a box corresponding to a patch having a patch size in a box corresponding to an occupancy packing size block, and a point (x, y) may be located in the box.

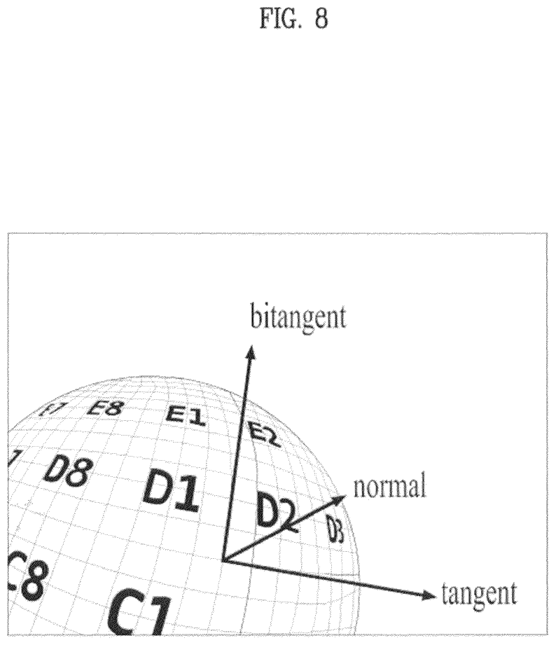

FIG. 8 shows an exemplary relationship among normal, tangent, and bitangent axes according to embodiments.

The point cloud video encoder 10002 according to embodiments may generate a geometry image. The geometry image refers to image data including geometry information about a point cloud. The geometry image generation process may employ three axes (normal, tangent, and bitangent) of a patch in FIG. 8.

Geometry image generation (14002)

In this process, the depth values constituting the geometry images of individual patches are determined, and the entire geometry image is generated based on the positions of the patches determined in the patch packing process described above. The process of determining the depth values constituting the geometry images of individual patches may be configured as follows.

1) Calculate parameters related to the position and size of an individual patch. The parameters may include the following information. According to an embodiment, a position of a patch is included in patch information.

A normal index indicating the normal axis is obtained in the previous patch generation process. The tangent axis is an axis coincident with the horizontal axis u of the patch image among the axes perpendicular to the normal axis, and the bitangent axis is an axis coincident with the vertical axis v of the patch image among the axes perpendicular to the normal axis. The three axes may be expressed as shown in FIG. 8.

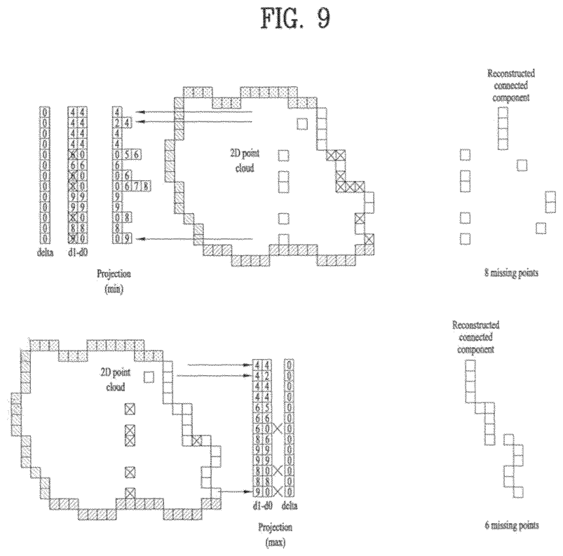

FIG. 9 shows an exemplary configuration of the minimum mode and maximum mode of a projection mode according to embodiments.

The point cloud video encoder 10002 according to embodiments may perform patch-based projection to generate a geometry image, and the projection mode according to the embodiments includes a minimum mode and a maximum mode.

3D spatial coordinates of a patch may be calculated based on the bounding box of the minimum size surrounding the patch. For example, the 3D spatial coordinates may include the minimum tangent value of the patch (on the patch 3d shift tangent axis) of the patch, the minimum bitangent value of the patch (on the patch 3d shift bitangent axis), and the minimum normal value of the patch (on the patch 3d shift normal axis).

2D size of a patch indicates the horizontal and vertical sizes of the patch when the patch is packed into a 2D image. The horizontal size (patch 2d size u) may be obtained as a difference between the maximum and minimum tangent values of the bounding box, and the vertical size (patch 2d size v) may be obtained as a difference between the maximum and minimum bitangent values of the bounding box.

2) Determine a projection mode of the patch. The projection mode may be either the min mode or the max mode. The geometry information about the patch is expressed with a depth value. When each point constituting the patch is projected in the normal direction of the patch, two layers of images, an image constructed with the maximum depth value and an image constructed with the minimum depth value, may be generated.

In the min mode, in generating the two layers of images d0 and d1, the minimum depth may be configured for do, and the maximum depth within the surface thickness from the minimum depth may be configured for d1, as shown in FIG. 9.

For example, when a point cloud is located in 2D as illustrated in FIG. 9, there may be a plurality of patches including a plurality of points. As shown in the figure, it is indicated that points marked with the same style of shadow may belong to the same patch. The figure illustrates the process of projecting a patch of points marked with blanks.

When projecting points marked with blanks to the left/right, the depth may be incremented by 1 as 0, 1, 2, . . . 6, 7, 8, 9 with respect to the left side, and the number for calculating the depths of the points may be marked on the right side.

The same projection mode may be applied to all point clouds or different projection modes may be applied to respective frames or patches according to user definition. When different projection modes are applied to the respective frames or patches, a projection mode that may enhance compression efficiency or minimize missed points may be adaptively selected.

3) Calculate the depth values of the individual points.

In the min mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the minimum normal value of each point. If there is another depth value within the range between depth0 and the surface thickness at the same position, this value is set to depth1. Otherwise, the value of depth0 is assigned to depth1. Image d1 is constructed with the value of depth1.

For example, a minimum value may be calculated in determining the depth of points of image d0 (4 2 4 4 0 6 0 0 9 9 0 8 0). In determining the depth of points of image d1, a greater value among two or more points may be calculated. When only one point is present, the value thereof may be calculated (4 4 4 4 6 6 6 8 9 9 8 8 9). In the process of encoding and reconstructing the points of the patch, some points may be lost (For example, in the figure, eight points are lost).

In the max mode, image do is constructed with depth0, which is a value obtained by subtracting the minimum normal value of the patch (on the patch 3d shift normal axis) calculated in operation 1) from the minimum normal value of the patch (on the patch 3d shift normal axis) for the maximum normal value of each point. If there is another depth value within the range between depth0 and the surface thickness at the same position, this value is set to depth1. Otherwise, the value of depth0 is assigned to depth1. Image d1 is constructed with the value of depth1 .

For example, a maximum value may be calculated in determining the depth of points of do (4 4 4 4 6 6 6 8 9 9 8 8 9). In addition, in determining the depth of points of d1, a lower value among two or more points may be calculated. When only one point is present, the value thereof may be calculated (4 2 4 4 5 6 0 6 9 9 0 8 0). In the process of encoding and reconstructing the points of the patch, some points may be lost (For example, in the figure, six points are lost).

The entire geometry image may be generated by placing the geometry images of the individual patches generated through the above-described processes onto the entire geometry image based on the patch position information determined in the patch packing process.

Layer d1 of the generated entire geometry image may be encoded using various methods. A first method (absolute d1 encoding method) is to encode the depth values of the previously generated image d1. A second method (differential encoding method) is to encode a difference between the depth values of previously generated image d1 and the depth values of image do.

In the encoding method using the depth values of the two layers, d0 and d1 as described above, if there is another point between the two depths, the geometry information about the point is lost in the encoding process, and therefore an enhanced-delta-depth (EDD) code may be used for lossless coding.

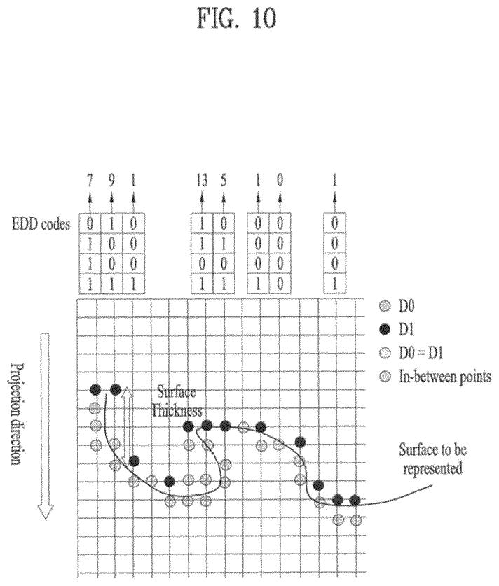

Hereinafter, the EDD code will be described in detail with reference to FIG. 10.

FIG. 10 illustrates an exemplary EDD code according to embodiments.

In some/all processes of the point cloud video encoder 10002 and/or V-PCC encoding (e.g., video compression 14009), the geometry information about points may be encoded based on the EOD code.

As shown in FIG. 10, the EDD code is used for binary encoding of the positions of all points within the range of surface thickness including d1. For example, in FIG. 10, the points included in the second left column may be represented by an EDD code of 0b1001 (=9) because the points are present at the first and fourth positions over DO and the second and third positions are empty. When the EDD code is encoded together with DO and transmitted, a reception terminal may restore the geometry information about all points without loss.

For example, when there is a point present above a reference point, the value is 1. When there is no point, the value is 0. Thus, the code may be expressed based on 4 bits.

### Smoothing (14004)

Smoothing is an operation for eliminating discontinuity that may occur on the patch boundary due to deterioration of the image quality occurring during the compression process. Smoothing may be performed by the point cloud video encoder 10002 or smoother 14004:

1) Reconstruct the point cloud from the geometry image. This operation may be the reverse of the geometry image generation described above. For example, the reverse process of encoding may be reconstructed;

2) Calculate neighboring points of each point constituting the reconstructed point cloud using the K-D tree or the like;

3) Determine whether each of the points is positioned on the patch boundary. For example, when there is a neighboring point having a different projection plane (cluster index) from the current point, it may be determined that the point is positioned on the patch boundary;

4) If there is a point present on the patch boundary, move the point to the center of mass of the neighboring points (positioned at the average x, y, z coordinates of the neighboring points). That is, change the geometry value. Otherwise, maintain the previous geometry value.

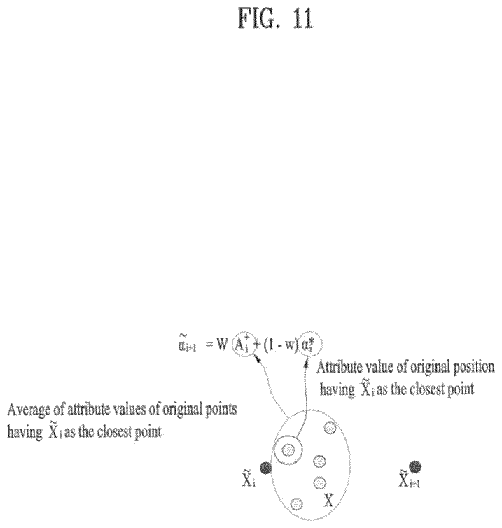

FIG. 11 illustrates an example of recoloring based on color values of neighboring points according to embodiments.

The point cloud video encoder 10002 or the texture image generator 14003 according to the embodiments may generate a texture image based on recoloring.

Texture image generation (14003)

The texture image generation process, which is similar to the geometry image generation process described above, includes generating texture images of individual patches and generating an entire texture image by arranging the texture images at determined positions. However, in the operation of generating texture images of individual patches, an image with color values (e.g., R, G, and B values) of the points constituting a point cloud corresponding to a position is generated in place of the depth values for geometry generation.

In estimating a color value of each point constituting the point cloud, the geometry previously obtained through the smoothing process may be used. In the smoothed point cloud, the positions of some points may have been shifted from the original point cloud, and accordingly a recoloring process of finding colors suitable for the changed positions may be required. Recoloring may be performed using the color values of neighboring points. For example, as shown in FIG. 11, a new color value may be calculated in consideration of the color value of the nearest neighboring point and the color values of the neighboring points.

For example, referring to FIG. 11, in the recoloring, a suitable color value for a changed position may be calculated based on the average of the attribute information about the closest original points to a point and/or the average of the attribute information about the closest original positions to the point.

Texture images may also be generated in two layers of t0 and t1, like the geometry images generated in two layers of d0 and d1.

Auxiliary patch information compression (14005)

The point cloud video encoder 10002 or the auxiliary patch information compressor 14005 according to the embodiments may compress the auxiliary patch information (auxiliary information about the point cloud).

The auxiliary patch information compressor 14005 compresses the auxiliary patch information generated in the patch generation, patch packing, and geometry generation processes described above. The auxiliary patch information may include the following parameters:

Index (cluster index) for identifying the projection plane (normal plane);

3D spatial position of a patch, i.e., the minimum tangent value of the patch (on the patch 3d shift tangent axis), the minimum bitangent value of the patch (on the patch 3d shift bitangent axis), and the minimum normal value of the patch (on the patch 3d shift normal axis);

2D spatial position and size of the patch, i.e., the horizontal size (patch 2d size u), the vertical size (patch 2d size v), the minimum horizontal value (patch 2d shift u), and the minimum vertical value (patch 2d shift u); and

Mapping information about each block and patch, i.e., a candidate index (when patches are disposed in order based on the 2D spatial position and size information about the patches, multiple patches may be mapped to one block in an overlapping manner. In this case, the mapped patches constitute a candidate list, and the candidate index indicates the position in sequential order of a patch whose data is present in the block), and a local patch index (which is an index indicating one of the patches present in the frame). Table 1 shows a pseudo code representing the process of matching between blocks and patches based on the candidate list and the local patch indexes.

The maximum number of candidate lists may be defined by a user.

TABLE 1

for( i = 0; i < BlockCount; i++ ) {
if( candidatePatches[ i ].size( ) = = 1 ) {
blockToPatch[ i ] = candidatePatches[ i ][ 0 ]
} else {
candidate_index
if( candidate_index = = max_candidate_count ) {
blockToPatch[ i ] = local_patch_index
} else {
blockToPatch[ i ] = candidatePatches[ i ][ candidate_index ]
}
}
}

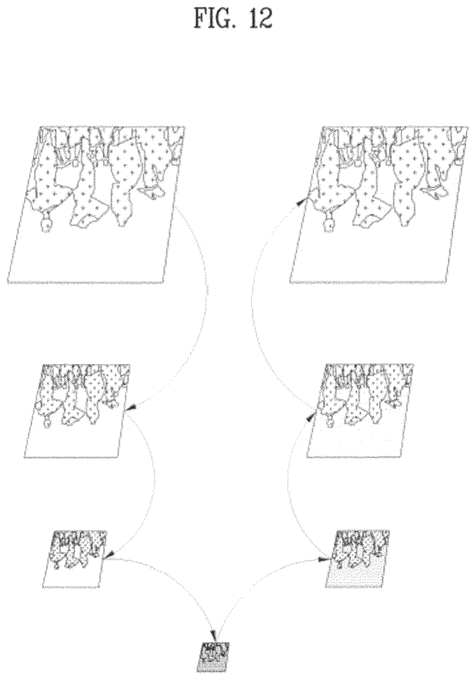

FIG. 12 illustrates push-pull background filling according to embodiments.

Image padding and group dilation (14006, 14007, 14008)

The image padder according to the embodiments may fill the space except the patch area with meaningless supplemental data based on the push-pull background filling technique.

Image padding 14006 and 14007 is a process of filling the space other than the patch region with meaningless data to improve compression efficiency. For image padding, pixel values in columns or rows close to a boundary in the patch may be copied to fill the empty space. Alternatively, as shown in FIG. 12, a push-pull background filling method may be used. According to this method, the empty space is filled with pixel values from a low resolution image in the process of gradually reducing the resolution of a non-padded image and increasing the resolution again.

Group dilation 14008 is a process of filling the empty spaces of a geometry image and a texture image configured in two layers, d0/d1 and t0/t1, respectively. In this process, the empty spaces of the two layers calculated through image padding are filled with the average of the values for the same position.

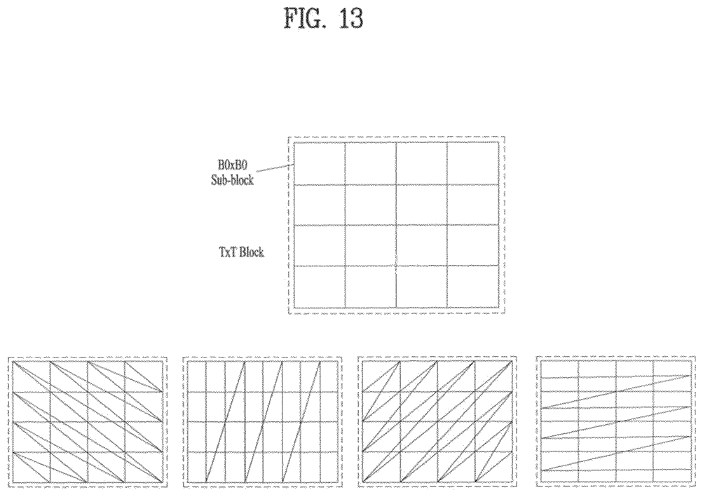

FIG. 13 shows an exemplary possible traversal order for a 4*4 block according to embodiments.

Occupancy map compression (14012, 14011)

The occupancy map compressor according to the embodiments may compress the previously generated occupancy map. Specifically, two methods, namely video compression for lossy compression and entropy compression for lossless compression, may be used. Video compression is described below.

The entropy compression may be performed through the following operations.

1) If a block constituting an occupancy map is fully occupied, encode 1 and repeat the same operation for the next block of the occupancy map. Otherwise, encode 0 and perform operations 2) to 5).

2) Determine the best traversal order to perform run-length coding on the occupied pixels of the block. FIG. 13 shows four possible traversal orders for a 4*4 block.

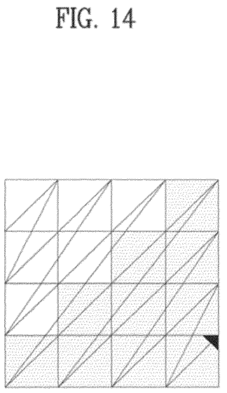

FIG. 14 illustrates an exemplary best traversal order according to embodiments.

As described above, the entropy compressor according to the embodiments may code (encode) a block based on the traversal order scheme as shown in FIG. 14.

For example, the best traversal order with the minimum number of runs is selected from among the possible traversal orders and the index thereof is encoded. FIG. 14 illustrates a case where the third traversal order in FIG. 13 is selected. In the illustrated case, the number of runs may be minimized to 2, and therefore the third traversal order may be selected as the best traversal order.

3) Encode the number of runs. In the example of FIG. 14, there are two runs, and therefore 2 is encoded.

4) Encode the occupancy of the first run. In the example of FIG. 14, 0 is encoded because the first run corresponds to unoccupied pixels.

5) Encode lengths of the individual runs (as many as the number of runs). In the example of FIG. 14, the lengths of the first run and the second run, 6 and 10, are sequentially encoded. Video compression (14009, 14010, 14011)

The video compressors 14009, 14010, and 14011 according to the embodiments encodes a sequence of a geometry image, a texture image, an occupancy map image, and the like generated in the above-described operations, using a 2D video codec such as HEVC or VVC.

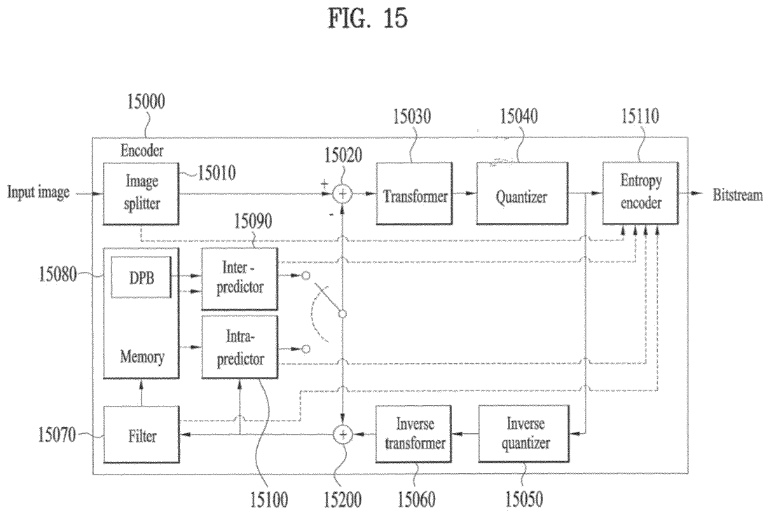

FIG. 15 illustrates an exemplary 2D video/image encoder according to embodiments. According to embodiments, the 2D video/image encoder may be called an encoding device.

FIG. 15, which represents an embodiment to which the video compressors 14009, 14010, and 14011 described above is applied, is a schematic block diagram of a 2D video/image encoder 15000 configured to encode a video/image signal. The 2D video/image encoder 15000 may be included in the point cloud video encoder 10002 described above or may be configured as an internal/external component. Each component of FIG. 15 may correspond to software, hardware, processor and/or a combination thereof.

Here, the input image may be one of the geometry image, the texture image (attribute(s) image), and the occupancy map image described above. When the 2D video/image encoder of FIG. 15 is applied to the video compressor 14009, the image input to the 2D video/image encoder 15000 is a padded geometry image, and the bitstream output from the 2D video/image encoder 15000 is a bitstream of a compressed geometry image. When the 2D video/image encoder of FIG. 15 is applied to the video compressor 14010, the image input to the 2D video/image encoder 15000 is a padded texture image, and the bitstream output from the 2D video/image encoder 15000 is a bitstream of a compressed texture image. When the 2D video/image encoder of FIG. 15 is applied to the video compressor 14011, the image input to the 2D video/image encoder 15000 is an occupancy map image, and the bitstream output from the 2D video/image encoder 15000 is a bitstream of a compressed occupancy map image.

An inter-predictor 15090 and an intra-predictor 15100 may be collectively called a predictor. That is, the predictor may include the inter-predictor 15090 and the intra-predictor 15100. A transformer 15030, a quantizer 15040, an inverse quantizer 15050, and an inverse transformer 15060 may be collectively called a residual processor. The residual processor may further include a subtractor 15020. According to an embodiment, the image splitter 15010, the subtractor 15020, the transformer 15030, the quantizer 15040, the inverse quantizer 15050, the inverse transformer 15060, the adder 15200, the filter 15070, the inter-predictor 15090, the intra-predictor 15100, and the entropy encoder 15110 of FIG. 15 may be configured by one hardware component (e.g., an encoder or a processor). In addition, the memory 15080 may include a decoded picture buffer (DPB) and may be configured by a digital storage medium.

The image splitter 15010 may spit an image (or a picture or a frame) input to the encoder 15000 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a lower depth based on a quad-tree structure and/or a binary-tree structure. In this case, for example, the quad-tree structure may be applied first and the binary-tree structure may be applied later. Alternatively, the binary-tree structure may be applied first. The coding procedure according to the present disclosure may be performed based on a final CU that is not split anymore. In this case, the LCU may be used as the final CU based on coding efficiency according to characteristics of the image. When necessary, a CU may be recursively split into CUs of a lower depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The term “unit” may be used interchangeably with terms such as block or area or modle. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The subtractor 15020 of the encoding device 15000 may generate a residual signal (residual block or residual sample array) by subtracting a prediction signal (predicted block or predicted sample array) output from the inter-predictor 15090 or the intra-predictor 15100 from an input image signal (original block or original sample array), and the generated residual signal is transmitted to the transformer 15030. In this case, as shown in the figure, the unit that subtracts the prediction signal (predicted block or predicted sample array) from the input image signal (original block or original sample array) in the encoding device 15000 may be called a subtractor 15020. The predictor may perform prediction for a processing target block (hereinafter referred to as a current block) and generate a predicted block including prediction samples for the current block. The predictor may determine whether intra-prediction or inter-prediction is applied on a current block or CU basis. As will be described later in the description of each prediction mode, the predictor may generate various kinds of information about prediction, such as prediction mode information, and deliver the generated information to the entropy encoder 15110. The information about the prediction may be encoded and output in the form of a bitstream by the entropy encoder 15110.

The intra-predictor 15100 of the predictor may predict the current block with reference to the samples in the current picture. The samples may be positioned in the neighbor of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, and more or fewer directional prediction modes may be used depending on the setting. The intra-predictor 15100 may determine a prediction mode to be applied to the current block, based on the prediction mode applied to the neighboring block.

The inter-predictor 15090 of the predictor may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 15090 may configure a motion information candidate list based on the neighboring blocks and generate information indicating a candidate to be used to derive a motion vector and/or a reference picture index of the current block. Inter-prediction may be performed based on various prediction modes. For example, in a skip mode and a merge mode, the inter-predictor 15090 may use motion information about a neighboring block as motion information about the current block. In the skip mode, unlike the merge mode, the residual signal may not be transmitted. In a motion vector prediction (MVP) mode, the motion vector of a neighboring block may be used as a motion vector predictor and the motion vector difference may be signaled to indicate the motion vector of the current block.

The prediction signal generated by the inter-predictor 15090 or the intra-predictor 15100 may be used to generate a reconstruction signal or to generate a residual signal.

The transformer 15030 may generate transform coefficients by applying a transformation technique to the residual signal. For example, the transformation technique may include at least one of discrete cosine transform (DCT), discrete sine transform (DST), Karhunen-Loève transform (KLT), graph-based transform (GBT), or conditionally non-linear transform (CNT). Here, the GBT refers to transformation obtained from a graph depicting the relationship between pixels. The CNT refers to transformation obtained based on a prediction signal generated based on all previously reconstructed pixels. In addition, the transformation operation may be applied to pixel blocks having the same size of a square, or may be applied to blocks of a variable size other than the square.

The quantizer 15040 may quantize the transform coefficients and transmit the same to the entropy encoder 15110. The entropy encoder 15110 may encode the quantized signal (information about the quantized transform coefficients) and output a bitstream of the encoded signal. The information about the quantized transform coefficients may be referred to as residual information. The quantizer 15040 may rearrange the quantized transform coefficients, which are in a block form, in the form of a one-dimensional vector based on a coefficient scan order, and generate information about the quantized transform coefficients based on the quantized transform coefficients in the form of the one-dimensional vector.

The entropy encoder 15110 may employ various encoding techniques such as, for example, exponential Golomb, context-adaptive variable length coding (CAVLC), and context-adaptive binary arithmetic coding (CABAC). The entropy encoder 15110 may encode information necessary for video/image reconstruction (e.g., values of syntax elements) together with or separately from the quantized transform coefficients. The encoded information (e.g., encoded video/image information) may be transmitted or stored in the form of a bitstream on a network abstraction layer (NAL) unit basis.

The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 15110 and/or a storage (not shown) to store the signal may be configured as internal/external elements of the encoder 15000. Alternatively, the transmitter may be included in the entropy encoder 15110.

The quantized transform coefficients output from the quantizer 15040 may be used to generate a prediction signal. For example, inverse quantization and inverse transform may be applied to the quantized transform coefficients through the inverse quantizer 15050 and the inverse transformer 15060 to reconstruct the residual signal (residual block or residual samples). The adder 15200 may add the reconstructed residual signal to the prediction signal output from the inter-predictor 15090 or the intra-predictor 15100. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 15200 may be called a reconstructor or a reconstructed block generator. The generated reconstructed signal may be used for intra-prediction of the next processing target block in the current picture, or may be used for inter-prediction of the next picture through filtering as described below.

The filter 15070 may improve subjective/objective image quality by applying filtering to the reconstructed signal output from the adder 15200. For example, the filter 15070 may generate a modified reconstructed picture by applying various filtering techniques to the reconstructed picture, and the modified reconstructed picture may be stored in the memory 15080, specifically, the DPB of the memory 15080. The various filtering techniques may include, for example, deblocking filtering, sample adaptive offset, adaptive loop filtering, and bilateral filtering. As described below in the description of the filtering techniques, the filter 15070 may generate various kinds of information about filtering and deliver the generated information to the entropy encoder 15110. The information about filtering may be encoded and output in the form of a bitstream by the entropy encoder 15110.

The modified reconstructed picture stored in the memory 15080 may be used as a reference picture by the inter-predictor 15090. Thus, when inter-prediction is applied, the encoder may avoid prediction mismatch between the encoder 15000 and the decoder and improve encoding efficiency.

The DPB of the memory 15080 may store the modified reconstructed picture so as to be used as a reference picture by the inter-predictor 15090. The memory 15080 may store the motion information about a block from which the motion information in the current picture is derived (or encoded) and/or the motion information about the blocks in a picture that has already been reconstructed. The stored motion information may be delivered to the inter-predictor 15090 so as to be used as motion information about a spatial neighboring block or motion information about a temporal neighboring block. The memory 15080 may store the reconstructed samples of the reconstructed blocks in the current picture and deliver the reconstructed samples to the intra-predictor 15100.

At least one of the prediction, transform, and quantization procedures described above may be skipped. For example, for a block to which the pulse code modulation (PCM) is applied, the prediction, transform, and quantization procedures may be skipped, and the value of the original sample may be encoded and output in the form of a bitstream.

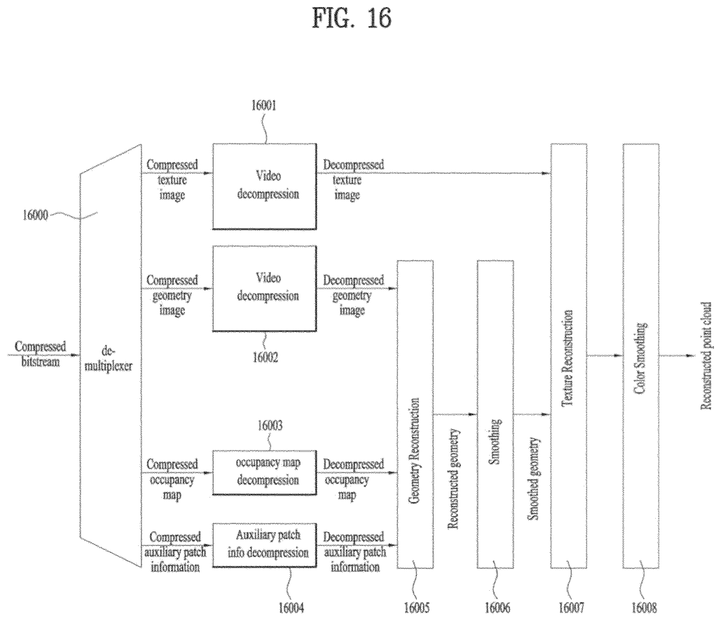

FIG. 16 illustrates an exemplary V-PCC decoding process according to embodiments.

The V-PCC decoding process or V-PCC decoder may follow the reverse process of the V-PCC encoding process (or encoder) of FIG. 4. Each component in FIG. 16 may correspond to software, hardware, a processor, and/or a combination thereof.

The demultiplexer 16000 demultiplexes the compressed bitstream to output a compressed texture image, a compressed geometry image, a compressed occupancy map, and a compressed auxiliary patch information, respectively.

The video decompression or video decompressors 16001 and 16002 decompress each of the compressed texture image and the compressed geometry image.

The occupancy map decompression or occupancy map decompressor 16003 decompresses the compressed occupancy map image.

The auxiliary patch information decompression or auxiliary patch information decompressor 16004 decompresses the compressed auxiliary patch information.

The geometry reconstruction or geometry reconstructor 16005 restores (reconstructs) the geometry information based on the decompressed geometry image, the decompressed occupancy map, and/or the decompressed auxiliary patch information. For example, the geometry changed in the encoding process may be reconstructed.

The smoothing or smoother 16006 may apply smoothing to the reconstructed geometry. For example, smoothing filtering may be applied.

The texture reconstruction or texture reconstructor 16007 reconstructs the texture from the decompressed texture image and/or the smoothed geometry.

The color smoothing or color smoother 16008 smooths color values from the reconstructed texture. For example, smoothing filtering may be applied.

As a result, reconstructed point cloud data may be generated.

FIG. 16 illustrates a decoding process of the V-PCC for reconstructing a point cloud by decompressing (decoding) the compressed occupancy map, geometry image, texture image, and auxiliary patch information.

Each of the units illustrated in FIG. 16 may operate as at least one of a processor, software, and hardware. Detailed operations of each unit of FIG. 16 according to embodiments are described below.

Video decompression (16001, 16002)

Video decompression is a reverse process of the video compression described above. It is a process of decoding the bitstream of a geometry image, the bitstream of a compressed texture image, and/or the bitstream of a compressed occupancy map image generated in the above-described process, using a 2D video codec such as HEVC and VVC.

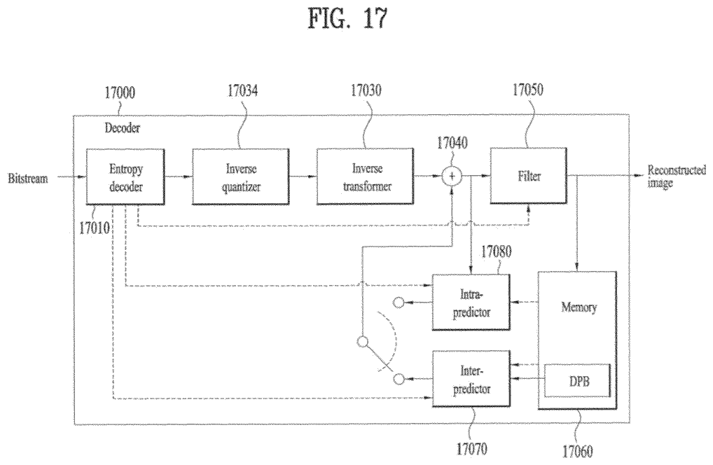

FIG. 17 illustrates an exemplary 2D video/image decoder according to embodiments, which is also referred to as a decoding device.

The 2D video/image decoder may follow the reverse process of the operation of the 2D video/image encoder of FIG. 15.

The 2D video/image decoder of FIG. 17 is an embodiment of the video decompressors 16001 and 16002 of FIG. 16. FIG. 17 is a schematic block diagram of a 2D video/image decoder 17000 by which a video/image signal is decoded. The 2D video/image decoder 17000 may be included in the point cloud video decoder 10008 described above, or may be configured as an internal/external component. Each component in FIG. 17 may correspond to software, hardware, a processor, and/or a combination thereof.

Here, the input bitstream may be one of a bitstream of a geometry image, a bitstream of a texture image (attribute(s) image), and a bitstream of an occupancy map image. When the 2D video/image decoder of FIG. 17 is applied to the video decompressor 16001, the bitstream input to the 2D video/image decoder is a bitstream of a compressed texture image, and the reconstructed image output from the 2D video/image decoder is a decompressed texture image. When the 2D video/image decoder of FIG. 17 is applied to the video decompressor 16002, the bitstream input to the 2D video/image decoder is a bitstream of a compressed geometry image, and the reconstructed image output from the 2D video/image decoder is a decompressed geometry image. The 2D video/image decoder of FIG. 17 may receive a bitstream of a compressed occupancy map image and decompress the same. The reconstructed image (or the output image or decoded image) may represent a reconstructed image for the above-described geometry image, texture image (attribute(s) image), and occupancy map image.

Referring to FIG. 17, an inter-predictor 17070 and an intra-predictor 17080 may be collectively referred to as a predictor. That is, the predictor may include the inter-predictor 17070 and the intra-predictor 17080. An inverse quantizer 17020 and an inverse transformer 17030 may be collectively referred to as a residual processor. That is, the residual processor may include the inverse quantizer 17020 and the inverse transformer 17030. The entropy decoder 17010, the inverse quantizer 17020, the inverse transformer 17030, the adder 17040, the filter 17050, the inter-predictor 17070, and the intra-predictor 17080 of FIG. 17 may be configured by one hardware component (e.g., a decoder or a processor) according to an embodiment. In addition, the memory 17060 may include a decoded picture buffer (DPB) or may be configured by a digital storage medium.

When a bitstream containing video/image information is input, the decoder 17000 may reconstruct an image in a process corresponding to the process in which the video/image information is processed by the encoder of FIG. 15. For example, the decoder 17000 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 17000 may be played through a player.

The decoder 17000 may receive a signal output from the encoder in the form of a bitstream, and the received signal may be decoded through the entropy decoder 17010. For example, the entropy decoder 17010 may parse the bitstream to derive information (e.g., video/image information) necessary for image reconstruction (or picture reconstruction). For example, the entropy decoder 17010 may decode the information in the bitstream based on a coding technique such as exponential Golomb coding, CAVLC, or CABAC, output values of syntax elements required for image reconstruction, and quantized values of transform coefficients for the residual. More specifically, in the CABAC entropy decoding, a bin corresponding to each syntax element in the bitstream may be received, and a context model may be determined based on decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. According to the CABAC entropy decoding, after a context model is determined, the context model may be updated based on the information about the symbol/bin decoded for the context model of the next symbol/bin. Information about the prediction in the information decoded by the entropy decoder 17010 may be provided to the predictors (the inter-predictor 17070 and the intra-predictor 17080), and the residual values on which entropy decoding has been performed by the entropy decoder 17010, that is, the quantized transform coefficients and related parameter information, may be input to the inverse quantizer 17020. In addition, information about filtering of the information decoded by the entropy decoder 17010 may be provided to the filter 17050. A receiver (not shown) configured to receive a signal output from the encoder may be further configured as an internal/external element of the decoder 17000. Alternatively, the receiver may be a component of the entropy decoder 17010.

The inverse quantizer 17020 may output transform coefficients by inversely quantizing the quantized transform coefficients. The inverse quantizer 17020 may rearrange the quantized transform coefficients in the form of a two-dimensional block. In this case, the rearrangement may be performed based on the coefficient scan order implemented by the encoder. The inverse quantizer 17020 may perform inverse quantization on the quantized transform coefficients using a quantization parameter (e.g., quantization step size information), and acquire transform coefficients.

The inverse transformer 17030 acquires a residual signal (residual block and residual sample array) by inversely transforming the transform coefficients.

The predictor may perform prediction on the current block and generate a predicted block including prediction samples for the current block. The predictor may determine whether intra-prediction or inter-prediction is to be applied to the current block based on the information about the prediction output from the entropy decoder 17010, and may determine a specific intra-/inter-prediction mode.

The intra-predictor 17080 of the predictor may predict the current block with reference to the samples in the current picture. The samples may be positioned in the neighbor of or away from the current block depending on the prediction mode. In intra-prediction, the prediction modes may include a plurality of non-directional modes and a plurality of directional modes. The intra-predictor 17080 may determine a prediction mode to be applied to the current block, using the prediction mode applied to the neighboring block.

The inter-predictor 17070 of the predictor may derive a predicted block for the current block based on a reference block (reference sample array) specified by a motion vector on the reference picture. In this case, in order to reduce the amount of motion information transmitted in the inter-prediction mode, the motion information may be predicted on per a block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 17070 may configure a motion information candidate list based on neighboring blocks and derive a motion vector of the current block and/or a reference picture index based on the received candidate selection information. Inter-prediction may be performed based on various prediction modes. The information about the prediction may include information indicating an inter-prediction mode for the current block.

The adder 17040 may add the acquired residual signal in the inverse transformer 17030 to the prediction signal (predicted block or prediction sample array) output from the inter-predictor 17070 or the intra-predictor 17080, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 17040 may be called a reconstructor or a reconstructed block generator. The generated reconstructed signal may be used for intra-prediction of the next processing target block in the current picture, or may be used for inter-prediction of the next picture through filtering as described below.

The filter 17050 may improve subjective/objective image quality by applying filtering to the reconstructed signal output from the adder 17040. For example, the filter 17050 may generate a modified reconstructed picture by applying various filtering techniques to the reconstructed picture, and may transmit the modified reconstructed picture to the memory 17060, specifically, the DPB of the memory 17060. The various filtering techniques may include, for example, deblocking filtering, sample adaptive offset, adaptive loop filtering, and bilateral filtering.

The reconstructed picture stored in the DPB of the memory 17060 may be used as a reference picture in the inter-predictor 17070. The memory 17060 may store the motion information about a block from which the motion information is derived (or decoded) in the current picture and/or the motion information about the blocks in a picture that has already been reconstructed. The stored motion information may be delivered to the inter-predictor 17070 so as to be used as the motion information about a spatial neighboring block or the motion information about a temporal neighboring block. The memory 17060 may store the reconstructed samples of the reconstructed blocks in the current picture, and deliver the reconstructed samples to the intra-predictor 17080.

In the present disclosure, the embodiments described regarding the filter 15070, the inter-predictor 15090, and the intra-predictor 15100 of the encoder 15000 of FIG. 15 may be applied to the filter 17050, the inter-predictor 17070 and the intra-predictor 17080 of the decoder 17000, respectively, in the same or corresponding manner.

At least one of the prediction, inverse transform, and inverse quantization procedures described above may be skipped. For example, for a block to which the pulse code modulation (PCM) is applied, the prediction, inverse transform, and inverse quantization procedures may be skipped, and the value of a decoded sample may be used as a sample of the reconstructed image.

Occupancy map decompression (16003)

This is a reverse process of the occupancy map compression described above. Occupancy map decompression is a process for reconstructing the occupancy map by decompressing the occupancy map bitstream.

Auxiliary patch information decompression (16004)

The auxiliary patch information may be reconstructed by performing the reverse process of the aforementioned auxiliary patch information compression and decoding the compressed auxiliary patch information bitstream.

Geometry reconstruction (16005)

This is a reverse process of the geometry image generation described above. Initially, a patch is extracted from the geometry image using the reconstructed occupancy map, the 2D position/size information about the patch included in the auxiliary patch information, and the information about mapping between a block and the patch. Then, a point cloud is reconstructed in a 3D space based on the geometry image of the extracted patch and the 3D position information about the patch included in the auxiliary patch information. When the geometry value corresponding to a point (u, v) within the patch is g (u, v), and the coordinates of the position of the patch on the normal, tangent and bitangent axes of the 3D space are (δ0, s0, r0), δ(u, v), s (u, v), and r (u, v), which are the normal, tangent, and bitangent coordinates in the 3D space of a position mapped to point (u, v) may be expressed as follows:
δ(u, v)=δ0+g (u, v)
s(u, v)=s0+u
r(u, v)=r0+v.

### Smoothing (16006)

Smoothing, which is the same as the smoothing in the encoding process described above, is a process for eliminating discontinuity that may occur on the patch boundary due to deterioration of the image quality occurring during the compression process.

Texture reconstruction (16007)

Texture reconstruction is a process of reconstructing a color point cloud by assigning color values to each point constituting a smoothed point cloud. It may be performed by assigning color values corresponding to a texture image pixel at the same position as in the geometry image in the 2D space to points of a point of a point cloud corresponding to the same position in the 3D space, based on the geometry image reconstructed in the geometry reconstruction process and the mapping information of the point cloud described above.

Color smoothing (16008)

Color smoothing is similar to the process of geometry smoothing described above. Color smoothing is a process for eliminating discontinuity that may occur on the patch boundary due to deterioration of the image quality occurring during the compression process. Color smoothing may be performed through the following operations:

1) Calculate neighboring points of each point constituting the reconstructed point cloud using the K-D tree or the like. The neighboring point information calculated in the geometry smoothing process described above may be used.

2) Determine whether each of the points is positioned on the patch boundary. These operations may be performed based on the boundary information calculated in the geometry smoothing process described above.

3) Check the distribution of color values for the neighboring points of the points present on the boundary and determine whether smoothing is to be performed. For example, when the entropy of luminance values is less than or equal to a threshold local entry (there are many similar luminance values), it may be determined that the corresponding portion is not an edge portion, and smoothing may be performed. As a method of smoothing, the color value of the point may be replaced with the average of the color values of the neighboring points.

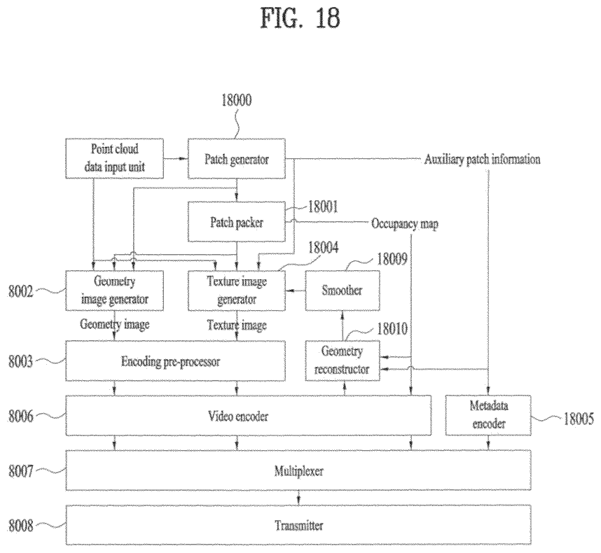

FIG. 18 is a flowchart illustrating operation of a transmission device for compression and transmission of V-PCC based point cloud data according to embodiments of the present disclosure.

The transmission device according to the embodiments may correspond to the transmission device of FIG. 1, the encoding process of FIG. 4, and the 2D video/image encoder of FIG. 15, or perform some/all of the operations thereof. Each component of the transmission device may correspond to software, hardware, a processor and/or a combination thereof.

An operation process of the transmission terminal for compression and transmission of point cloud data using V-PCC may be performed as illustrated in the figure.

The point cloud data transmission device according to the embodiments may be referred to as a transmission device or a transmission system.

Regarding a patch generator 18000, a patch for 2D image mapping of a point cloud is generated based on input point cloud data. Patch information and/or auxiliary patch information is generated as a result of the patch generation. The generated patch information and/or auxiliary patch information may be used in the processes of geometry image generation, texture image generation, smoothing, and geometry reconstruction for smoothing.

The patch packer 18001 performs a patch packing process of mapping the patches generated by the patch generator 18000 into a 2D image. For example, one or more patches may be packed. An occupancy map may be generated as a result of the patch packing. The occupancy map may be used in the processes of geometry image generation, geometry image padding, texture image padding, and/or geometry reconstruction for smoothing.

The geometry image generator 18002 generates a geometry image based on the point cloud data, the patch information (or auxiliary patch information), and/or the occupancy map. The generated geometry image is pre-processed by the encoding pre-processor 18003 and then encoded into one bitstream by the video encoder 18006.

The encoding pre-processor 18003 may include an image padding procedure. In other words, the generated geometry image and some spaces in the generated texture image may be padded with meaningless data. The encoding pre-processor 18003 may further include a group dilation procedure for the generated texture image or the texture image on which image padding has been performed.

The geometry reconstructor 18010 reconstructs a 3D geometry image based on the geometry bitstream, auxiliary patch information, and/or occupancy map encoded by the video encoder 18006.

The smoother 18009 smoothes the 3D geometry image reconstructed and output by the geometry reconstructor 18010 based on the auxiliary patch information, and outputs the smoothed 3D geometry image to the texture image generator 18004.

The texture image generator 18004 may generate a texture image based on the smoothed 3D geometry, point cloud data, patch (or packed patch), patch information (or auxiliary patch information), and/or occupancy map. The generated texture image may be pre-processed by the encoding pre-processor 18003 and then encoded into one video bitstream by the video encoder 18006.

The metadata encoder 18005 may encode the auxiliary patch information into one metadata bitstream.

The video encoder 18006 may encode the geometry image and the texture image output from the encoding pre-processor 18003 into respective video bitstreams, and may encode the occupancy map into one video bitstream. According to an embodiment, the video encoder 18006 encodes each input image by applying the 2D video/image encoder of FIG. 15.

The multiplexer 18007 multiplexes the video bitstream of geometry, the video bitstream of the texture image, the video bitstream of the occupancy map, which are output from the video encoder 18006, and the bitstream of the metadata (including auxiliary patch information), which is output from the metadata encoder 18005, into one bitstream.

The transmitter 18008 transmits the bitstream output from the multiplexer 18007 to the receiving side. Alternatively, a file/segment encapsulator may be further provided between the multiplexer 18007 and the transmitter 18008, and the bitstream output from the multiplexer 18007 may be encapsulated in the form of a file and/or segment and output to the transmitter 18008.

The patch generator 18000, the patch packer 18001, the geometry image generator 18002, the texture image generator 18004, the metadata encoder 18005, and the smoother 18009 of FIG. 18 may correspond to the patch generation 14000, the patch packing 14001, the geometry image generation 14002, the texture image generation 14003, the auxiliary patch information compression 14005, and the smoothing 14004, respectively. The encoding pre-processor 18003 of FIG. 18 may include the image padders 14006 and 14007 and the group dilator 14008 of FIG. 4, and the video encoder 18006 of FIG. 18 may include the video compressors 14009, 14010, and 14011 and/or the entropy compressor 14012 of FIG. 4. For parts not described with reference to FIG. 18, refer to the description of FIGS. 4 to 15. The above-described blocks may be omitted or may be replaced by blocks having similar or identical functions. In addition, each of the blocks shown in FIG. 18 may operate as at least one of a processor, software, or hardware. Alternatively, the generated video bitstreams of the geometry, the texture image, and the occupancy map and the metadata bitstream of the auxiliary patch information may be formed into one or more track data in a file or encapsulated into segments and transmitted to the receiving side through a transmitter.

Procedure of operating the reception device

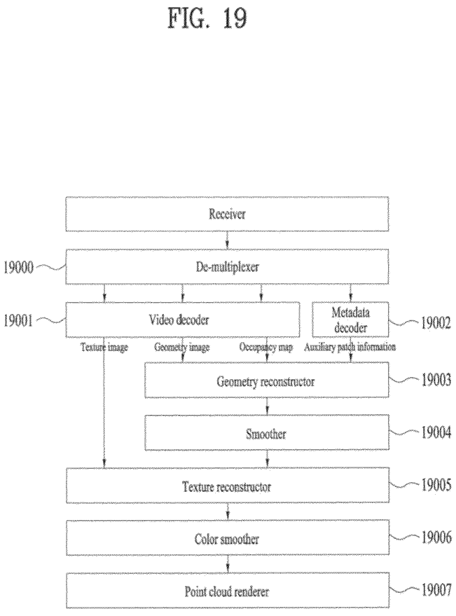

FIG. 19 is a flowchart illustrating operation of a reception device for receiving and restoring V-PCC-based point cloud data according to embodiments.

The reception device according to the embodiments may correspond to the reception device of FIG. 1, the decoding process of FIG. 16, and the 2D video/image encoder of FIG. 17, or perform some/all of the operations thereof. Each component of the reception device may correspond to software, hardware, a processor and/or a combination thereof.

The operation of the reception terminal for receiving and reconstructing point cloud data using V-PCC may be performed as illustrated in the figure. The operation of the V-PCC reception terminal may follow the reverse process of the operation of the V-PCC transmission terminal of FIG. 18.

The point cloud data reception device according to the embodiments may be referred to as a reception device, a reception system, or the like.

The receiver receives a bitstream (i.e., compressed bitstream) of a point cloud, and the demultiplexer 19000 demultiplexes a bitstream of a texture image, a bitstream of a geometry image, and a bitstream of an occupancy map image, and a bitstream of metadata (i.e., auxiliary patch information) from the received point cloud bitstream. The demultiplexed bitstreams of the texture image, the geometry image, and the occupancy map image are output to the video decoder 19001, and the bitstream of the metadata is output to the metadata decoder 19002.

According to an embodiment, when the transmission device of FIG. 18 is provided with a file/segment encapsulator, a file/segment decapsulator is provided between the receiver and the demultiplexer 19000 of the receiving device of FIG. 19 as. In this case, the transmission device encapsulates and transmits the point cloud bitstream in the form of a file and/or segment, and the reception device receives and decapsulates the file and/or segment containing the point cloud bitstream.

The video decoder 19001 decodes the bitstream of the geometry image, the bitstream of the texture image, and the bitstream of the occupancy map image into the geometry image, the texture image, and the occupancy map image, respectively. According to an embodiment, the video decoder 19001 performs the decoding operation by applying the 2D video/image decoder of FIG. 17 to each input bitstream. The metadata decoder 19002 decodes the bitstream of metadata into auxiliary patch information, and outputs the information to the geometry reconstructor 19003.

The geometry reconstructor 19003 reconstructs the 3D geometry based on the geometry image, the occupancy map, and/or auxiliary patch information output from the video decoder 19001 and the metadata decoder 19002.

The smoother 19004 smoothes the 3D geometry reconstructed by the geometry reconstructor 19003.

The texture reconstructor 19005 reconstruct the texture using the texture image output from the video decoder 19001 and/or the smoothed 3D geometry. That is, the texture reconstructor 19005 reconstructs the color point cloud image/picture by assigning color values to the smoothed 3D geometry using the texture image. Thereafter, in order to improve objective/subjective visual quality, a color smoothing process may be additionally performed on the color point cloud image/picture by the color smoother 19006. The modified point cloud image/picture derived through the operation above is displayed to the user after the rendering process in the point cloud renderer 19007. In some cases, the color smoothing process may be omitted.

The above-described blocks may be omitted or may be replaced by blocks having similar or identical functions. In addition, each of the blocks shown in FIG. 19 may operate as at least one of a processor, software, and hardware.

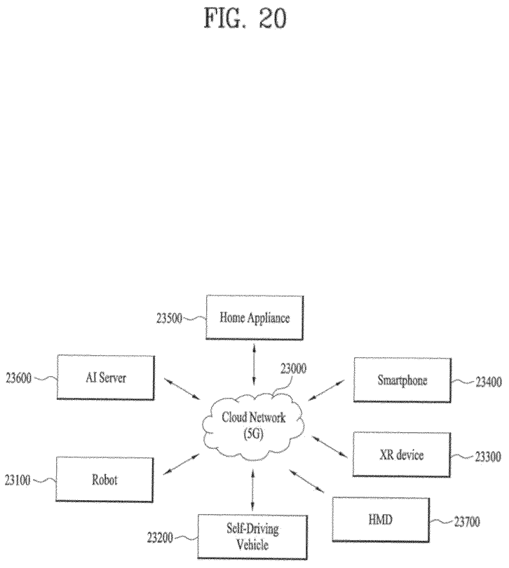

FIG. 20 illustrates an exemplary structure operable in connection with point cloud data transmission/reception methods/devices according to embodiments.

In the structure according to the embodiments, at least one of a server 23600, a robot 23100, a self-driving vehicle 23200, an XR device 23300, a smartphone 23400, a home appliance 23500 and/or a head-mount display (HMD) 23700 is connected to a cloud network 23000. Here, the robot 23100, the self-driving vehicle 23200, the XR device 23300, the smartphone 23400, or the home appliance 23500 may be referred to as a device. In addition, the XR device 23300 may correspond to a point cloud data (PCC) device according to embodiments or may be operatively connected to the PCC device.

The cloud network 23000 may represent a network that constitutes part of the cloud computing infrastructure or is present in the cloud computing infrastructure. Here, the cloud network 23000 may be configured using a 3G network, 4G or Long Term Evolution (LTE) network, or a 5G network.

The server 23600 may be connected to at least one of the robot 23100, the self-driving vehicle 23200, the XR device 23300, the smartphone 23400, the home appliance 23500, and/or the HMD 23700 over the cloud network 23000 and may assist at least a part of the processing of the connected devices 23100 to 23700.

The HMD 23700 represents one of the implementation types of the XR device and/or the PCC device according to the embodiments. An HMD type device according to embodiments includes a communication unit, a control unit, a memory, an I/O unit, a sensor unit, and a power supply unit.

Hereinafter, various embodiments of the devices 23100 to 23500 to which the above-described technology is applied will be described. The devices 23100 to 23500 illustrated in FIG. 20 may be operatively connected/coupled to a point cloud data transmission and reception device according to the above-described embodiments.

### <PCC+XR>

The XR/PCC device 23300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 23300 may analyze 3D point cloud data or image data acquired through various sensors or from an external device and generate position data and attribute data about 3D points. Thereby, the XR/PCC device 23300 may acquire information about the surrounding space or a real object, and render and output an XR object. For example, the XR/PCC device 23300 may match an XR object including auxiliary information about a recognized object with the recognized object and output the matched XR object.

### <PCC+Self-driving+XR>

The self-driving vehicle 23200 may be implemented as a mobile robot, a vehicle, an unmanned aerial vehicle, or the like by applying the PCC technology and the XR technology.

The self-driving vehicle 23200 to which the XR/PCC technology is applied may represent an autonomous vehicle provided with means for providing an XR image, or an autonomous vehicle that is a target of control/interaction in the XR image. In particular, the self-driving vehicle 23200, which is a target of control/interaction in the XR image, may be distinguished from the XR device 23300 and may be operatively connected thereto.

The self-driving vehicle 23200 having means for providing an XR/PCC image may acquire sensor information from the sensors including a camera, and output the generated XR/PCC image based on the acquired sensor information. For example, the self-driving vehicle may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap the object on the screen. For example, the self-driving vehicle may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only real-world objects, backgrounds, and the like as CG images. On the other hand, the AR technology refers to a technology for showing a CG image virtually created on a real object image. The MR technology is similar to the AR technology described above in that virtual objects to be shown are mixed and combined with the real world. However, the MR technology differs from the AR technology makes a clear distinction between a real object and a virtual object created as a CG image and uses virtual objects as complementary objects for real objects, whereas the MR technology treats virtual objects as objects having the same characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to all VR, AR, MR, and XR technologies. For such technologies, encoding/decoding based on PCC, V-PCC, and G-PCC techniques may be applied.

The PCC method/device according to the embodiments may be applied to the self-driving vehicle 23200 that provides a self-driving service.

The self-driving vehicle 23200 that provides the self-driving service is connected to a PCC device for wired/wireless communication.

When the point cloud compression data transmission and reception device (PCC device) according to the embodiments is connected to self-driving vehicle 23200 for wired/wireless communication, the device may receive and process content data related to an AR/VR/PCC service that may be provided together with the self-driving service and transmit the processed content data to the self-driving vehicle 23200. In the case where the point cloud data transmission and reception device is mounted on the self-driving vehicle 23200, the point cloud transmitting and reception device may receive and process content data related to the AR/VR/PCC service according to a user input signal input through a user interface device and provide the processed content data to the user. The self-driving vehicle 23200 or the user interface device according to the embodiments may receive a user input signal. The user input signal according to the embodiments may include a signal indicating the self-driving service.

Related technologies have been proposed to enable point cloud data compressed by V-PCC to be reconstructed and displayed at the receiving side. The term V-PCC used herein has the same meaning as visual volumetric video-based coding (V3C), and both terms may be used interchangeably. Therefore, the term V-PCC may be construed as V3C. Generally, when the point cloud data is displayed, the point cloud data may be transformed into mesh (e.g., triangle or polygon) information and displayed. That is, when the point cloud data is displayed, the point cloud data may be transformed and displayed in the form of a mesh according to the characteristics of the displayed application. In the present disclosure, three vertices may be grouped to form one surface. A triangle formed of the three vertices may be referred to as a polygon, and an object in a 3D space formed by a group of polygons may be referred to as a mesh.

According to embodiments, the mesh data includes geometry information, attribute information, an occupancy map, auxiliary information (or patch information), and connectivity information. Accordingly, in the present disclosure, the connectivity information is referred to as vertex connectivity information, mesh connectivity information, mesh information, or connectivity information about the mesh data. Herein, the geometry information and attribute information are referred to as point cloud data. Also, the geometry image, the attribute image, the occupancy map, and the auxiliary information (or patch information) generated through patch generation and packing based on the geometry information and the attribute information are referred to as point cloud data. Accordingly, point cloud data including connectivity information may be referred to as mesh data. According to embodiments, the geometry information includes the position (coordinates) of each vertex, and the attribute information includes various kinds of information including color information and normal vector information. The connectivity information includes information on how each of the vertices constitutes a surface. When data input for encoding is mesh data, the geometry information is referred to as vertex position information (vertex coordinates), the attribute information is referred to as vertex attribute information, and the connectivity information may be referred to as vertex connectivity information (or mesh connectivity information). In the present disclosure, a vertex may have the same meaning as a point including geometry information and attribute information. Therefore, each vertex (i.e., each point) may have a 3D position, that is, geometry information and a plurality of attributes, for example, color, reflectance, and surface normal.

However, the conventional V-PCC specification standard method does not include a connectivity information processing unit, and processes the mesh information by adding a separate process or system according to an application used.

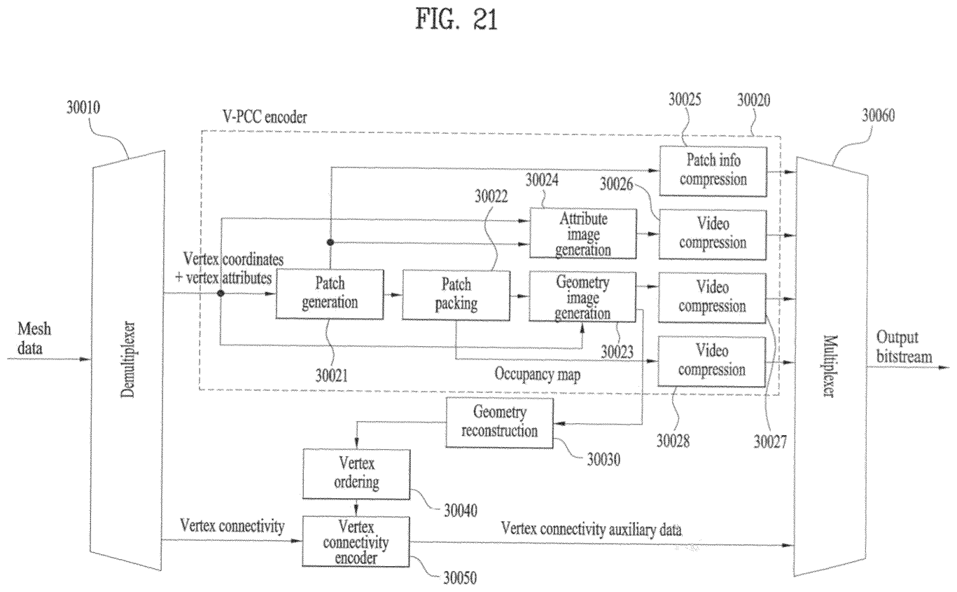

FIG. 21 illustrates another exemplary video encoder according to embodiments. That is, FIG. 21 illustrates an exemplary video encoder for compressing mesh data. In this example, a vertex connectivity encoder 30050 is separately provided in the V-PCC encoder 30020.

According to embodiments, the video encoder of FIG. 21 may include a demultiplexer 30010, a V-PCC encoder 30020, a geometry reconstructor 30030, a vertex ordering part 30040, a vertex connectivity encoder 30050, and a multiplexer 30060. According to embodiments, the geometry reconstructor 30030, the vertex ordering part 30040, and the vertex connectivity encoder 30050 may be referred to as a connectivity information processor.

The V-PCC encoder 30020 may perform some or all of the operations of the point cloud video encoder of FIG. 4.

According to embodiments, when mesh data is input, the demultiplexer 30010 demultiplexes vertex position information, vertex attribute information, and vertex connectivity information. Then, it outputs the vertex position information and vertex attribute information to a patch generator 30021, a geometry image generator 30023, and an attribute image generator 30024 of the V-PCC encoder 30020, and outputs the vertex connectivity information to the vertex connectivity encoder 30050.

According to embodiments, the patch generator 30021 generates a patch from the vertex position information and vertex attribute information. In addition, the patch generator 30021 generates patch information including information about patch generation. The patch generated by the patch generator 30021 is output to a patch packer 30022, and the patch information is output to the attribute image generator 30024 and a patch information compressor 30025. The patch information compressor 30025 compresses patch information and outputs the compressed patch information to the multiplexer 30060.

The patch packer 30022 packs one or more patches in a 2D image area. In addition, occupancy map information including information about the patch packing is generated. The occupancy map information is compressed by the video compressor 30028 and then output to the multiplexer 30060.

The geometry image generator 30023 generates a geometry image based on the vertex position information, patch information (or auxiliary patch information), and/or occupancy map information. The geometry image is compressed by the video compressor 30027 and then output to the multiplexer 30060.

The attribute image generator 3024 generates an attribute image based on the vertex position information, vertex attribute information, a patch, patch information (or auxiliary patch information). The attribute image is compressed by the video compressor 30026 and then output to the multiplexer 3060.

In addition, the geometry reconstructor 30030 outputs the reconstructed geometry information to the vertex ordering part 30040 based on the geometry image, and the vertex ordering part 30040 sorts the reconstructed geometry information in an arbitrary or predetermined order and outputs the same to the vertex connectivity encoder 30050. The vertex connectivity encoder 30050 encodes vertex connectivity information based on the sorted geometry information, compresses the encoded vertex connectivity information, and then outputs vertex connectivity auxiliary data (or a vertex connectivity information bitstream) to the multiplexer 30060.

The multiplexer 30060 multiplexes the geometry image, the attribute image, the occupancy map information, the patch information, and the vertex connectivity data from the respective compressors into one bitstream in each compression unit.

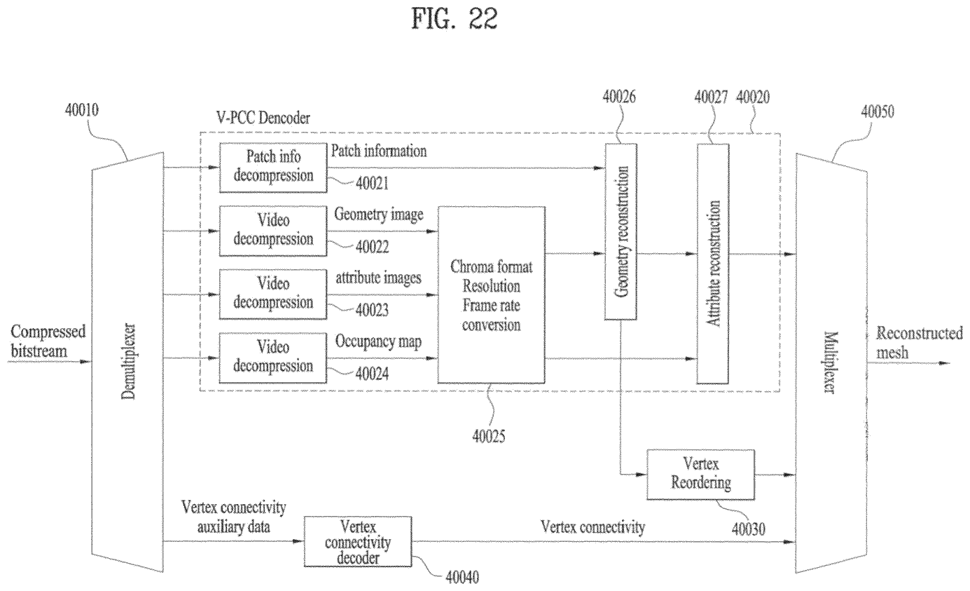

FIG. 22 illustrates another exemplary video decoder according to embodiments according to embodiments. That is, FIG. 22 illustrates an example of a video decoder for reconstructing mesh data. In the example, a vertex connectivity decoder 40040 is separately provided in the V-PCC decoder 40020.

According to embodiments, the video decoder of FIG. 22 may include a demultiplexer 40010, a V-PCC decoder 40020, a vertex reordering part 40030, a vertex connectivity decoder 40040, and a multiplexer 40050. According to embodiments, the vertex reordering part 40030 and the vertex connectivity decoder 40040 may be referred to as a connectivity information processor.

The V-PCC decoder 40020 may perform some or all of the operations of the point cloud video decoder of FIG. 16.

According to embodiments, the demultiplexer 40010 demultiplexes the compressed bitstream to output the compressed patch information, the compressed attribute image, the compressed geometry image, the compressed occupancy map information, and the vertex connectivity auxiliary data, respectively. The compressed patch information is output to the patch information decompressor 40021 of the V-PCC decoder 40020, and the compressed geometry image is output to the video decompressor 40022. The compressed attribute image is output to the video decompressor 40023 so as to be decompressed, and the compressed occupancy map information is output to the video decompressor 40024 so as to be decompressed. The decompressed patch information is output to the geometry reconstructor 40026.

According to embodiments, the converter 40025 performs chroma format conversion, resolution conversion, frame rate conversion, and the like based on the decompressed geometry image, the decompressed attribute image, and the decompressed occupancy map information.

The geometry reconstructor 40026 restores (reconstructs) geometry information based on the decompressed patch information and the output of the converter 40025 and outputs the reconstructed geometry information to the attribute reconstructor 40027.

The attribute reconstructor 40027 restores (reconstructs) attribute information based on the output of the converter 40025 and the reconstructed geometry information and outputs the reconstructed attribute information to the multiplexer 40050.

The vertex reordering part 40030 sorts the geometry information reconstructed by the geometry reconstructor 40026 in the reverse order of the transmitting side and outputs the sorted geometry information to the multiplexer 40050.

The vertex connectivity decoder 40040 decodes the vertex connectivity auxiliary data output from the demultiplexer 40010, restores vertex connectivity information, and outputs the vertex connectivity information to the multiplexer 40050.

The multiplexer 40050 multiplexes the output of the attribute reconstructor 40027, the output of the vertex reordering part 40030, and the output of the vertex connectivity decoder 40040 and outputs the reconstructed mesh data.

As such, since the V-PCC encoding/decoding standard does not consider mesh (triangle, polygon) information, a separate vertex connectivity encoder is added to the V-PCC encoder on the transmitting side as shown in FIG. 21, and a separate vertex connectivity decoder is added to the V-PCC decoder on the receiving side as shown in FIG. 22 to process data containing vertex connectivity information. The added vertex connectivity encoder encodes the vertex connectivity information about the mesh data and transmits the encoded information as a vertex connectivity information bitstream (i.e., vertex connectivity auxiliary data), and the vertex connectivity decoder decodes the received vertex connectivity information bitstream (i.e., vertex connectivity auxiliary data) to restore the vertex connectivity information.

In this case, the vertex connectivity encoder encodes the vertex connectivity information on a frame-by-frame basis and transmits a bitstream corresponding to one frame. Therefore, when only the vertex connectivity information about some regions in a frame is transmitted, it is required to decode the bitstream on a frame-by-frame basis and then encode the bitstream those regions. Also, this approach may not allow for parallel processing and may not be robust to packet loss errors.

In order to address these issues, the present disclosure proposes a structure for encoding/decoding, on a basis of connectivity subgroups in a frame, connectivity information (or vertex connectivity information) about mesh data encoded/decoded on a per frame basis. In the present disclosure, the connectivity information subgroup has the same meaning as the connectivity patch. Also, the present disclosure proposes a method of transmitting information about mapping to an index of vertex unit data corresponding to a vertex index of vertex connectivity information on a per connectivity subgroup basis. That is, the present disclosure proposes a structure, syntax, and semantics for splitting vertex connectivity information in one frame into a plurality of connectivity patches in the operation of encoding/decoding mesh data based on V-PCC, and performing encoding/decoding on a per split connectivity patch basis.

Accordingly, parallel encoding/decoding and selective transmission may be enabled, and an application using mesh data may selectively transmit a connectivity subgroup bitstream corresponding to an area within a user view. Thereby, transmission efficiency may be improved.

More specifically, the present disclosure proposes a structure in which connectivity information in one frame is split into a plurality of connectivity patches, and encoding and decoding are performed on a per split connectivity patch basis. Also, the present disclosure proposes a method of splitting connectivity information in one frame into a plurality of connectivity patches. In addition, the present disclosure proposes a method by which the transmitting side transmits information about mapping between a reconstructed vertex index of the connectivity information and a corresponding geometry information index, and the decoder corrects the reconstructed vertex index based on the received mapping information. The present disclosure defines connectivity information composed of vertices (or points) in a reconstructed geometry 3D patch as a connectivity patch. In the present disclosure, one piece of connectivity information is composed of three vertices forming a triangle among vertices in a frame.

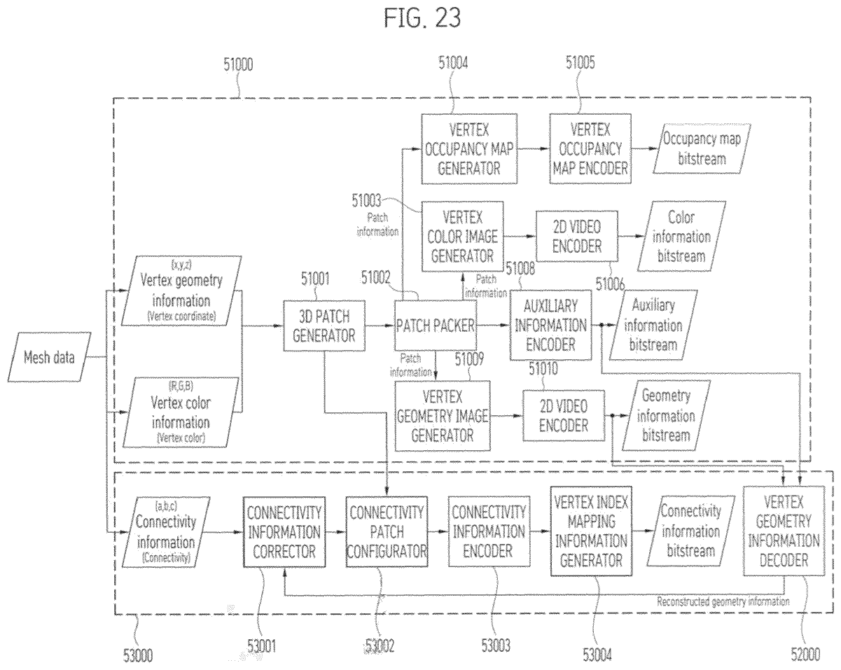

FIG. 23 illustrates another exemplary video encoder according to embodiments. That is, FIG. 23 illustrates another exemplary video encoder for compressing mesh data, which may include a V-PCC encoder 51000 and a connectivity information processor 53000.

The V-PCC encoder 51000 may include a patch generator 51001, a patch packer 51002, a vertex attribute image generator 51003, a vertex occupancy map generator 51004, a vertex occupancy map encoder 51005, a 2D video encoder 51006, an auxiliary information encoder 51008, a vertex geometry image generator 51009, and a 2D video encoder 51010. According to embodiments, the vertex occupancy map encoder 51005 and the 2D video encoders 51006 and 51010 may each be referred to as a video compressor.

The V-PCC encoder 51000 may perform some or all of the operations of the V-PCC encoder 30020 of FIG. 21 or the point cloud video encoder of FIG. 4.

The connectivity information processor 53000 may include a geometry reconstructor 52000, a connectivity information corrector 53001, a connectivity patch configurator 53002, a connectivity information encoder 53003, and a vertex index mapping information generator 53004. The geometry reconstructor 52000 may be referred to as a vertex geometry decoder. Also, the video decoder of FIG. 23 may be referred to as a mesh decoder.

Each component of FIG. 23 may correspond to software, hardware, a processor, and/or a combination thereof.

According to embodiments, the video decoder of FIG. 23 may correct the connectivity information with the reconstructed geometry information and split the frame-by-frame corrected connectivity information into connectivity patches. After the connectivity information is encoded on the basis of split connectivity patches, information (e.g. a vertex index mapping list) mapping a vertex index of each connectivity patch to a vertex index of a corresponding frame may be generated for each connectivity patch by the vertex index mapping information generator 53004. Each operation is performed according to the principles described in detail below.

According to embodiments, when mesh data is input, the demultiplexer (not shown) demultiplexes vertex position information (vertex coordinates) (e.g., x, y, z), vertex attribute information (e.g., RGB color information), and vertex connectivity information. Then, it outputs the vertex position information and vertex attribute information to the patch generator 51001 of the V-PCC encoder 51000, and outputs the vertex connectivity information to the vertex connectivity corrector 53001 of the connectivity information processor 53000.

According to embodiments, the patch generator 51001 generates 3D patches based on the vertex position information and vertex attribute information. That is, the patch generator 51001 receives the vertex position information and/or vertex attribute information (e.g., vertex color information and/or normal information) as input, and generates multiple 3D patches based on the information. Here, a patch is a set of points constituting a point cloud (or mesh data), and points belonging to the same patch are adjacent to each other in a 3D space and are mapped in the same direction of a bounding box having 6 faces in the operation of mapping to a 2D image. In this case, each split 3D patch may be determined based on the normal information and/or the color information about the optimal projection plane for the patch.

Further, the patch generator 51001 outputs information about patch generation to the connectivity patch configurator 53002 of the connectivity information processor 53000.

According to embodiments, the information about the patch generation refers to the point splitting information generated in the process of generating one or more 3D patches by the patch generator 51001.

The one or more 3D patches generated by the patch generator 51001 are output to the patch packer 51002. The patch packer 51002 packs one or more 3D patches in a 2D image region. That is, the patch packer 51002 determines the positions where the patches determined by the patch generator 51001 are to be packed in a W×H image space without overlapping each other. According to an embodiment, the patches may be packed such that, when the W×H image space is divided into a grid of M×N spaces, only one patch is present in an MxN space. Also, the patch packer 51002 outputs patch information including information about patch generation and/or information about patch packing to the vertex occupancy map generator 51004, the vertex attribute image generator 51003, and the vertex geometry image generator 51009.

The vertex occupancy map generator 51004 generates map information based on the patch information. That is, the vertex occupancy map generator 51004 may generate an occupancy map, in which a pixel to which a vertex is projected is set to 1 and an empty pixel is set to 0, based on the patch information generated by the patch packer 51002. The occupancy map is encoded (or compressed) by the vertex occupancy map encoder 51005, and is then output in the form of an occupancy map bitstream. In other words, the vertex occupancy map encoder 51005 encodes a binary image indicating whether a vertex (or point) projected onto a corresponding pixel is present in an image space in which the patches determined by the patch packer 51002 are positioned. According to an embodiment, the occupancy map binary image may be encoded by a 2D video encoder.

The vertex attribute image generator 51003 generates an attribute image based on the vertex position information, vertex attribute information, patch, patch information (or auxiliary patch information). That is, when the vertex attribute information (e.g., vertex color information) is present in the original mesh data, the vertex attribute image generator 51003 generates vertex attribute information about the projected patch as a vertex attribute image. The vertex attribute image is encoded (or compressed) by the 2D video encoder 51006 and is then output in the form of on an attribute information bitstream.

The vertex geometry image generator 51009 generates a geometry image based on the vertex position information, patch information (or auxiliary patch information), and/or occupancy map information. That is, the vertex geometry image generator 51009 configures and generates a single channel image (i.e., a vertex geometry image) for a distance from each vertex to a plane onto which each vertex is projected, based on the patch information generated by the patch packer 51002. The vertex geometry image is encoded (or compressed) by the 2D video encoder 51010 and is then output in the form of a geometry information bitstream.

The auxiliary information encoder 51008 encodes the patch information (which is referred to as auxiliary patch information or auxiliary information) and outputs an auxiliary information bitstream. That is, the auxiliary information encoder 51008 may encode an MxN patch index map in a W×H image space and/or a 3D reconstructed position (x0, y0, z0) based on the determined projection plane index per patch and/or the 2D bounding box position (u0, v0, ul, v1) of the patch, and/or the bounding box of the patch. In other words, the auxiliary patch information may include information about a position, a size, and the like of the patch in a 2D/3D space.

The geometry reconstructor 52000 reconstructs vertex geometry information from the geometry image and outputs the vertex geometry information to the connectivity information corrector 53001. That is, the geometry reconstructor 52000 reconstructs vertex geometry information based on the encoded patch auxiliary information, and outputs the reconstructed vertex geometry information to the connectivity information corrector 53001.

The connectivity information corrector 53001 may correct the connectivity information by referencing the index of vertex data of the reconstructed vertex geometry information. According to embodiments, whether the connectivity information corrector 53001 is executed may be determined on a per mesh frame basis. That is, in one embodiment, the connectivity information input to the connectivity information corrector 53001 and the corrected connectivity information are given on a frame-by-frame basis.

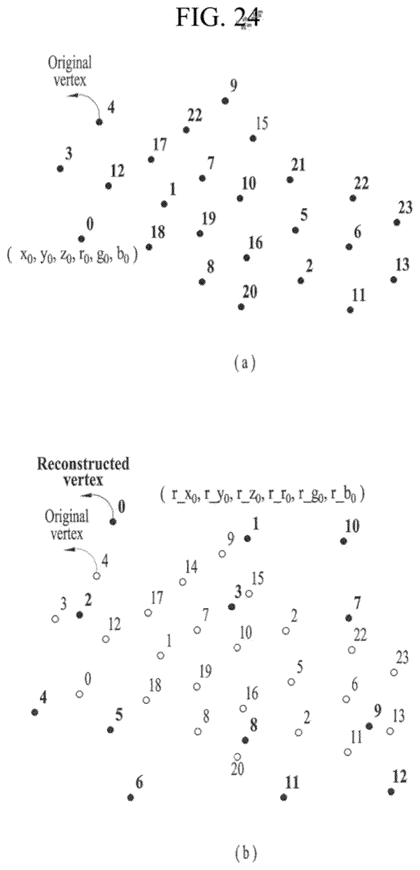

FIGS. 24-(a) and 24-(b) illustrate an example of original vertex data and reconstructed vertex data in the case of geometry lossy encoding according to embodiments. That is, FIG. 24-(a) illustrates an example of indices of original vertex data, and FIG. 24-(b) illustrates an example of indices of vertex data reconstructed by the geometry reconstructor 52000 (which is referred to as reconstructed vertex geometry information or reconstructed geometry information). In this example, each vertex includes position information and color information.

Referring to FIGS. 24-(a) and 24-(b), due to the geometry lossy encoding, for original vertex data consisting of 24 vertices (or points) (e.g., indices 0 to 23), 13 vertices (or points) (indices 0 to 12) (i.e., reconstructed vertex data) are reconstructed by the geometry reconstructor 52000. In other words, when the geometry information is lossy encoded, the number of vertices (i.e., points) of the reconstructed vertex geometry information may be changed and/or the vertex geometry information (i.e., the position) may be changed by a quantization process compared to the original vertex data, as shown in FIG. 24-(b).

As described above, the reconstructed vertex geometry information (or reconstructed vertex data) may have a changed number of vertices and changed positions of the vertices compared to the original vertex data. Accordingly, the connectivity information corrector 53001 may correct the connectivity information with reference to the indices of the vertex data of the reconstructed vertex geometry information.

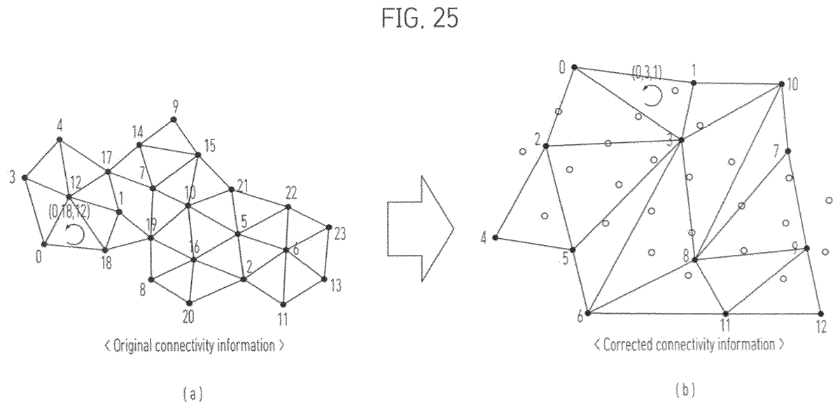

FIG. 25-(a) illustrates an example of original connectivity information according to embodiments, and FIG. 25-(b) illustrates an example of corrected connectivity information according to embodiments.

For example, if the original connectivity information configured based on FIG. 24-(a) is given as shown in FIG. 25-(a), the connectivity information corrector 53001 may correct the connectivity information based on the reconstructed vertex geometry information shown in FIG. 24-(b), as shown in FIG. 25-(b).

If the connectivity information with index 0 in FIG. 25-(a) is (0, 18, 12), the connectivity information with index 0 in FIG. 25-(b) is corrected to (0, 3, 1). In other words, the connectivity information may be corrected based on the reconstructed vertex geometry information. Then, the corrected connectivity information may be encoded.

The connectivity information corrected by the connectivity information corrector 53001 is output to the connectivity patch configurator 53002.

The connectivity patch configurator 53002 divides the corrected connectivity information into a plurality of connectivity patches. According to an embodiment, the corrected connectivity information may be frame-based connectivity information. According to embodiments, the connectivity patch configurator 53002 may split the connectivity information in one frame into multiple connectivity patches based on the point division information provided by the patch generator 51001. According to an embodiment, the point division information is information generated in a process of generating one or more 3D patches by the patch generator 51001.

According to embodiments, the connectivity patches split by the connectivity patch configurator 53002 may be based on 3D patches generated by the patch generator 51001. In other words, the connectivity patch configurator 53002 may divide the connectivity information in one frame into 3D patches.

Hereinafter, various embodiments of the connectivity patch splitting method will be described. That is, a description will be given of how the corrected connectivity information is divided into connectivity patches.

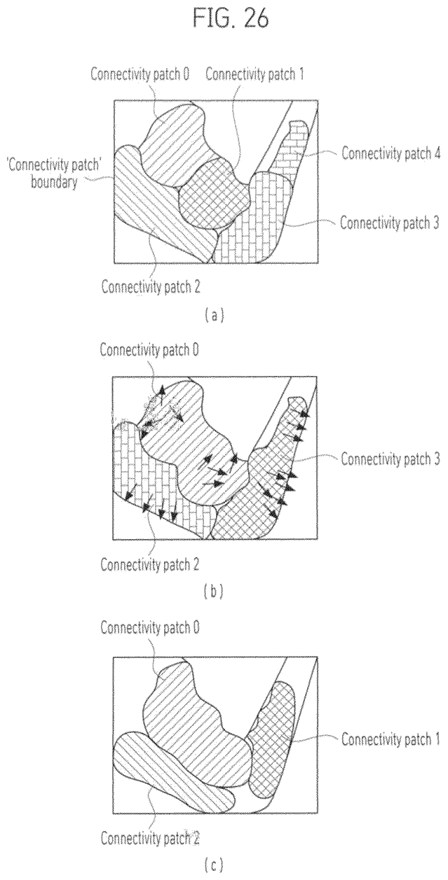

FIG. 26-(a) illustrates a connectivity patch splitting method according to a first embodiment.

In FIG. 26-(a), connectivity information between reconstructed vertices included in one 3D patch determined (or generated or divided) by the patch generator 51001 constitutes one connectivity patch. That is, the vertices included in the 3D patch generated by the patch generator 51001 may be reconstructed by the geometry reconstructor 52000, and the connectivity information between the reconstructed vertices may be one connectivity patch. In other words, the 3D patch generated based on V-PCC and the connectivity patch generated by the connectivity patch configurator 53002 are the same unit.

In FIG. 26-(a), for example, when five 3D patches are generated by the patch generator 51001, the connectivity information in one frame is also split into five connectivity patches (connectivity patch 0 to connectivity patch 4) by the connectivity patch configurator 53002. That is, the area of the five connectivity patches (i.e., the connectivity patch 0 to connectivity patch 4) is the area of the 3D patches in terms of V-PCC. This means that information about each 3D patch is received, and the connectivity information in the frame is divided into connectivity patches in units of 3D patches.

FIG. 26-(b) illustrates a connectivity patch splitting method according to a second embodiment.

That is, like FIG. 26-(a), FIG. 26-(b) illustrates an example in which one or more connectivity patches split from connectivity information in one frame in units of 3D patches are reconstructed based on the amount of change in normal vector.

According to the second embodiment, when connectivity information between reconstructed vertices included in one of the 3D patches determined by the patch generator 51001 constitutes one connectivity patch, the connectivity patch may be classified again based on an average or variance of the amounts of change in normal vector between adjacent vertices in the 3D patch. For example, when the difference in the average or variance of the normal vector change amounts between multiple adjacent 3D patches is less than or equal to a threshold, the vertices in the multiple 3D patches may be included in one connectivity patch. In other words, two or more connectivity patches among the connectivity patches configured as shown in FIG. 26-(a) are compared with each other in terms of the average or variance of the normal vector change amounts. If the difference between the two or more connectivity patches is not significant, the connectivity patches may be integrated into one connectivity patch. In other words, FIG. 26-(b) compares the averages or variances of the normal vector change amount to combine 3D patches (or connectivity patches) having no large variation to configure one connectivity patch. For example, connectivity patches 0 and 1 in FIG. 26-(a) are combined to reconstruct one connectivity patch (i.e., connectivity patch 0) in FIG. 26-(b). Also, connectivity patches 3 and 4 in FIG. 26-(a) are combined to reconstruct one connectivity patch (i.e., connectivity patch 1) in FIG. 26-(b). That is, in FIG. 26-(a), there are five split connectivity patches (or 3D patches) from one frame, and combining connectivity patches (or 3D patches) that exhibit insignificant variation in normal vector (or exhibit similar variations in normal vector) result in three split connectivity patches from one frame as shown in FIG. 26-(b).

FIG. 26-(c) illustrates a connectivity patch splitting method according to a third embodiment.

That is, FIG. 26-(c) illustrates an example of splitting connectivity information in a frame into a plurality of connectivity patches based on a normal vector between reconstructed vertices.

According to the third embodiment, the reconstructed vertices may be grouped based on the reconstructed vertex normal vector, and the connectivity information between the reconstructed vertices included in one group may constitute one connectivity patch. In this case, information on the number of several connectivity patches into which the connectivity information in one frame is split may be given. The number information may be carried in the signaling information that is transmitted to the receiving side.

For example, an area in which the variance of the value of the normal vector on each axis is less than or equal to a threshold or an area where the difference of the value from the average is less than or equal to a threshold may be configured as one connectivity patch.

Referring to FIG. 26-(c), for example, the connectivity information in one frame is split into three connectivity patches (connectivity patch 0 to connectivity patch 2) based on the normal vector of the reconstructed vertices.

In other words, in the third embodiment, one connectivity patch is configured by grouping similar pieces of connectivity information determined by comparing normal vectors of the geometry information reconstructed in the frame regardless of the 3D patches.

According to embodiments, when the connectivity information in one frame is split into a plurality of connectivity patches, the connectivity information may be internal connectivity information or boundary connectivity information.

According to embodiments, the internal connectivity information may be defined as connectivity information having all vertices constituting the connectivity information included in one connectivity patch. That is, when all three vertices (i.e., points) constituting the connectivity information are included in one connectivity patch, the connectivity information is defined as internal connectivity information. In other words, when a connectivity patch may include one or more pieces of connectivity information, and the vertices of the connectivity information are included in the same connectivity patch, the connectivity information is internal connectivity information.

According to embodiments, the boundary connectivity information may be defined as connectivity information having at least two of the three vertices constituting the connectivity information included in different connectivity patches.

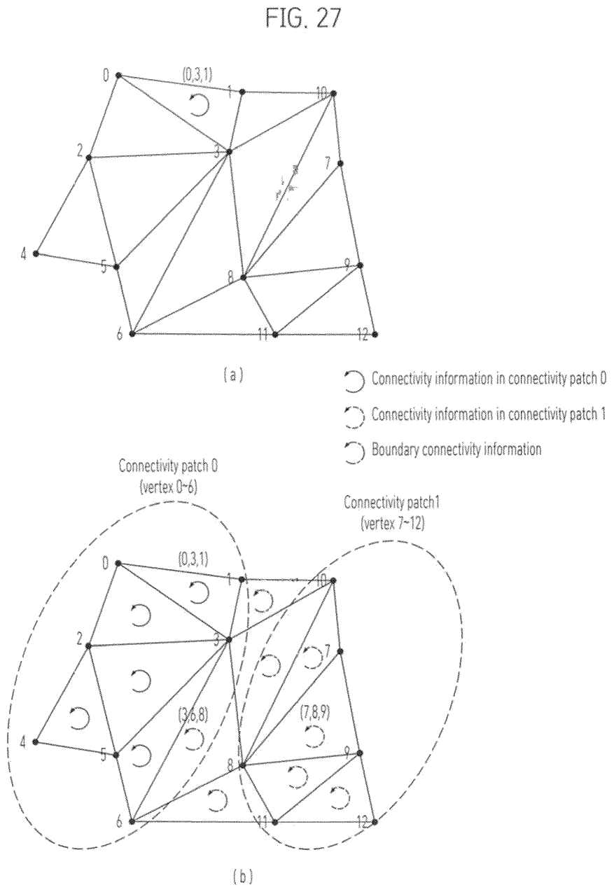

FIGS. 27-(a) and 27-(b) illustrate an exemplary method of processing boundary connectivity information according to embodiments.

Referring to FIG. 27-(b), for example, three vertices constituting the connectivity information (0, 3, 1) with index 0 are included in connectivity patch 0, and therefore the connectivity information (0, 3, 1) with index 0 is classified as internal connectivity information. On the contrary, two vertices among the three vertices constituting connectivity information (3, 6, 8) with index 3 are included in connectivity patch 0 and the other vertex is included in connectivity patch 1. Accordingly, connectivity information (3, 6, 8) with index 3 is classified as boundary connectivity information.

Therefore, in the case of FIG. 27-(b), the 13 pieces of connectivity information are divided into nine pieces of internal connectivity information (i.e., five pieces of connectivity information including all three vertices in connectivity patch 0 and four pieces of connectivity information including all three vertices in connectivity patch 1) and four pieces of boundary connectivity information including some of the vertices in connectivity patch 0 and the other of the vertices in connectivity patch 1 .

According to embodiments, the boundary connectivity information may be processed using various methods.

According to an embodiment, the internal connectivity information may be encoded and transmitted, and the boundary connectivity information may not be encoded. That is, the boundary connectivity information is neither encoded nor transmitted. In this case, the receiving side may restore the boundary connectivity information based on the internal connectivity information through post-processing. As another example, the receiving side may not restore the boundary connectivity information.

According to another embodiment, the boundary connectivity information may also be encoded and transmitted. In this case, the connectivity information may be redundantly included in a plurality of connectivity patches including the vertices constituting the boundary connectivity information and transmitted after being encoded, or may be included in one of the plurality of connectivity patches and transmitted after being encoded.

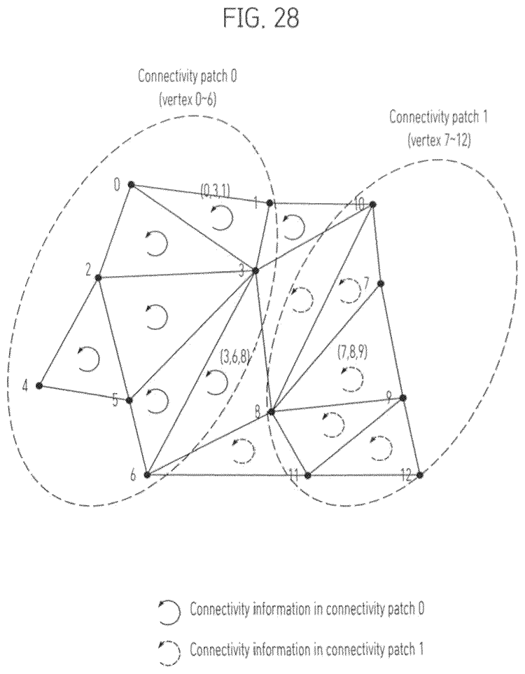

FIG. 28 illustrates another exemplary method of processing boundary connectivity information according to embodiments.

Referring to FIG. 28, two pieces of boundary connectivity information among the four pieces of boundary connectivity information are included in connectivity patch 0, and the other two pieces of boundary connectivity information are included in connectivity patch 1 .

According to embodiments, boundary connectivity information may be included in a connectivity patch including two vertices among the three vertices constituting the boundary connectivity information. In FIG. 28, in the case of connectivity information (3, 6, 8) with index 3, for example, two of the three vertices constituting connectivity information (3, 6, 8) with index 3 are included in connectivity patch 0. Accordingly, connectivity information (3, 6, 8) with index 3 may be transmitted after being included and encoded in connectivity patch 0 .

As described above, when a plurality of connectivity patches is configured, the connectivity information encoder 53003 encodes the connectivity information on a per connectivity patch basis.

According to embodiments, in the process of encoding the connectivity information by the connectivity information encoder 53003, a process of starting with a vertex in a connectivity patch and traversing the other vertices connected to the vertex may be recursively performed. In addition, when visiting a vertex, the connection relationship with other vertices connected to the vertex may be represented as the number of vertices, the structural relationship of the vertices, and the like, and the information may be signaled in signaling information to be transmitted. The connectivity information encoder 53003 may repeat the process until all the vertices are visited. Then, the encoding process of the connectivity patch may be terminated. In addition, a connectivity patch header (connectivity_patch_header) may be transmitted on a per connectivity patch basis. In the present disclosure, information transmitted in connectivity_patch_header is referred to as connectivity patch-related information.

The connectivity patch-related information may include at least a connectivity patch index (connectivity_patch_idx), a vertex and connectivity number in a connectivity patch (num_vertex, num_connectivity), or a vertex index mapping list (vertex_idx_mapping_list [i]). According to an embodiment, at least the connectivity patch index (connectivity_patch_idx), the vertex and connectivity number in a connectivity patch (num_vertex, num_connectivity), or the vertex index mapping list (vertex_idx_mapping_list [i]) may be included in the connectivity patch header. In one embodiment, the connectivity patch header may be followed by a connectivity patch payload containing encoded connectivity information.

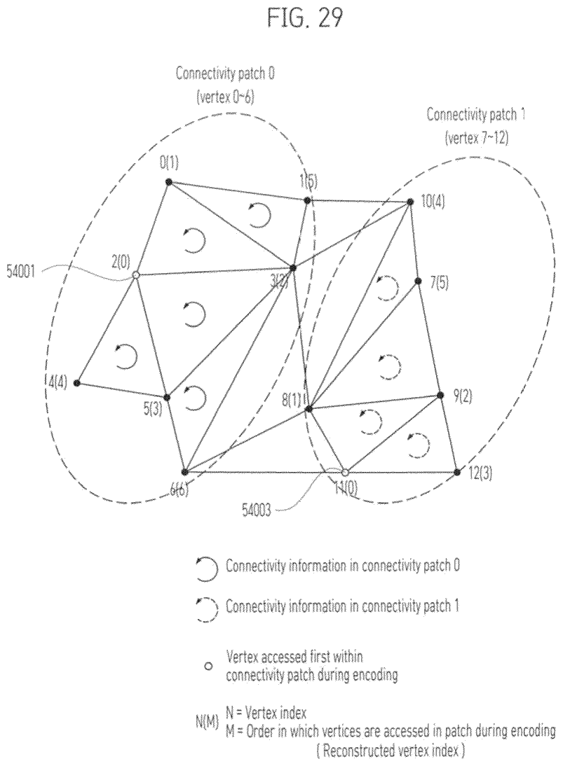

FIG. 29 illustrates an example of a vertex access order in encoding on a connectivity patch basis according to embodiments. In particular, FIG. 29 illustrates an exemplary case where boundary connectivity information is not encoded.

In FIG. 29, reference numeral 54001 indicates a vertex accessed first within connectivity patch 0 during encoding, and reference numeral 54003 indicates a vertex first accessed in connectivity patch 1 during encoding. In N (M), N denotes a vertex index and M denotes the order in which the vertices are accessed in the connectivity patch during encoding. That is, N denotes a vertex index in a frame. In this case, the vertices in the frame are vertices reconstructed by the geometry reconstructor 52000. For example, when there are 13 reconstructed vertices in one frame, the vertex index (i.e., N) has a value from 0 to 12. M denotes a vertex index in the connectivity patch. The vertices in the connectivity patch are part of the vertices reconstructed by the geometry reconstructor 52000. In other words, Nis an index allocated to the vertices in the frame, and M is an index allocated to vertices in a corresponding connectivity patch. In the present disclosure, the encoding and decoding of the connectivity information are performed based on the reconstructed vertices, and the index of the reconstructed vertices is used interchangeably with a reconstructed vertex index or a vertex index. For simplicity, the index N of the vertices in the frame will be referred to as a global vertex index.

For example, referring to FIG. 29, the vertex index M in connectivity patch 0 has a value from 0 to 6, and the vertex index M in connectivity patch 1 has a value from 0 to 5. According to embodiments, the reconstructed vertex index M in the corresponding connectivity patch may be specified according to an access order in the connectivity patch.

When the connectivity information encoder 53003 completes encoding of the connectivity information on the per connectivity patch basis, the encoded connectivity information is output to the vertex index mapping information generator 53004.

The vertex index mapping information generator 53004 may generate a vertex index mapping list (e.g., vertex_idx_mapping_list [i]) that maps a vertex index M in a connectivity patch to a vertex index) of a corresponding frame, and output the same in the form of a connectivity information bitstream. Here, the vertex index M in the connectivity patch may be specified according to an access order of the vertices during encoding and decoding. The connectivity information bitstream may contain connectivity information encoded by the connectivity information encoder 53003 and the vertex index mapping list generated by the vertex index mapping information generator 53004. Here, the vertex index mapping list may be contained in the connectivity patch header.

According to embodiments, the vertex index mapping list may be configured and transmitted on a per connectivity patch basis.

According to embodiments, when generating the vertex index mapping list, the vertex index N in a frame mapped (or matched) to the vertex index M in the corresponding connectivity patch may be a frame-based index value or a connectivity patch-based index value. That is, in each vertex index mapping list, the vertex index N in the frame may be transmitted as a frame-based index or may be converted into a connectivity patch-based index and then transmitted.

In the present disclosure, a vertex index N in a transmitted frame is referred to as a global vertex index when it is a frame-based index, and is referred to as a local vertex index when it is a connectivity patch-based index.

That is, in the vertex index mapping list, the vertex index N in a frame mapped to the vertex index M in the corresponding connectivity patch may be an original vertex index, and may be a value obtained by converting the original vertex index using an offset. According to embodiments, the local vertex index is obtained by converting a vertex index of the frame using an offset.

In other words, the vertex index N in the frame included in each vertex index mapping list may be a frame-based value or a connectivity patch-based value.

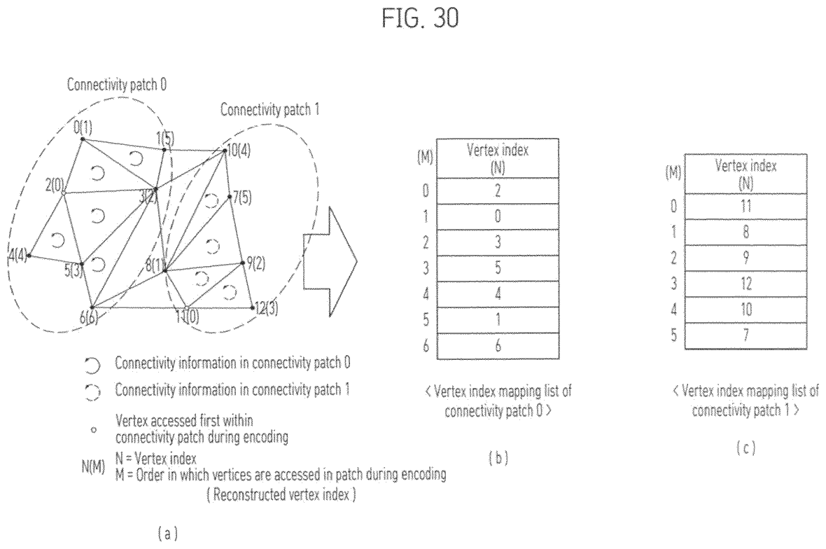

FIGS. 30-(a) to 30-(c) illustrate an exemplary case where a vertex index N in a frame included in each vertex index mapping list according to embodiments is a frame-based value. That is, in the illustrated example, the vertex index N in the frame is transmitted as a global vertex index without being changed.

According to embodiments, in each vertex index mapping list, the values of M (i.e., vertex indices in a corresponding connectivity patch) may be sorted in ascending order, and each of the values may be assigned a vertex index in a corresponding (or mapped) frame.

FIG. 30-(b) illustrates an exemplary vertex index mapping list corresponding to connectivity patch 0. For example, in the case of vertex index 0 in connectivity patch 0, vertex index 2 in the frame is listed (or stored) in the vertex index mapping list (i.e., 0(2)). In the case of vertex index 6 in connectivity patch 0, vertex index 6 in the frame is listed (or stored) in the vertex index mapping list (i.e., 6(6)).

FIG. 30-(c) illustrates an exemplary vertex index mapping list corresponding to connectivity patch 1. For example, in the case of vertex index 0 in connectivity patch 1, vertex index 11 in the frame is listed (or stored) in the vertex index mapping list (i.e., 0 (11)). In the case of vertex index 5 in connectivity patch 1, vertex index 7 in the frame is listed (or stored) in the vertex index mapping list (i.e., 5(7)).

As described above, the frame-based index (i.e., the global vertex index) may be a non-redundant index assigned to all vertexes in the frame.

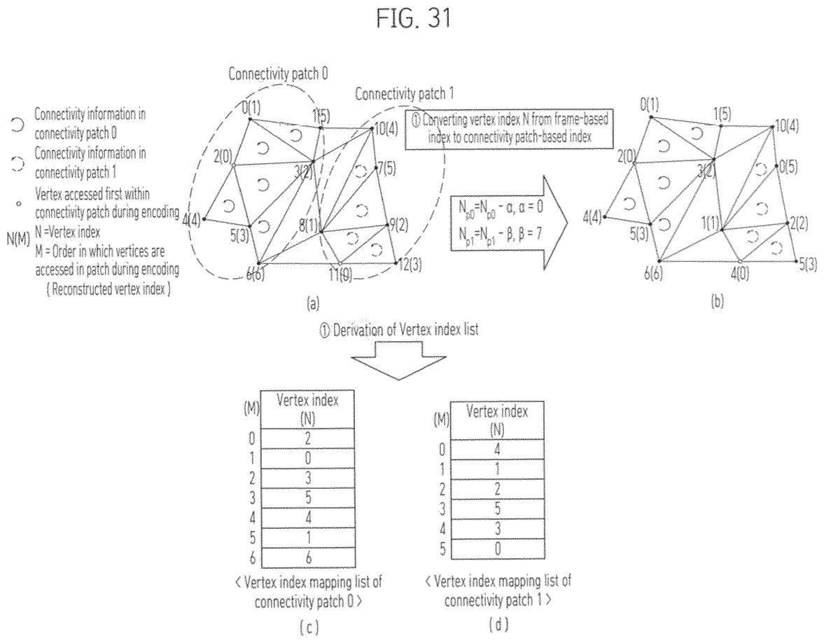

FIGS. 31-(a) to 31-(d) illustrate an exemplary case where a vertex index N in a frame included in each vertex index mapping list according to embodiments is a connectivity patch-based value. That is, the vertex index N in the frame is converted into a local vertex index and transmitted.

According to embodiments, in each vertex index mapping list, the values of M (i.e., vertex indices in a corresponding connectivity patch) may be sorted in ascending order, and each of the values may be assigned a vertex index in a corresponding (or mapped) frame converted on a per connectivity patch basis.

As shown in FIG. 31-(b), the vertex index N in the frame is converted from the frame-based index to the connectivity patch-based index using an offset. That is, a global vertex index may be converted into a local vertex index by subtracting the offset for the corresponding connectivity patch from the vertex index N in the frame.

According to an embodiment of the present disclosure, the offset for each connectivity patch may be determined as the least value among the values of N in the connectivity patch.

For example, since 0 is the least value among the values of N (i.e., 0-6) included in the first connectivity patch (i.e., connectivity patch 0), the offset (e.g., alpha) for the first connectivity patch (i.e., connectivity patch 0) is 0. Therefore, as shown in FIG. 31-(c), the vertex index N in the frame of the first connectivity patch, that is, connectivity patch 0, does not change in the vertex index mapping list.

Also, since 7 is the least value among the values of N (i.e., 7-12) included in the second connectivity patch (i.e., connectivity patch 1), the offset (e.g., beta) for the second connectivity patch (i.e., connectivity patch 1) becomes 7. Therefore, as shown in FIG. 31-(d), the vertex index N in the frame of connectivity patch 1 is changed from the range of 7 to 11 to the range of 0 to 5 in the vertex index mapping list (i.e., from 11 to 4, from 8 to 1, from 9 to 2, from 12 to 5, from 10 to 3, and from 7 to 0). That is, in the case of connectivity patch 1, the vertex index N in the frame is converted from a global vertex index (i.e., a frame-based index) to a local vertex index (i.e., a connectivity patch-based index). The conversion may be performed in the following manner. The least value among the index values in a frame of the corresponding connectivity patch may be determined as an offset, and the value obtained by subtracting the offset from each index value may be used as a local vertex index.

As shown in FIGS. 31-(a) to 31-(d), when a vertex index in a frame is converted into a local vertex index (i.e., a connectivity patch-based index) in each vertex index mapping list and transmitted, the size of a connectivity information bitstream constituting the vertex index mapping list may be reduced compared to the global vertex index (i.e., the frame-based index), thereby increasing compression efficiency.

According to the embodiments, an occupancy map bitstream, a geometry information bitstream, an attribute information bitstream, which are output from the V-PCC encoder 51000, and a connectivity information bitstream output from the connectivity information processor 53000, may be transmitted, respectively or may be multiplexed into one bitstream to be transmitted. In the present disclosure, the one bitstream configured by multiplexing may be referred to as a V-PCC bitstream. The structure of the V-PCC bitstream will be described in detail below. In the present disclosure, the V-PCC bitstream may be referred to as a mesh bitstream or a V3C bitstream.

By using vertex connectivity information as described above, data may be transmitted in the form of a texture per mesh rather than a texture per point. Accordingly, data may be received in the form of a texture per mesh at the receiving side.

According to embodiments, the V-PCC bitstream may be transmitted from the transmitting side to the receiving side as it is, or may be encapsulated in the form of a file/segment and transmitted to the reception device by the transmitter of FIG. 1 or 18, or may be stored in a digital storage medium (e.g., USB, SD, CD, DVD, Blu-ray, HDD, SSD, etc.).

According to an embodiment, the file may be in an ISOBMFF file format. According to embodiments, the V-PCC bitstream may be transmitted to the receiving side through multiple tracks in the file or may be transmitted to the receiving side through a single track.

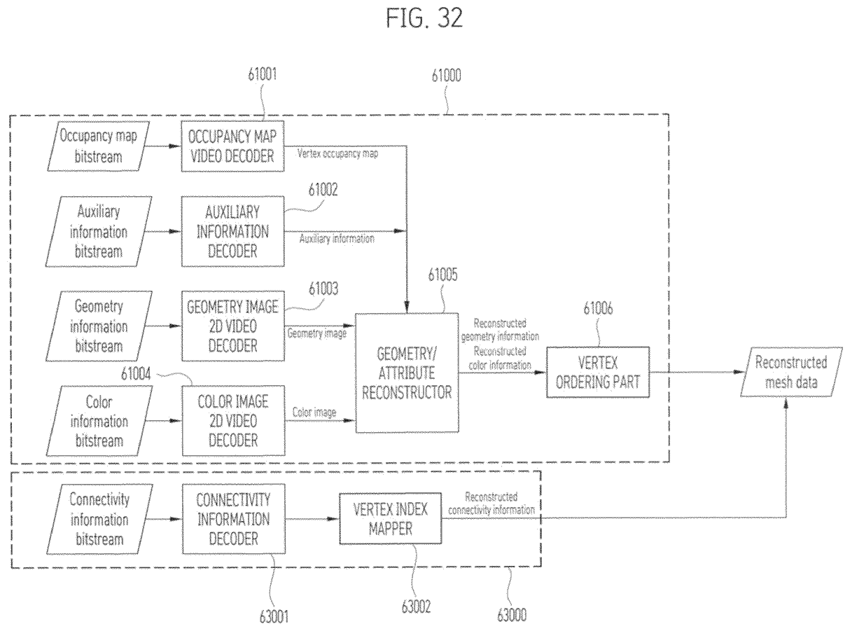

FIG. 32 is a diagram illustrating another exemplary video decoder according to embodiments. That is, FIG. 32 illustrates an exemplary video decoder configured to reconstruct mesh data. In the example, a connectivity information processor 63000 is separately provided to a V-PCC decoder 61000.

The video decoder of FIG. 32 performs a reverse operation to the video encoder of FIG. 23 to decode the bitstream information encoded on a per connectivity patch basis. That is, the vertex index in the reconstructed connectivity information may be mapped to the index of the corresponding vertex data, and the order of the reconstructed vertex data may be changed with reference to the vertex index of the reconstructed connectivity information. Each operation is performed according to the principles described in detail below.

According to embodiments, the V-PCC decoder 61000 may include an occupancy map 2D video decoder 61001, an auxiliary information decoder 61002, a geometry image 2D video decoder 61003, an attribute image 2D video decoder 61004, a geometry/attribute reconstructor 61005, and a vertex ordering part 61006. The V-PCC decoder 61000 may perform some or all of the operations of the point cloud video decoder of FIG. 16, or some or all of the operations of the V-PCC decoder 40020 of FIG. 22. The

According to embodiments, the connectivity information processor 63000 may include a connectivity information decoder 63001 and a vertex index mapper 63002.

Each component of FIG. 32 may correspond to software, hardware, a processor, and/or a combination thereof.

If the occupancy map bitstream, the geometry information bitstream, the attribute information bitstream, and the connectivity information bitstream are multiplexed into one V-PCC bitstream and received, the demultiplexer (not shown) de-multiplexes the V-PCC bitstream and outputs an auxiliary information bitstream containing compressed patch information, an attribute information bitstream containing a compressed attribute image, a geometry bitstream containing a compressed geometry image, an occupancy map bitstream containing compressed occupancy map information, and a connectivity information bitstream containing compressed connectivity information, respectively.

The occupancy map 2D video decoder 61001 of the V-PCC decoder 61000 decompresses the compressed occupancy map information contained in the occupancy map bitstream and outputs a vertex occupancy map to the geometry/attribute information reconstructor 61005. That is, the occupancy map 2D video decoder 61001 may receive the occupancy map 2D video bitstream and perform operations such as entropy decoding, inverse quantization, inverse transform, and predicted signal to reconstruct the vertex occupancy map.

The auxiliary information decoder 61002 of the V-PCC decoder 61000 decompresses the compressed auxiliary information (i.e., patch information) contained in the auxiliary information bitstream and outputs the auxiliary information (i.e., patch information) to the geometry/attribute reconstructor 61005. That is, the auxiliary information decoder 61002 may decode an M×N patch index map in a W×H image space and/or a 3D reconstructed position (x0, y0, z0) based on the determined projection plane index per patch and/or the 2D bounding box position (u0, v0, u1, v1) of the patch, and/or the bounding box of the patch.

The geometry image 2D video decoder 61003 of the V-PCC decoder 61000 decompresses the compressed geometry information contained in the geometry information bitstream and outputs a geometry image to the geometry/attribute reconstructor 61005. That is, the geometry image 2D video decoder 61003 may receive the geometry image 2D video bitstream and perform operations such as entropy decoding, inverse quantization, inverse transform, and predicted signal prediction to reconstruct the geometry image.

The attribute image 2D video decoder 61004 of the V-PCC decoder 61000 decompresses the compressed attribute information contained in the attribute information bitstream and outputs an attribute image to the geometry/attribute reconstructor 61005. That is, the attribute image 2D video decoder 61004 may receive the geometry image 2D video bitstream and perform operations such as entropy decoding, inverse quantization, inverse transform, and predicted signal prediction to reconstruct the geometry image.

According to embodiments, a converter may be further included in front of the geometry/attribute reconstructor 61005. The converter performs chroma format conversion, resolution conversion, frame rate conversion, and the like on the basis of the decompressed geometry image, the decompressed attribute image, and the decompressor map information.

The geometry/attribute reconstructor 61005 reconstructs the geometry information and attribute information based on the decompressed vertex occupancy map, the decompressed auxiliary information, the decompressed geometry image, and the decompressed attribute image, and outputs the reconstructed geometry information and attribute information to the vertex ordering part 61006.

According to embodiments, the geometry/attribute reconstructor 61005 restorers (reconstructs) geometry information based on the decompressed patch information and the output of the converter. Attribute information is restored (reconstructed) based on the output of the converter and the reconstructed geometry information. That is, the geometry/attribute reconstructor 61005 may reconstruct 3D vertex-based geometry information and attribute (e.g., color) information based on the reconstructed auxiliary information, the reconstructed geometry image, and the reconstructed attribute (e.g., color) image.

The vertex ordering part 61006 arranges the geometry information reconstructed by the geometry/attribute reconstructor 61005 in a connectivity patch in the reverse order to the order at the transmitting side. The arrangement of the reconstructed geometry information will be described in detail later.

The connectivity information decoder 63001 of the connectivity information processor 63000 decodes the compressed connectivity information contained in the connectivity information bitstream on a per connectivity patch basis and outputs the decoded connectivity information to the vertex index mapping unit 63001. In other words, the connectivity information decoder 63001 may receive the connectivity information bitstream per connectivity patch, decode the connectivity information per connectivity patch, or may receive the connectivity information bitstream per frame and decode the connectivity information per frame. According to an embodiment, the connectivity information may be decoded per connectivity patch.

For a connectivity patch containing the connectivity information decoded by the connectivity information decoder 63001, the vertex index mapper 63002 maps a vertex index in the connectivity patch to a vertex index in a frame based on a vertex index mapping list.

According to an embodiment, the vertex index mapping list may be parsed from connectivity patch-related information (e.g., a connectivity patch header). The parsing of the vertex index mapping list may be performed by the vertex index mapper 63002 or by a separate signaling processing block.

According to embodiments, the mapping operation may vary according to whether the vertex index in the frame listed in the vertex index mapping list is a global vertex index (e.g., FIGS. 30-(a) to 30-(c)) or a local vertex index (e.g., FIGS. 31-(a) to 31-(d)).

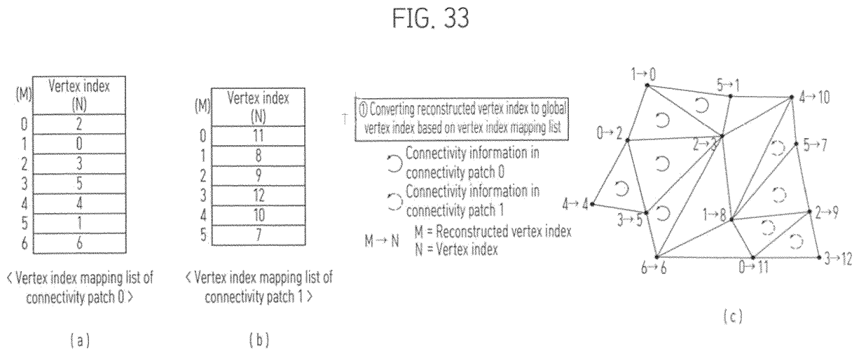

FIGS. 33-(a) to 33-(c) illustrate an exemplary process for mapping vertex indices for frames according to embodiments. FIGS. 33-(a) to 33-(c) illustrate an exemplar case where a vertex index in a frame listed in the vertex index mapping list is a global vertex index (i.e., a frame-based index) as shown in FIGS. 30-(a) to 30-(c).

According to embodiments, when the type (mapping_list_idx_type) of the vertex index mapping list (vertex_idx_mapping_list) parsed from the connectivity patch header is a frame-based index (i.e., a global vertex index), a vertex index mapping process may be performed as shown in FIGS. 33-(a) to 33-(c).

FIG. 33-(a) illustrates an exemplary vertex index mapping list in connectivity patch 0, and FIG. 33-(b) illustrates an exemplary vertex index mapping list in connectivity patch 1 .

In this case, as shown in FIG. 33-(c), the vertex index in a corresponding connectivity patch is converted into a vertex index (i.e., a global vertex index) in a frame based on each vertex index mapping list.

That is, for the total number of connectivities obtained by parsing the number of connectivities in the corresponding connectivity patch (num_connectivity), the vertex index M in the corresponding connectivity patch may be changed to the value of the vertex index in the frame in the vertex index mapping list. That is, the vertex index in the corresponding connectivity patch is converted into a global vertex index with reference to the vertex index mapping list.

For example, vertex index 0 in connectivity patch 0 is converted to vertex index 2 in the frame in the vertex index mapping list of FIG. 33-(a). As another example, vertex index 4 in connectivity patch 1 is converted to vertex index 10 in the frame in vertex index mapping list of FIG. 33-(b).

FIG. 33-(c) illustrates an example of connectivity information in which, when the vertex indices of frames are received on a frame-by-frame basis, the vertex index M in connectivity patch 0 and the vertex index M in connectivity patch 1 are converted to a global vertex index N with reference to the vertex index mapping list in FIG. 33-(a) and the vertex index mapping list in FIG. 33-(b). That is, in connectivity patch 0, the vertex index is changed from 0 to 2, from 1 to 0, from 2 to 3, from 3 to 5, from 4 to 4, from 5 to 1, and 6 to 6. In connectivity patch 1, the vertex index is changed from 0 to 11, from 1 to 8, from 2 to 9, from 3 to 12, from 4 to 10, and from 5 to 7.

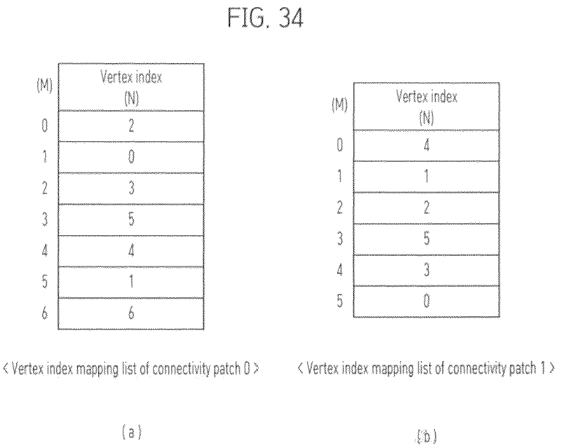

FIG. 34-(a) shows an exemplary vertex index mapping list of connectivity patch 0 according to embodiments, and FIG. 34-(b) shows an exemplary vertex index mapping list of connectivity patch 1, wherein vertex indices in a frame are listed on a basis of a connectivity information matching unit.

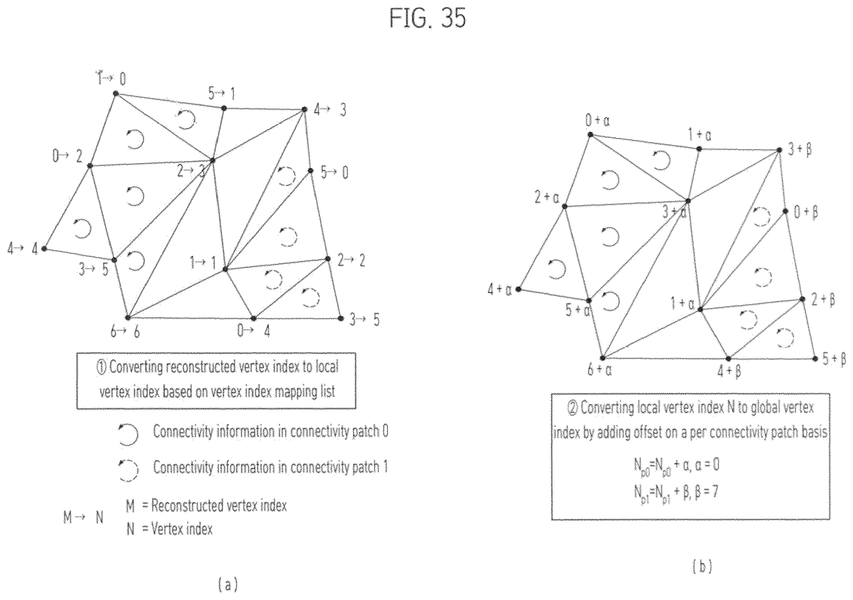

FIGS. 35-(a) and 35-(b) illustrate another exemplary process for mapping vertex indices for a frame according to embodiments. FIGS. 34-(a), 34-(c), 35-(a), and 35-(b) illustrate an exemplary case where a vertex index in a frame listed in a vertex index mapping list is a local vertex index (i.e., a connectivity patch unit) as shown in FIGS. 31-(a) to 31-(d).

That is, when the type (mapping_list_idx_type) of the vertex index mapping list (vertex_idx_mapping_list) parsed from the connectivity patch header is a connectivity patch-based index (i.e., a local vertex index), a vertex index mapping process may be performed as shown in FIGS. 35-(a) and 35-(b) based on the vertex index mapping list of FIGS. 34-(a) and 34-(b).

According to embodiments, for the total number of connectivities obtained by parsing the number of connectivities in a connectivity patch (num_connectivity), the vertex index M in the corresponding connectivity patch may be changed to the value of the vertex index in the frame in the vertex index mapping list. In the process, the index is converted to a local vertex index in the patch. That is, the vertex index in the corresponding connectivity patch is converted into a local vertex index with reference to the vertex index mapping list.

For example, vertex index 0 in connectivity patch 0 is converted to vertex index 2 in the frame in the vertex index mapping list of FIG. 34-(a). As another example, vertex index 4 in connectivity patch 1 is converted to vertex index 3 in the frame in the vertex index mapping list of FIG. 34-(b).

FIG. 35-(a) illustrates an example of connectivity information in which, when the vertex indices of frames are received on a per connectivity patch basis, the vertex index M in connectivity patch 0 and the vertex index M in connectivity patch 1 are converted to a local vertex index N with reference to the vertex index mapping list in FIG. 34-(a) and the vertex index mapping list in FIG. 34-(b). That is, in connectivity patch 0, the vertex index is changed from 0 to 2, from 1 to 0, from 2 to 3, from 3 to 5, from 4 to 4, from 5 to 1, and 6 to 6. In connectivity patch 1, the vertex index is changed from 0 to 4, from 1 to 1, from 2 to 2, from 3 to 5, from 4 to 3, and from 5 to 0

Then, as shown in FIG. 35-(b), an offset may be derived on a connectivity patch basis. The local vertex index N in the corresponding connectivity patch may be converted into a global vertex index by adding the offset thereto. That is, the offset is added to the local vertex index N on a per connectivity patch basis to convert the local vertex index N into a global vertex index.

The offset may be a least index among the indices of vertices in a connectivity patch identified by connectivity_patch_idx among the connectivity patches. In this case, in connectivity patch 0, the offset (i.e., alpha) is 0, and therefore there is no change in the vertex index. In connectivity patch 1, the offset (i.e., beta) is 7, and therefore the vertex index is changed from 4 to 11, from 1 to 8, from 2 to 9, from 5 to 12, from 3 to 10, and from 0 to 7.

According to embodiments, the vertex ordering part 61006 may change the order of the vertex data (x, y, z, r, g, b, . . . ) reconstructed by the geometry/attribute reconstructor 61005 in the connectivity patch with reference to vertex_idx_mapping_list.

In the video decoder of FIG. 32, only one of the vertex index mapper 63002 and the vertex ordering part 61006 may be selectively excluded. According to an embodiment, the vertex index mapper 63002 may be executed, and the mesh data may be reconstructed based on the execution result. The vertex ordering method according to embodiments may be carried out as follows.

The reconstructed vertex data (x, y, z, r, g, b, . . . ) in a frame may be stored in ascending order of patch indices on a per connectivity patch. The vertex ordering part 61006 may change the storage order (of the indices) of the reconstructed vertex data in the connectivity patch. That is, when the m-th value n in the vertex index mapping list (vertex_idx_mapping_list) is the same as the reconstructed vertex data index, the reconstructed vertex data may be changed to the m-th position in storage order in the current patch.

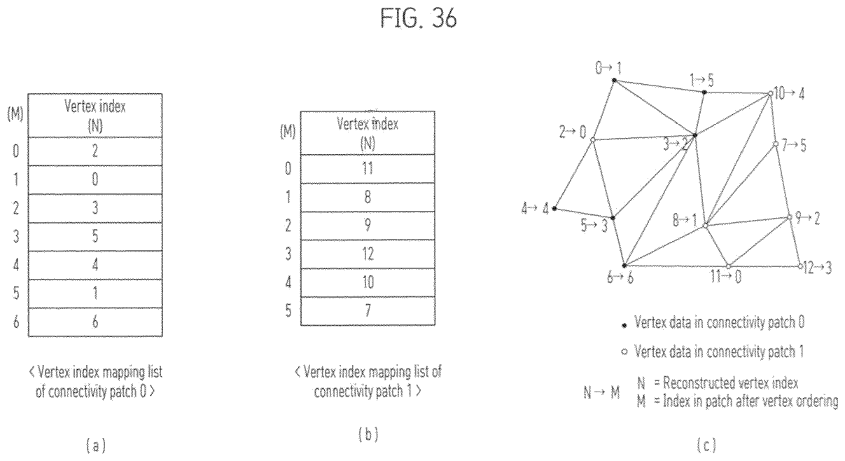

FIGS. 36-(a) to 36-(c) illustrate an example of a vertex ordering process when the vertex index in a frame is received in a vertex index mapping list on a frame-by-frame basis according to embodiments. That is, FIGS. 36-(a) to 36-(c) illustrate an example in which changing the storage order of vertex data is represented as a change of the vertex data index.

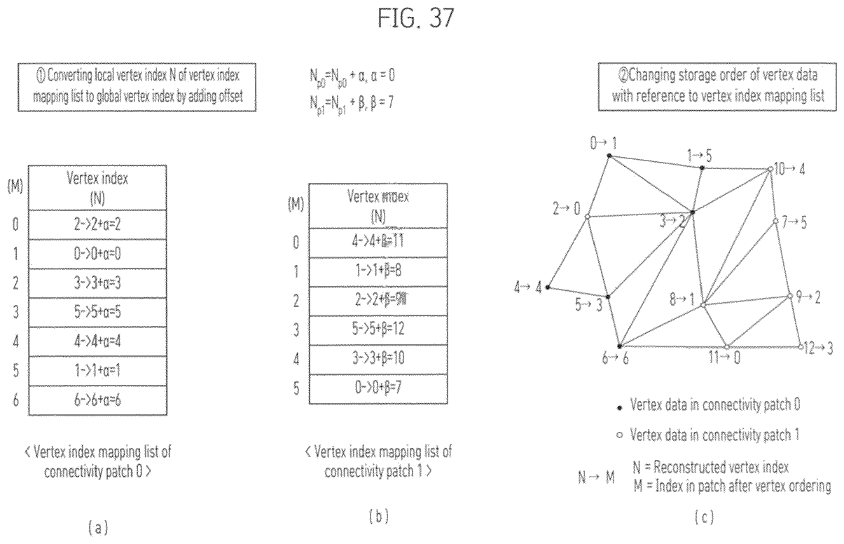

FIGS. 37-(a) to 37-(c) illustrate an example of a vertex ordering process when vertex indices in a frame are received in a vertex index mapping list on a per connectivity patch basis according to embodiments. That is, as shown in FIGS. 37-(a) to 37-(c), a vertex index in the vertex index mapping list may be converted into a global vertex index by adding an offset (e.g., alpha, beta, etc.) derived on a per connectivity patch basis thereto. Thereafter, the storage order of the vertex data may be changed in the same manner as when the frame-based index is received in the vertex index mapping list.

According to embodiments, mesh data may be restored (reconstructed) by multiplexing the reconstructed vertex data (x, y, z, r, g, b, . . . ), reconstructed connectivity information, the output of the vertex ordering part 61006, and/or the output of the vertex index mapper 63002.

That is, the reconstructed mesh data is a structure in which the reconstructed vertex connectivity information is contained in the point cloud data. In the present disclosure, the mesh data having vertex connectivity information is contained in point cloud data is used interchangeably with point cloud data.

The reconstructed mesh data is displayed in the form of mesh information to a user through a rendering process.

Next, the V-PCC bitstream will be discussed. In the present disclosure, a V-PCC bitstream may be referred to as a mesh bitstream or a V3C bitstream.

According to embodiments, the V-PCC bitstream has a structure in which an occupancy map bitstream, a geometry information bitstream, an attribute information bitstream, and a connectivity information bitstream are multiplexed. According to an embodiment, the connectivity information bitstream may contain encoded connectivity information. The connectivity information bitstream may further contain connectivity patch-related information.

According to embodiments, the V-PCC bitstream may be transmitted from the transmitting side to the receiving side as it is, or may be encapsulated in the form of a file/segment and transmitted to the reception device by the transmitter of FIG. 1 or 18, or may be stored in a digital storage medium (e.g., USB, SD, CD, DVD, Blu-ray, HDD, SSD, etc.).

According to an embodiment, the file may be in an ISOBMFF file format.

According to embodiments, the V-PCC bitstream may be transmitted to the receiving side through multiple tracks in the file or may be transmitted to the receiving side through a single track.

In this case, some point cloud data corresponding to a specific 3D space region from among point cloud data (i.e., mesh data) containing connectivity information may be related to one or more 2D regions. According to embodiments, the 2D region refers to one or more video frames or atlas frames including data related to the point cloud data in the corresponding 3D region.

According to embodiments, atlas data is signaling information including an atlas sequence parameter set (ASPS), an atlas frame parameter set (AFPS), an atlas adaptation parameter set (AAPS), atlas tile information, and an SEI message, and may be referred to as metadata about an atlas. According to embodiments, the ASPS is a syntax structure that includes syntax elements applied to zero or one or more fully coded atlas sequences (CASs) determined by the content of the syntax elements in the ASPS that are referenced by the syntax elements in each tile header. According to embodiments, the AFPS is a syntax structure that includes syntax elements applied to zero or one or more fully coded atlas frames determined by the content of the syntax elements in each tile. According to embodiments, the AAPS may include camera parameters related to a portion of the atlas sub-bitstream, such as camera position, rotation, scale, and camera model. In one embodiment, a syntax element and a field or parameter are used interchangeably.

In some embodiments, an atlas represents a set of 2D bounding boxes, which may be patches projected onto a rectangular frame.

According to embodiments, an atlas frame is a 2D rectangular array of atlas samples onto which patches are projected. An atlas sample is a position of a rectangular frame in which patches related to an atlas are projected.

According to embodiments, an atlas frame may be partitioned into one or more rectangular tiles. That is, a tile is a unit into which a 2D frame is partitioned. In other words, the tile is a unit for partitioning signaling information about point cloud data called atlas. According to embodiments, tiles do not overlap in an atlas frame, and one atlas frame may include regions not related to a tile. The height and width of each tile in one atlas may vary from tile to tile. A tile may be referred to as an atlas tile, and tile data may correspond to tile group data. The term tile may be referred to as a term tile group.

The V-PCC bitstream according to embodiments may contain a coded point cloud (or mesh) sequence (CPCS) and may be composed of sample stream V-PCC units. The sample stream V-PCC units carry V-PCC parameter set (VPS) data, an atlas bitstream, a 2D video encoded occupancy map bitstream, and a 2D video encoded occupancy map bitstream, a 2D video encoded geometry information bitstream, zero or more 2D video encoded attribute information bitstreams, and/or a connectivity information bitstream.

According to embodiments, the V-PCC bitstream may contain one sample stream V-PCC header and one or more sample stream V-PCC units. For simplicity, the one or more sample stream V-PCC units may be referred to as a sample stream V-PCC payload. That is, the sample stream V-PCC payload may be referred to as a set of sample stream V-PCC units.

Each sample stream V-PCC unit may include V-PCC unit size information and a V-PCC unit. The V-PCC unit size information indicates the size of the V-PCC unit. For simplicity, the V-PCC unit size information may be referred to as a sample stream V-PCC unit header, and the V-PCC unit may be referred to as a sample stream V-PCC unit payload.

Each V-PCC unit may include a V-PCC unit header and a V-PCC unit payload.

In the present disclosure, data contained in the V-PCC unit payload is distinguished by the V-PCC unit header. To this end, the V-V-PCC unit header contains type information indicating the type of the V-PCC unit. Each V-PCC unit payload contains geometry video data (i.e., a 2D video encoded geometry information bitstream), attribute video data (i.e., a 2D video encoded attribute information bitstream), occupancy video data (i.e., an occupancy map bitstream), atlas data, a V-PCC parameter set (VPS), and connectivity data (i.e., a connectivity information bitstream).

The VPS according to the embodiments may be referred to as a sequence parameter set (SPS). Both terms may be used interchangeably.

The atlas data according to the embodiments may mean data composed of attributes (e.g., textures (patches)) and/or depths of point cloud (or mesh) data, and may be referred to as an atlas sub-bitstream (or atlas substream).

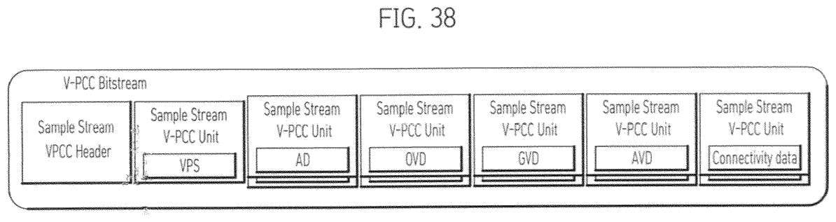

FIG. 38 illustrates an example of data carried by sample stream V-PCC units in a V-PCC bitstream according to embodiments.

The V-PCC bitstream of FIG. 38 may include, for example, a sample stream V-PCC unit that carries a VPS, sample stream V-PCC units that carry atlas data (AD), sample stream V-PCC units that carry occupancy video data (OVD), sample stream V-PCC units that carry geometry video data (GVD), sample stream V-PCC units that carry attribute video data (AVD), sample stream V-PCC units that carry connectivity data.

According to embodiments, each sample stream V-PCC unit includes a V-PCC unit of any one type among VPS, AD, OVD, GVD, AVD, and connectivity data.

The term field used in the syntaxes of the present disclosure described below may have the same meaning as a parameter or element (or syntax element).

The sample stream V-PCC header ( ) according to embodiments may include a field ssvh_unit_size_precision_bytes_minus1 and a field ssvh_reserved_zero_5bits.

The value of field ssvh_unit_size_precision_bytes_minus1 plus 1 may indicate the accuracy, in bytes, of the element ssvu_vpcc_unit_size in all sample stream V-PCC units. The value of this field may be in the range of 0 to 7.

The field ssvh_reserved_zero_5bits is a reserved field for future use.

The sample stream V-PCC unit (sample_stream_vpcc_unit ( ) according to embodiments may include a field ssvu_vpcc_unit_size and vpcc_unit (ssvu_vpcc_unit_size) . . .

The field ssvu_vpcc_unit_size corresponds to the aforementioned V-PCC unit size information and specifies the size of the subsequent V-PCC unit in bytes. The number of bits used to represent the ssvu_vpcc_unit_size field is equal to (ssvh_unit_size_precision_bytes_minus1+1)*8.

vpcc_unit (ssvu_vpcc_unit_size) has a length corresponding to the value of the field ssvu_vpcc_unit_size and carries one of the followings: V-PCC parameter set (VPS), atlas data (AD), occupancy video data (OVD), geometry video data (GVD), attribute video data (AVD), and connectivity data.

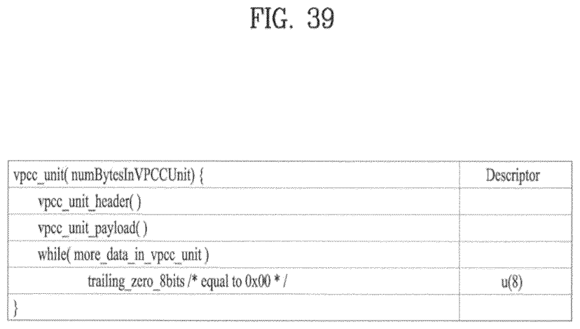

FIG. 39 shows an exemplary syntax structure of V-PCC units according to embodiments. A V-PCC unit includes a V-PCC unit header (vpcc_unit_header ( ) and a V-PCC unit payload (vpcc_unit_payload ( ). According to embodiments, the V-PCC unit may include more data. In this case, it may further include a field trailing_zero_8bits. The field trailing_zero_8bits according to embodiments is a byte corresponding to 0×00.

As described above, the V-PCC unit payload may contain one of a V-PCC parameter set (vpcc_parameter_set ( ), an atlas sub-bitstream (atlas_sub_bitstream ( ), a video sub-bitstream (video_sub_bitstream ( ), and a connectivity information sub-bitstream, depending on the value of the vuh_unit_type in the V-PCC unit header.

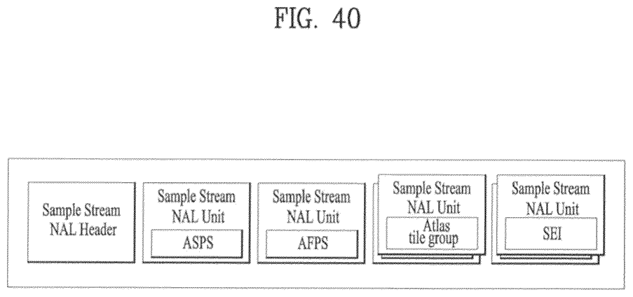

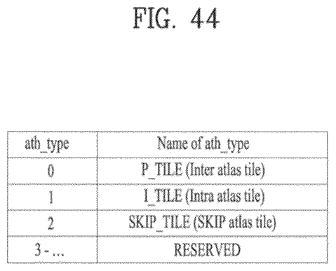

FIG. 40 shows an exemplary structure of the atlas substream (or atlas sub-bitstream) described above. In an embodiment, the atlas substream of FIG. 44 conforms to the format of the HEVC NAL unit.

An atlas substream according to embodiments may include a sample stream NAL unit containing an atlas sequence parameter set (ASPS), a sample stream NAL unit containing an atlas frame parameter set (AFPS), one or more sample stream NAL units containing information about one or more atlas tile groups (or tiles), and/or one or more sample stream NAL units containing one or more SEI messages.

The one or more SEI messages according to the embodiments may include a prefix SEI message and a suffix SEI message.

According to embodiments, the atlas substream may further include a sample stream NAL header in front of the one or more sample stream NAL units.

The sample stream NAL unit (sample_stream_nal_unit ( ) according to embodiments may include a field ssnu_nal_unit_size and nal_unit (ssnu_nal_unit_size).

The field ssnu_nal_unit_size specifies the size of the subsequent NAL unit in bytes.

The nal_unit (ssnu_nal_unit_size) has a length corresponding to the value of the field ssnu_nal_unit_size and carries one of an atlas sequence parameter set (ASPS), an atlas adaptation parameter set (AAPS), an atlas frame parameter set (AFPS), atlas tile group (or tile) information, and an SEI message. According to embodiments, the ASPS, the AAPS, the AFPS, the atlas tile group (or tile) information, and the SEI message are referred to as atlas data (or metadata about the atlas).

SEI messages according to the embodiments may assist in processes related to decoding, reconstruction, display, or other purposes.

According to embodiments, the NAL unit may include a NAL unit header. The NAL unit header may include a field nal_unit_type.

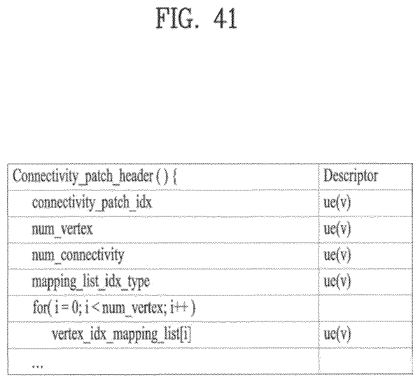

FIG. 41 shows an exemplary syntax structure of a connectivity patch header (connectivity_patch_header ( ) according to embodiments. The connectivity_patch_header may be transmitted/received on a per connectivity patch basis. The connectivity patch header may be included in the connectivity information bitstream. As an example, the connectivity information bitstream may include a connectivity patch header and a connectivity patch payload. According to embodiments, the connectivity patch payload may contain encoded connectivity information. In the present disclosure, information contained in the connectivity patch header is referred to as connectivity patch-related information.

According to embodiments, the connectivity patch header ((connectivity_patch_header ( ) may include a field connectivity_patch_idx, a field num_vertex, a field num_connectivity, a field mapping_list_idx_type, and a field vertex_idx_mapping_list [i] repeated as many times as the value of the field num_vertex.

The field connectivity patch_idx indicates an index of a connectivity patch for identifying a current connectivity patch.

The field num_vertex indicates the number of vertices in the current connectivity patch (or a connectivity patch identified by the value of connectivity_patch_idx).

The field num_connectivity indicates the number of pieces of connectivity information in the current connectivity patch (or a connectivity patch identified by the value of connectivity_patch_idx).

The field mapping_list_idx_type indicates a type of an index transmitted in a vertex index mapping list corresponding to the current connectivity patch (or a connectivity patch identified by the value of connectivity_patch_idx). For example, mapping_list_idx_type equal to 0 may indicate the connectivity patch-based index, and mapping_list_idx_type field equal to 1 may indicate the frame-based index.

The vertex_idx_mapping_list [i] is a vertex index mapping list. The vertex_idx_mapping_list [i] is a vertex index list of a frame corresponding to a vertex index M in the current connectivity patch (or a connectivity patch identified by the value of connectivity_patch_idx). The vertex index N in the frame listed in the vertex index mapping list depends on the value of mapping_list_idx_type.

A vertex index in a frame mapped to an index of an i-th vertex in the corresponding connectivity patch may be identified based on the vertex_idx_mapping_list [i].

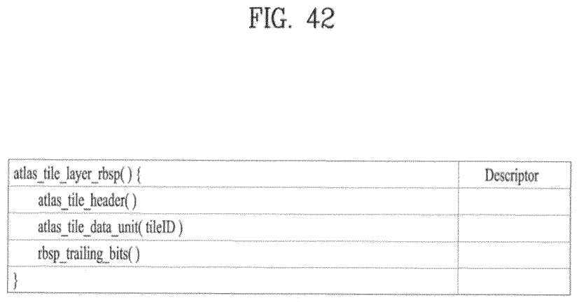

FIG. 42 shows a syntax structure of an atlas tile layer (atlas_tile_layer_rbsp ( ) according to embodiments.

FIG. 42 shows a syntax of the atlas tile layer ( ) carried by a NAL unit according to nal_unit_type.

According to embodiments, the atlas tile layer may include an atlas tile header (atlas_tile_header ( ) and atlas_tile_data_unit (tileID).

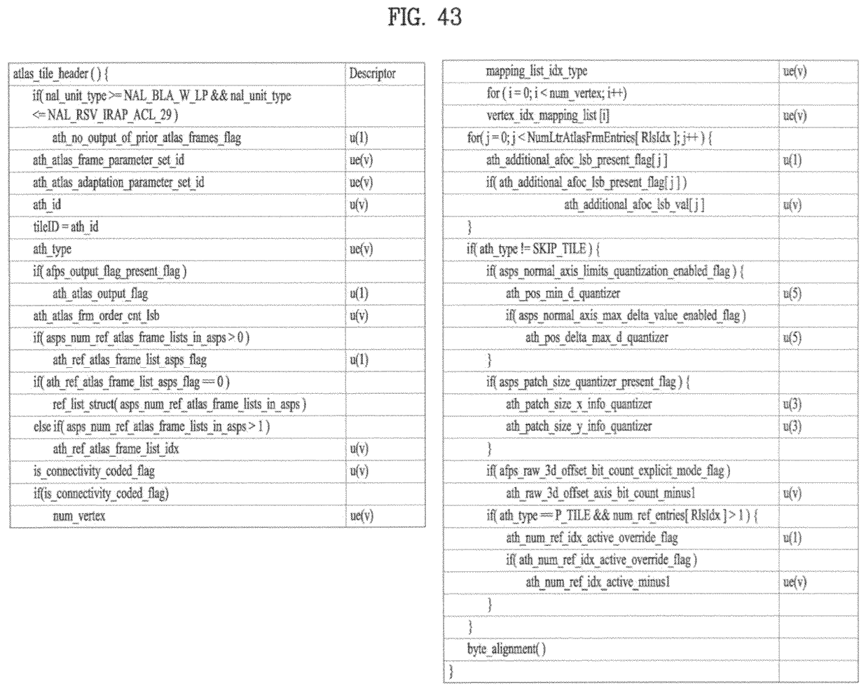

FIG. 43 shows a syntax structure of an atlas tile header (atlas_tile_header ( ) included in an atlas tile layer according to embodiments. According to embodiments, at least some of the connectivity patch-related information may be included in the atlas tile header (atlas_tile_header ( ). According to embodiments, the connectivity patch-related information included in the atlas tile header (atlas_tile_header ( ) may include a field is_connectivity_coded_flag, a field num_vertex, a field mapping_list_idx_type, and a field vertex_idx_mapping_list [i].

In FIG. 43, the field ath_atlas_frame parameter_set_id specifies the value of afps_atlas_frame_parameter_set_id for the active atlas frame parameter set for the current atlas tile group.

The field ath_atlas_adaptation_parameter_set_id specifies the value of aaps_atlas_adaptation_parameter_set_id for the active atlas adaptation parameter set for the current atlas tile group.

The field ath_id specifies a tile ID related to the current tile. When this field is not present, the value of ath_id may be inferred to be 0. That is, ath_id is a tile ID of a tile.

The field ath_type indicates the coding type for the current atlas tile group (or tile).

FIG. 44 shows examples of coding types assigned to the field ath_type according to embodiments.

For example, when the value of ath_type is 0, the coding type of the atlas tile is P_TILE (inter atlas tile).

When the value of ath_type is 1, the coding type of the atlas tile is I_TILE (intra atlas tile).

When the value of ath_type is 2, the coding type of the atlas tile is SKIP_TILE (skip atlas tile).

According to embodiments, when the value of afps_output_flag_present_flag included in the atlas frame tile information (AFTI) is 1, the atlas tile header may further include a field ath_atlas_output_flag.

The value of ath_atlas_output_flag affects the decoded atlas output and removal processes.

The field ath_atlas_frm_order_cnt_lsb specifies the atlas frame order count modulo MaxAtlasFrmOrderCntLsb for the current atlas tile.

According to embodiments, when the value of asps_num_ref_atlas_frame_list_in_asps included in the atlas sequence parameter set (ASPS) is greater than 1, the atlas tile header may further include a field ath_ref_atlas_frame_list_sps_flag. The assps_num_ref_atlas_frame_lists_in_asps indicates the number of syntax structures ref_list_struct (rlsIdx) included in the ASPS.

ath_ref_atlas_frame_list_sps_flag equal to 1 indicates that the reference atlas frame list of the current atlas tile is derived based on one of the syntax structures ref_list_struct (rlsIdx) included in the active ASPS. ath_ref_atlas_frame_list_sps_flag equal to 0 indicates that the reference atlas frame list of the current atlas tile list is derived based on the ref_list_struct (rlsIdx) directly included in the tile header of the current atlas tile.

According to embodiments, when the value of ath_ref_atlas_frame_list_sps_flag is 0, the atlas tile header includes ref_list_struct (asps_num_ref_atlas_frame_lists_in_asps). When the value of ath_ref_atlas_frame_list_sps_flag is greater than 1, the atlas tile header includes a field ath_ref atlas frame_list_idx.

The ath_ref_atlas_frame_list_idx indicates an index of the syntax structure ref_list_struct (rlsIdx) used for derivation of the reference atlas frame list for the current atlas tile. The reference atlas frame list is a list of syntax structures ref_list_struct (rlsIdx) included in the active ASSPS.

According to embodiments, the atlas tile header may include a field is_connectivity_coded_flag.

is_connectivity_coded_flag is a flag indicating whether connectivity information contained in a tile or a patch is transmitted.

According to embodiments, when the value of is_connectivity_coded_flag is 1 (i.e., true), the atlas tile header may include a field num_vertex, a field mapping_list_idx_type, and a field vertex_idx_mapping_list [i] repeated as many times as the value of num_vertex.

num_vertex indicates the number of vertices in the current connectivity patch.

mapping_list_idx_type indicates the type of index transmitted in the vertex index mapping list corresponding to the current connectivity patch. For example, mapping_list_idx_type equal to 0 may indicate a connectivity patch-based index, while mapping_list_idx_type equal to 1 may indicate a frame-based index.

The vertex_idx_mapping_list [i] is a vertex index mapping list. The vertex_idx_mapping_list [i] is a vertex index list of a frame corresponding to the vertex index M in the current connectivity patch. The vertex index N in the frame listed in the vertex index mapping list depends on the value of the mapping_list_idx_type. Based on the vertex_idx_mapping_list [i], the vertex index in the frame mapped to the index of the i-th vertex in the corresponding connectivity patch may be identified.

According to embodiments, the atlas tile header may further include a field ath additional_afoc_lsb_present_flag [j] as many as the value of the field NumLtrAtlasFrmEntries, and when the value of ath_additional_afoc_lsb_present_flag [j] is 1, may further include a field ath_additional_afoc_lsb_val [j].

ath_additional_afoc_lsb_val [j] indicates the value of FullAtlasFrmOrderCntLsbLt [RlsIdx] [j] for the current atlas tile.

According to embodiments, when the ath_type does not indicate SKIP_TILE, the atlas tile header may further include a field ath_pos_min_z_quantizer, a field ath_pos_delta_max_z_quantizer, a field ath_patch_size_x_info_quantizer, a field ath_patch_size_y_info_quantizer, a field ath_raw_3d_pos_axis_bit_count_minus1, and/or ath_num_ref_idx_active_minus1 according to the information contained in the ASPS or AFPS.

According to embodiments, the field ath pos_min_z_quantizer is included when the value of asps_normal_axis_limits_quantization_enabled_flag included in the ASPS is 1. The field ath pos_delta_max_z_quantizer is included when both asps_normal_axis_limits_quantization_enabled_flag and asps_normal_axis_max_delta_value_enabled_flag included in the ASPS are equal to 1.

According to embodiments, the field ath patch_size_x_info_quantizer and the field ath_patch_size_y_info_quantizer are included when the value of asps_patch_size_quantizer_present_flag included in the ASPS is 1. The field ath raw_3d_pos_axis_bit_count_minus1 is included when the value of afps_raw_3d_pos_bit_count_explicit_mode_flag included in the AFPS is 1.

According to embodiments, when the ath_type indicates P_TILE, and num_ref_entries [RlsIdx] is greater than 1, the atlas tile header further includes a field ath_num_ref_idx_active_override_flag. When ath_num_ref_idx_active_override_flag is equal to 1, the field ath_num_ref_idx_active_minus1 is included in the atlas tile header.

The field ath_pos_min_z_quantizer indicates a quantizer applied to the value of pdu_3d_pos_min_z [p] with index p. When the field ath pos_min_z_quantizer is not present, the value may be inferred to be 0.

The field ath_pos_delta_max_z_quantizer indicates a quantizer applied to the value of pdu_3d_pos_delta_max_z [p] of a patch having an index p. When the field ath_pos_delta_max_z_quantizer is not present, the value may be inferred to be 0.

The field ath_patch_size_x_info_quantizer indicates the value of PatchSizeXQuantizer applied to the variables pdu_2d_size_x_minus1 [p], mpdu_2d_delta_size_x [p], ipdu_2d_delta_size_x [p], rpdu_2d_size_x_minus1 [p], and epdu_2d_size_x_minus1 [p] of a patch with index p. When the field ath_patch_size_x_info_quantizer is not present, the value may be inferred to be the value of the field asps_log 2_patch_packing_block_size.

The field ath_patch_size_y_info_quantizer indicates the value of the quantizer PatchSizeYQuantizer applied to the variables pdu_2d_size_y_minus1 [p], mpdu_2d_delta_size_y [p], ipdu_2d_delta_size_y [p], rpdu_2d_size_y_minus 1 [p], and epdu_2d_size_y_minus 1 [p] of a patch with index P. When the field ath patch_size_y_info_quantizer is not present, the value may be inferred to be the value of asps_log 2_patch_packing_block_size.

The value of ath_raw_3d_pos_axis_bit_count_minus1 plus 1 indicates the number of bits in the fixed-length representation of rpdu_3d_pos_x, rpdu_3d_pos_y, and rpdu_3d_pos_z. ath_num_ref_idx_active_override_flag equal to 1 indicates that the field

ath num_ref_idx_active_minus1 is present for the current atlas tile. ath num_ref_idx_active_override_flag equal to 0 indicates that the field ath num_ref_idx_active_minus1 is not present. When the field ath num_ref_idx_active_override_flag is not present, the value may be inferred to be 0.

ath_num_ref_idx_active_minus1 plus 1 may indicate the maximum reference index for a reference atlas frame list that may be used to decode the current atlas tile. ath_num_ref_idx_active_minus1 equal to 0 indicates that the reference index of the reference atlas frame list cannot be used to decode the current atlas tile.

byte_alignment may be used to add a stop bit, 1, to indicate the end of the data, and then fill the remaining bits with 0 for byte alignment.

As described above, the syntax structure of ref_list_struct (rlsIdx) may be included in one or more ASPSs and/or directly in an atlas tile group (or tile) header.

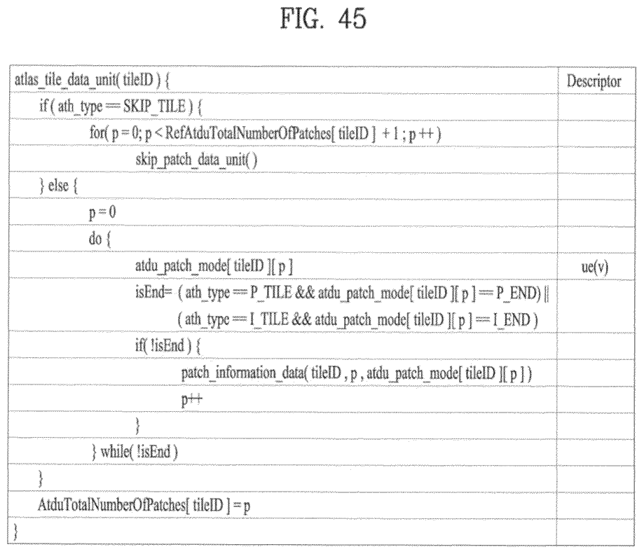

FIG. 45 shows atlas tile data (atlas_tile_data_unit) according to embodiments.

FIG. 45 illustrates a syntax of atlas tile data (atlas_tile_data_unit (tileID)) included in the atlas tile layer of FIG. 44. In FIG. 45, as p increases by 1 from 0, atlas-related elements (i.e., fields) according to index p may be included in the atlas tile data of the atlas tile corresponding to tileID.

atdu_patch_mode [tileID] [p] indicates the patch mode for a patch with index p in the current atlas tile group (or tile). When the field ath_type contained in the atlas tile header indicates SKIP_TILE, it is indicated that the entire tile information is copied directly from the tile having the same ID (ath_ID) as the current tile corresponding to the first reference atlas frame.

When atdu_patch_mode [tileID] [p] is neither I_END nor P_END, the atlas tile data may include patch_information_data (tileID, p, atdu_patch_mode [tileID] [p]) and atdu_patch_mode [tileID] [p] for each index p.

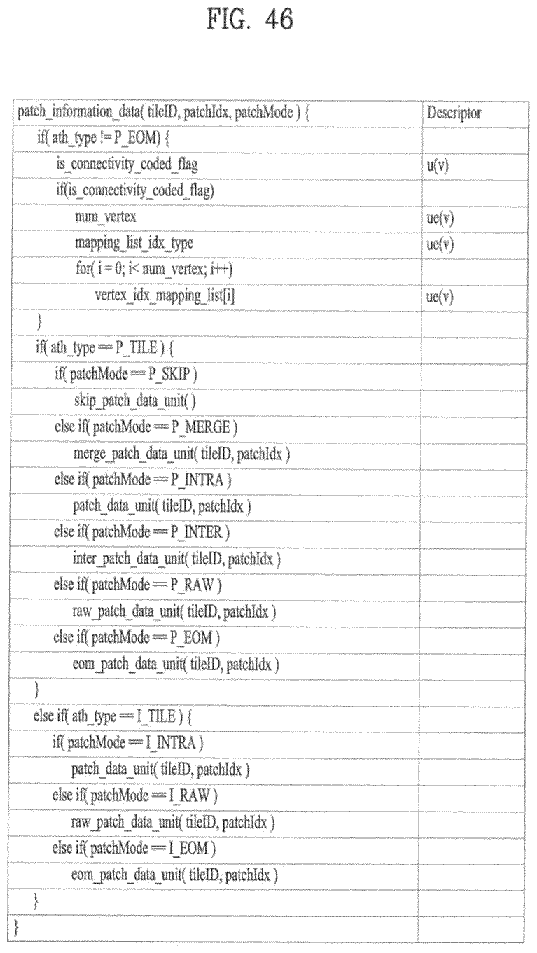

FIG. 46 shows patch information data (patch_information_data (tileID, patchIdx, patchMode)) according to embodiments.

FIG. 46 shows an exemplary syntax structure of patch information data

(patch_information_data (tileID, p, atdu_patch_mode [tileID] [p])) contained in the atlas tile data unit of FIG. 45. In FIG. 45, p in patch_information_data (tileID, p, atdu_patch_mode [tileID] [p]) corresponds to patchIdx in FIG. 46, and atdu_patch_mode [tileID] [p] corresponds to patchMode in FIG. 46.

According to embodiments, the ath_type field of FIG. 43 indicates P_TILE, and the value of the field atdu_patch_mode [tileID] [p] of FIG. 45 indicates that the identifier is P_EOM, which is the enhanced occupancy mode (EOM) point patch mode.

According to embodiments, at least some of the information related to the connectivity patch may be included in the patch information data (patch_information_data (tileID, patchIdx, patchMode)).

For example, when the field ath_type does not indicate P_EOM, the patch information data (patch_information_data (tileID, patchIdx, patchMode)) may include at least some of the connectivity patch-related information.

According to embodiments, the connectivity patch-related information transmitted through patch_information_data (tileID, patchIdx, patchMode) may include is_connectivity_coded_flag, num_vertex, mapping_list_idx_type, and vertex_idx_mapping_list [i].

According to embodiments, the patch information data (patch_information_data (tileID, patchIdx, patchMode)) may include the field is_connectivity_coded_flag.

is_connectivity_coded_flag is a flag indicating whether connectivity information contained in the tile or patch is transmitted.

According to embodiments, when the value of is_connectivity_coded_flag is 1 (i.e., true), the atlas tile header may include a field num_vertex, a field mapping_list_idx_type, and a field vertex_idx_mapping_list [i] repeated as many times as the value of num_vertex.

num_vertex indicates the number of vertices in the current connectivity patch.

mapping_list_idx_type indicates the type of index transmitted in the vertex index mapping list corresponding to the current connectivity patch. For example, mapping_list_idx_type equal to 0 may indicate a connectivity patch-based index, while mapping_list_idx_type equal to 1 may indicate a frame-based index.

The vertex_idx_mapping_list [i] is a vertex index mapping list. The vertex_idx_mapping_list [i] is a vertex index list of a frame corresponding to the vertex index M in the current connectivity patch. The vertex index N in the frame listed in the vertex index mapping list depends on the value of the mapping_list_idx_type. Based on the vertex_idx_mapping_list [i], the vertex index in the frame mapped to the index of the i-th vertex in the corresponding connectivity patch may be identified.

For example, when ath_type indicates P_TILE, one of skip_patch_data_unit ( ) merge_patch_data_unit (tileID, patchIdx), patch_data_unit (tileID, patchIdx), inter_patch_data_unit (tileID, patchIdx), raw_patch_data_unit (tileID, patchIdx), and eom_patch_data_unit (tileID, patchIdx) may be included as patch information data depending on the patch mode (patchMode).

For example, the skip_patch_data_unit ( ) is included when the patch mode (patchMode) is the patch skip mode (P_SKIP). The merge_patch_data_unit (tileID, patchIdx) is included when the patch mode (patchMode) is the patch merge mode (P_MERGE). The patch_data_unit (tileID, patchIdx) is included when the patch mode (patchMode) is the non-prediction patch mode (P_INTRA). Also, the inter_patch_data_unit (tileID, patchIdx) is included when the patch mode (patchMode) is the inter-prediction patch mode (P_INTER). The raw_patch_data_unit (tileID, patchIdx) is included when the patch mode (patchMode) is the raw point patch mode (P_RAW). The eom_patch_data_unit (tileID, patchIdx) is included when the patch mode (patchMode) is the EOM point patch mode (P_EOM).

When the ath_type indicates I_TILE, then one of patch_data_unit (tileID, patchIdx), raw_patch_data_unit (tileID, patchIdx), and eom_patch_data_unit (tileID, patchIdx) may be included as patch information data depending on the patch mode (patchMode).

For example, the patch_data_unit (tileID, patchIdx) is included when the patch mode (patchMode) is the non-prediction patch mode (I_INTRA). The raw_patch_data_unit (tileID, patchIdx) is included when the patch mode (patchMode) is the raw point patch mode (I_RAW). The eom_patch_data_unit (tileID, patchIdx) is included when the patch mode (patchMode) is the EOM point patch mode (I_EOM).

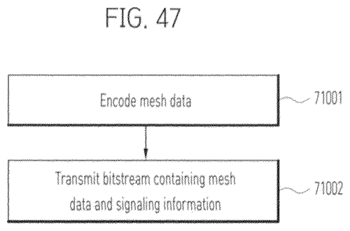

FIG. 47 is a flowchart illustrating a method of transmitting mesh data according to embodiments.

The method of transmitting mesh data according to the embodiments may include operation 71001 of encoding mesh data, and operation 71002 of transmitting the encoded mesh data and signaling information. In this case, a bitstream containing the encoded mesh data and the signaling information may be encapsulated and transmitted as a file. According to embodiments, the mesh data includes geometry information, attribute information, and connectivity information. According to embodiments, the geometry information and attribute information are referred to as point cloud data.

In operation 71001 of encoding the mesh data, the point cloud data including the geometry information and the attribute information may be partitioned to generate patches. The patches may be packed into a 2D frame, and then a geometry image, an attribute image, and an occupancy map image may be generated based on the patches packed into the 2D frame. Then, the geometry image, the attribute image, and the occupancy map image may be encoded respectively, and auxiliary information including information related to the patches may also be encoded. In other words, the geometry information and attribute information included in the mesh data are encoded based on V-PCC, and the connectivity information included in the mesh data is encoded by a connectivity information processor.

For the encoding of the geometry information and attribute information, refer to the description of FIGS. 1 to 21.

According to embodiments, the connectivity information related to a frames included in the mesh data is encoded by the connectivity information processor of FIG. 21 or the connectivity information processor of FIG. 23.

In this case, the connectivity information related to the frame is divided into a plurality of connectivity patches and encoded on a per-connectivity patch basis. In addition, when transmitting information about mapping between a vertex index in a connectivity patch and a corresponding vertex index in the frame, the vertex index in the frame is transmitted on a frame-by-frame basis or is converted and transmitted on a per connectivity patch basis.

For details of splitting the connectivity information related to the frame into a plurality of connectivity patches, encoding the split connectivity patches, and transmitting the mapping information, refer to the description of FIGS. 23 to 30.

The signaling information may include connectivity patch-related information. In one embodiment, the connectivity patch-related information is included in a connectivity patch header. In another embodiment, the connectivity patch-related information may be included in the SPS, GPS, APS, or TPS. In another embodiment, the connectivity patch-related information may be included in the atlas tile header and/or patch information data. The connectivity patch-related information has been described in detail above with reference to FIGS. 38 to 46, and thus a description thereof will not be skipped.

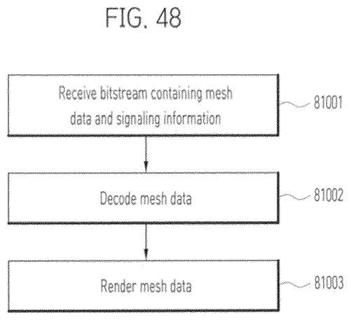

FIG. 48 is a flowchart illustrating a method of receiving mesh data according to embodiments.

The method of receiving mesh data according to the embodiments may include operation 81001 of receiving encoded mesh data and signaling information, operation 81002 of decoding the mesh data based on the signaling information, and operation 81003 of rendering the decoded mesh data.

Operation 81001 of receiving the mesh data and signaling information may be performed by the receiver 10005 of FIG. 1, the transmission 20002 or decoding 20003 of FIG. 2, or the receiver 13000 or reception processor 13001 of FIG. 13.

In operation 81002 of decoding the mesh data, Some or all of the operations of the decoding process of the point cloud video decoder 10006 of FIG. 1, the decoder 20003 of FIG. 2, the point cloud video decoder of FIG. 11, the point cloud video decoder of FIG. 13, the V-PCC decoder of FIG. 22, and the V-PCC decoder of FIG. 32 may be performed to decode the compressed transmitted geometry information, attribute information, occupancy map, and auxiliary information (also referred to as patch information).

In operation 81002 of decoding the mesh data, the encoded connectivity information may be decoded based on the connectivity patch-related information included in the signaling information. For details, refer to the description of FIGS. 32 to 37.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

It will be appreciated by those skilled in the art that various modifications and variations may be made in the embodiments without departing from the scope of the disclosures. Thus, it is intended that the present disclosure cover the modifications and variations of the embodiments provided they come within the scope of the appended claims and their equivalents.

Both apparatus and method disclosures are described in the present disclosure and descriptions of both the apparatus and method disclosures are complementarily applicable.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.”

Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also non-volatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if”′ and “when” are not limited to an optional case and are intended to be interpreted, when a specific condition is satisfied, to perform the related operation or interpret the related definition according to the specific condition.

### Mode for Disclosure

As described above, related details have been described in the best mode for carrying out the embodiments.

### Industrial Applicability

As described above, the embodiments are fully or partially applicable to a 3D data transmission/reception device and system.

Those skilled in the art may change or modify the embodiments in various ways within the scope of the embodiments.

Embodiments may include variations/modifications within the scope of the claims and their equivalents.

1. A method of transmitting 3D data, the method comprising:
generating a geometry image, an attribute image, an occupancy map, and auxiliary information based on geometry information and attribute information contained in mesh data;
encoding the geometry image, the attribute image, the occupancy map, and the auxiliary information, respectively;
splitting connectivity information contained in the mesh data into a plurality of connectivity patches and encoding the connectivity information contained in each of the split connectivity patches on a basis of the connectivity patches; and
transmitting a bitstream containing the encoded geometry image, the encoded attribute image, the encoded occupancy map, the encoded auxiliary information, the encoded connectivity information, and signaling information.

2. The method of claim 1, wherein the encoding of the connectivity information comprises:
correcting the connectivity information contained in the mesh data based on geometry information reconstructed based on the encoded geometry image and the encoded auxiliary information;
splitting the corrected connectivity information into a plurality of connectivity patches;
encoding connectivity information related to each of the connectivity patches on a basis of the split connectivity patches; and
generating mapping information mapping, based on the encoded connectivity information, a vertex index in a corresponding one of the connectivity patches to a vertex index in a frame.

3. The method of claim 2, wherein the connectivity information contained in the mesh data and the corrected connectivity information are configured on a frame-by-frame basis.

4. The method of claim 2, wherein the vertex index in the frame mapped to the vertex index in the corresponding one of the connectivity patches included in the mapping information is a frame-based index.

5. The method of claim 2, wherein the vertex index in the frame mapped to the vertex index in the corresponding one of the connectivity patches included in the mapping information is a connectivity patch-based index.

6. The method of claim 1, wherein boundary connectivity information positioned between the connectivity patches is not transmitted.

7. The method of claim 1, wherein boundary connectivity information positioned between the connectivity patches is included in one of the connectivity patches to be encoded and transmitted.

8. A device for transmitting 3D data, the device comprising:
a generator configured to generate a geometry image, an attribute image, an occupancy map, and auxiliary information based on geometry information and attribute information contained in mesh data;
an encoder configured to encode the geometry image, the attribute image, the occupancy map, and the auxiliary information, respectively;
a connectivity information processor configured to split connectivity information contained in the mesh data into a plurality of connectivity patches and encode the connectivity information contained in each of the split connectivity patches on a basis of the connectivity patches; and
a transmitter configured to transmit a bitstream containing the encoded geometry image, the encoded attribute image, the encoded occupancy map, the encoded auxiliary information, the encoded connectivity information, and signaling information.

9. The device of claim 1, wherein the connectivity information processor comprises:
a connectivity information corrector configured to correct the connectivity information contained in the mesh data based on geometry information reconstructed based on the encoded geometry image and the encoded auxiliary information;
a connectivity patch configurator configured to split the corrected connectivity information into a plurality of connectivity patches;
a connectivity information encoder configured to encode connectivity information related to each of the connectivity patches on a basis of the split connectivity patches; and
a mapping information generator configured to generate mapping information mapping, based on the encoded connectivity information, a vertex index in a corresponding one of the connectivity patches to a vertex index in a frame.

10. The device of claim 9, wherein the connectivity information contained in the mesh data and the corrected connectivity information are configured on a frame-by-frame basis.

11. The device of claim 9, wherein the vertex index in the frame mapped to the vertex index in the corresponding one of the connectivity patches included in the mapping information is a frame-based index.

12. The device of claim 9, wherein the vertex index in the frame mapped to the vertex index in the corresponding one of the connectivity patches included in the mapping information is a connectivity patch-based index.

13. A method of receiving 3D data, the method comprising:
receiving a bitstream containing an encoded geometry image, an encoded attribute image, an encoded occupancy map, encoded auxiliary information, encoded connectivity information, and signaling information;
reconstructing geometry information and attribute information by decoding the encoded geometry image, the encoded attribute image, the encoded occupancy map, and the encoded auxiliary information, respectively, based on the signaling information;
decoding the encoded connectivity information on a connectivity patch-by-patch basis based on the signaling information and the reconstructed geometry information; and
reconstructing mesh data based on the reconstructed geometry information and attribute information and the decoded connectivity information.

14. The method of claim 13, wherein the decoding of the connectivity information comprises:
converting a vertex index in a corresponding connectivity patch to a vertex index in a frame based on mapping information included in the signaling information.

15. The method of claim 14, wherein the vertex index in the frame mapped to the vertex index in the connectivity patch included in the mapping information is a frame-based index or a connectivity patch-based index.

16. The method of claim 15, further comprising:
converting the vertex index in the frame included in the mapping information to a local vertex index, based on the vertex index in the frame being the connectivity patch-based index; and
converting the local vertex index to a global vertex index by applying an offset to the local vertex index.
